(19) United States
(12) Patent Application Publication
(10) Pub. No.: US 2025/0005855 A1
(43) Pub. Date: Jan. 2, 2025

(54) LOCATIONS OF MEDIA CONTROLS FOR MEDIA CONTENT AND CAPTIONS FOR MEDIA CONTENT IN THREE-DIMENSIONAL ENVIRONMENTS

(71) Applicant: Apple Inc., Cupertino, CA (US)

(72) Inventors: Wesley M. HOLDER, Union City, CA (US); Matan STAUBER, San Francisco, CA (US); Stephen O. LEMAY, Palo Alto, CA (US); William A. SORRENTINO, III, Mill Valley, CA (US); Ichha ARORA, Rancho Cucamonga, CA (US); Harshad UNTWALE, Folsom, CA (US)

(21) Appl. No.: 18/733,802

(22) Filed: Jun. 4, 2024

Related U.S. Application Data
(60) Provisional application No. 63/655,544, filed on Jun. 3, 2024.
(60) Provisional application No. 63/506,132, filed on Jun. 4, 2023.
(60) Provisional application No. 63/506,122, filed on Jun. 4, 2023.

(51) Int. Cl. G06T 17/00; G06V 20/40; G06V 20/70; H04N 13/279

(52) U.S. Cl. CPC G06T 17/00; G06V 20/44; G06V 20/70; H04N 13/279

(57) ABSTRACT

In some embodiments, a computer system displays media playback controls at a position based on an arrangement between a user and media content. In some embodiments, a computer system displays captions concurrently with media content at a position based on a spatial arrangement between the computer system and a reference point corresponding to the media content. In some embodiments, a computer system changes the spatial arrangement between captions and the viewpoint of the user based on user input.

### CROSS-REFERENCE TO RELATED APPLICATIONS

This application claims the benefit of U.S. Provisional Application No. 63/506,122, filed Jun. 4, 2023, U.S. Provisional Application No. 63/506,132, filed Jun. 4, 2023, and U.S. Provisional Application No. 63/655,544, filed Jun. 3, 2024, the contents of which are herein incorporated by reference in their entireties for all purposes.

### TECHNICAL FIELD

The present disclosure relates generally to computer systems that provide computer-generated experiences, including, but not limited to, electronic devices that provide virtual reality and mixed reality experiences including media content via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system displays a set of controls associated with controlling playback of media. In some embodiments, the computer system displays media content concurrently with the set of controls. In some embodiments, the controls are displayed at a position based on a relative arrangement between a viewpoint of the user and the media content that exists when an input requesting display of the media content is detected. In this manner, the computer system optionally provides feedback to the user that they have begun to invoke display of the controls and displays the controls at a position configured to allow for easier and more-accurate interactions with the computer system. In some embodiments, a computer system displays a user interface element including captions based on a spatial arrangement between a viewpoint of the user of the computer system and a spatial reference in the media. In some embodiments, a computer system facilitates movement of captions relative to the viewpoint of the user.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7O illustrate examples of a computer system that displays media controls for media content based on a type of the media content, in accordance with some embodiments.

FIG. 8 is a flow diagram illustrating an exemplary method of displaying media controls for media content based on a type of the media content in accordance with some embodiments.

FIGS. 9A-9O illustrate examples of a computer system that displays captions for immersive media content that can move relative to a reference in the immersive media content, in accordance with some embodiments.

FIGS. 9P and 9Q illustrate examples of a computer system that displays captions for media content is non-immersive, in accordance with some embodiments.

FIGS. 9R-9U illustrate examples of a computer system facilitating movement of captions relative to the viewpoint of the user, in accordance with some embodiments.

FIG. 10 is a flow diagram illustrating an exemplary method of displaying captions for immersive media content moveable to a reference in the immersive media content in accordance with some embodiments.

FIG. 11 is a flow diagram illustrating an exemplary method of moving captions relative to the viewpoint of the user, in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system displays a set of controls associated with controlling playback of media. In some embodiments, the computer system displays media content concurrently with the set of controls. In some embodiments, the computer system displays the media controls at a position based on a relative arrangement between a viewpoint of the user and the media content that exists when an input requesting display of the media content is detected. In this manner, the computer system optionally provides feedback to the user that they have begun to invoke display of the controls and displays the controls at a position configured to allow for easier and more-accurate interactions with the computer system.

In some embodiments, a computer system displays media content in a three-dimensional environment. In some embodiments, the computer system concurrently displays captions corresponding to the media content. In some embodiments, the computer system detects a change in viewpoint of the user relative to a spatial reference of in the media content. In some embodiments, in response to detecting the viewpoint of the user change relative to the spatial reference of the media content, the computer system changes a position of the captions based on the degree of change of the viewpoint of the user relative to the spatial reference of the media content. In some embodiments, a computer system facilitates movement of the captions relative to the viewpoint of the user.

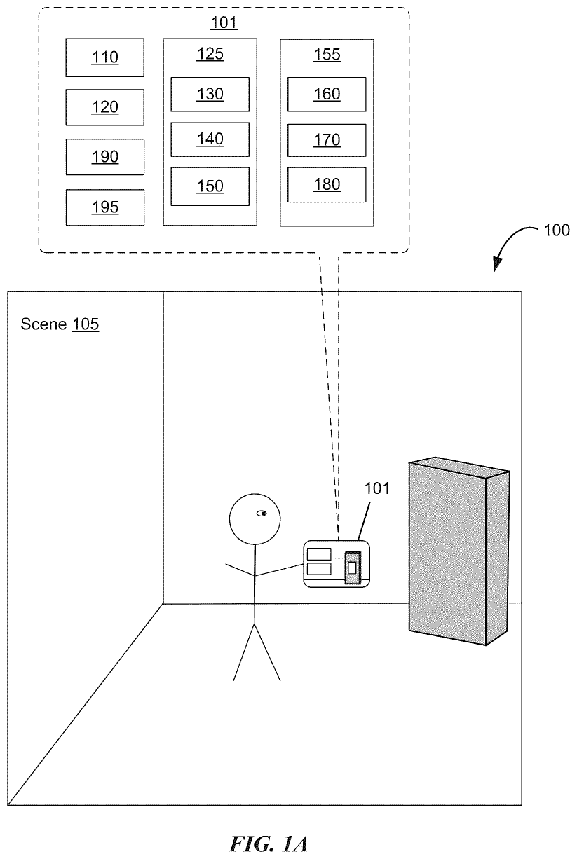

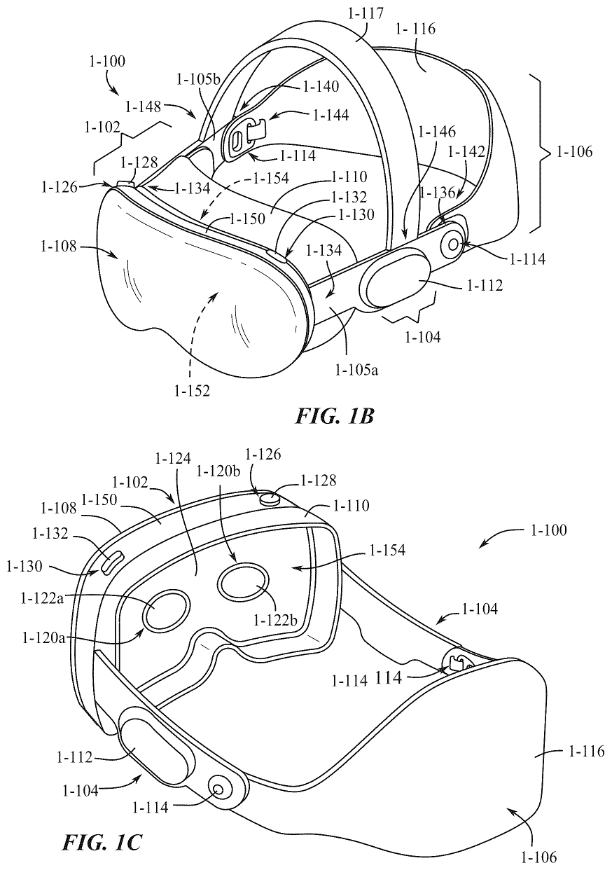

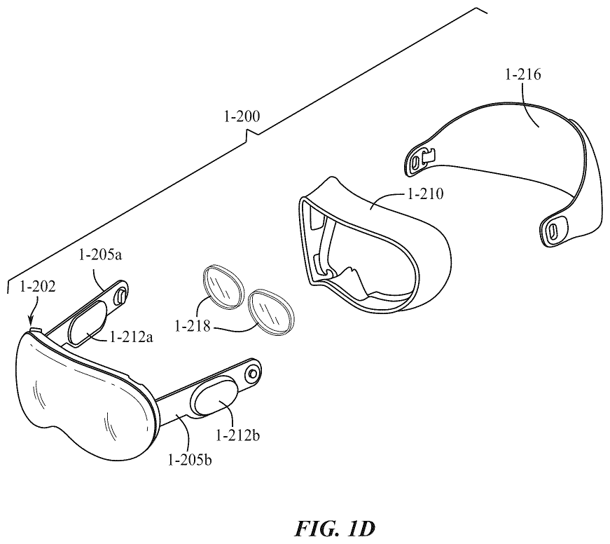

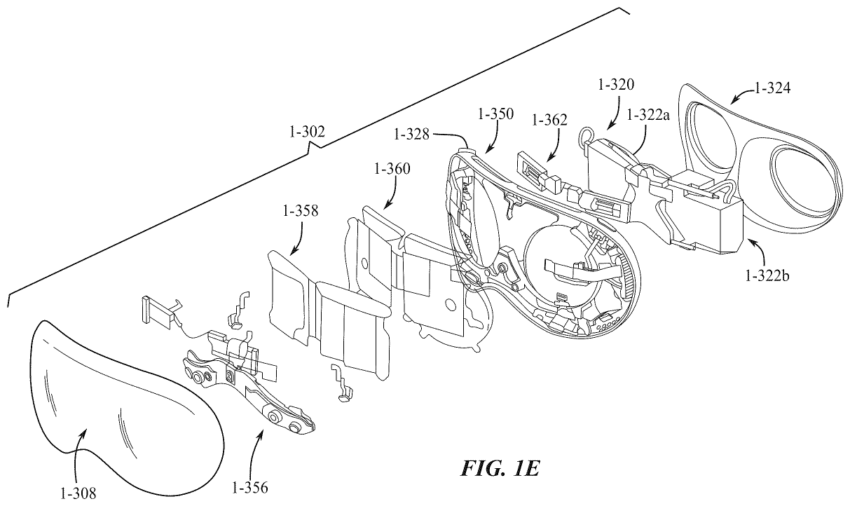

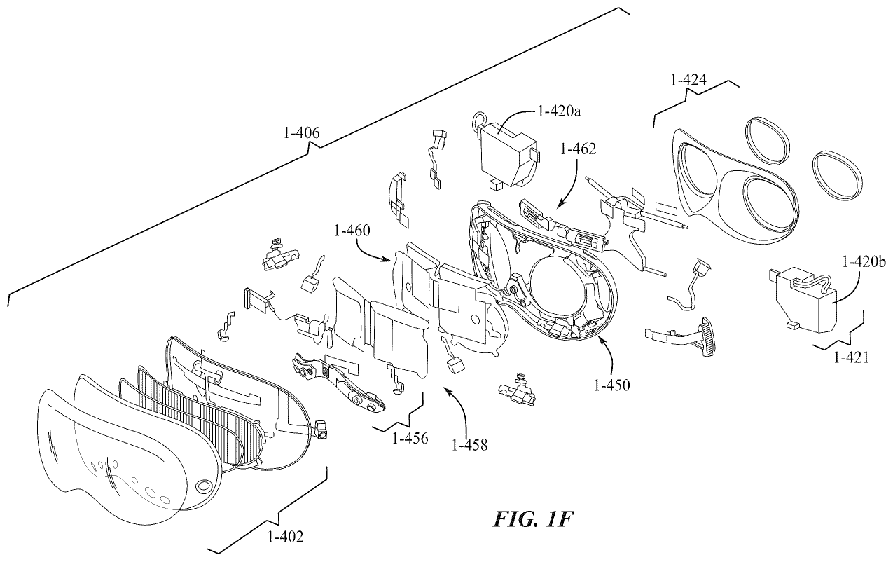

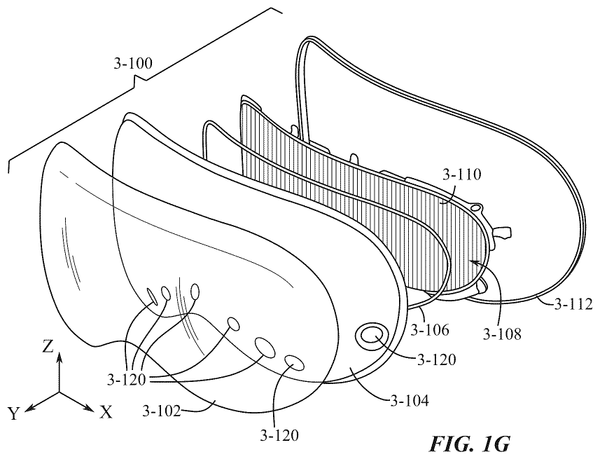

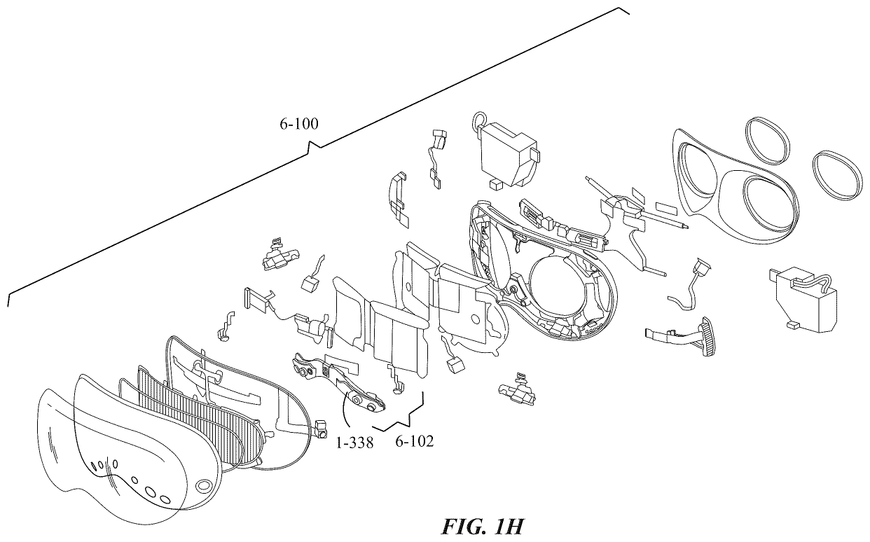

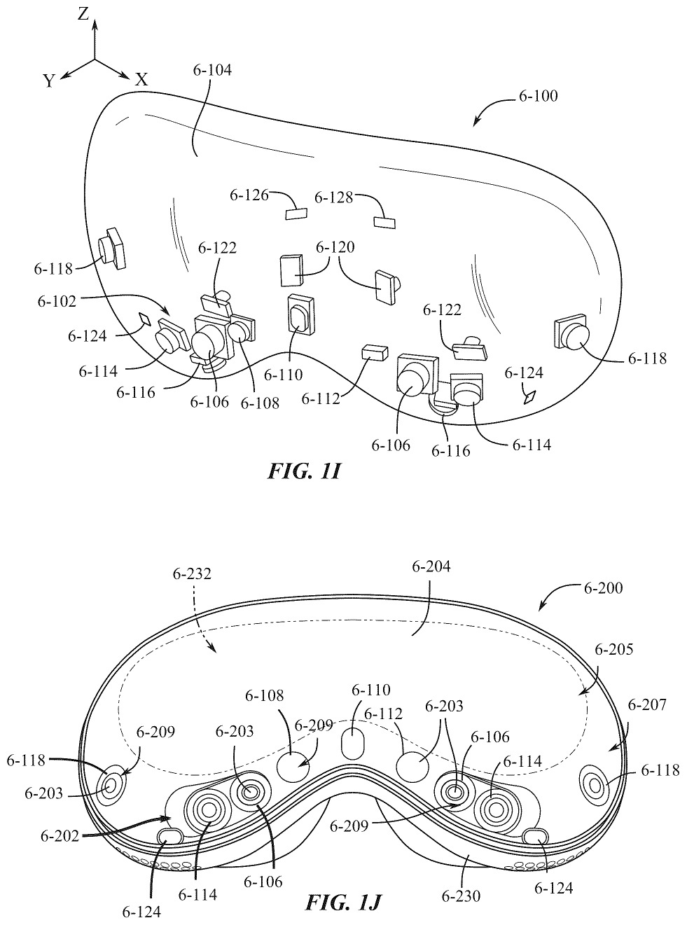

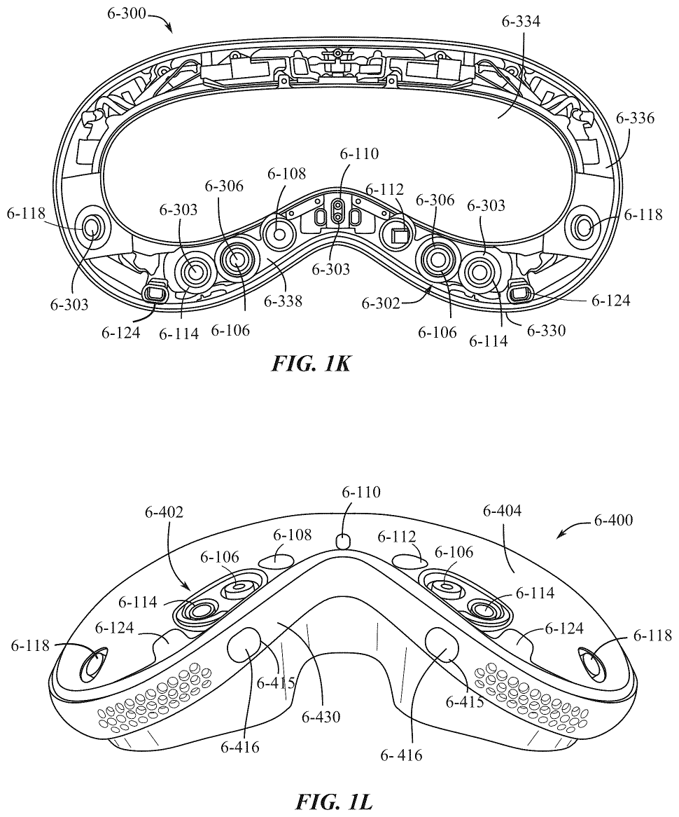

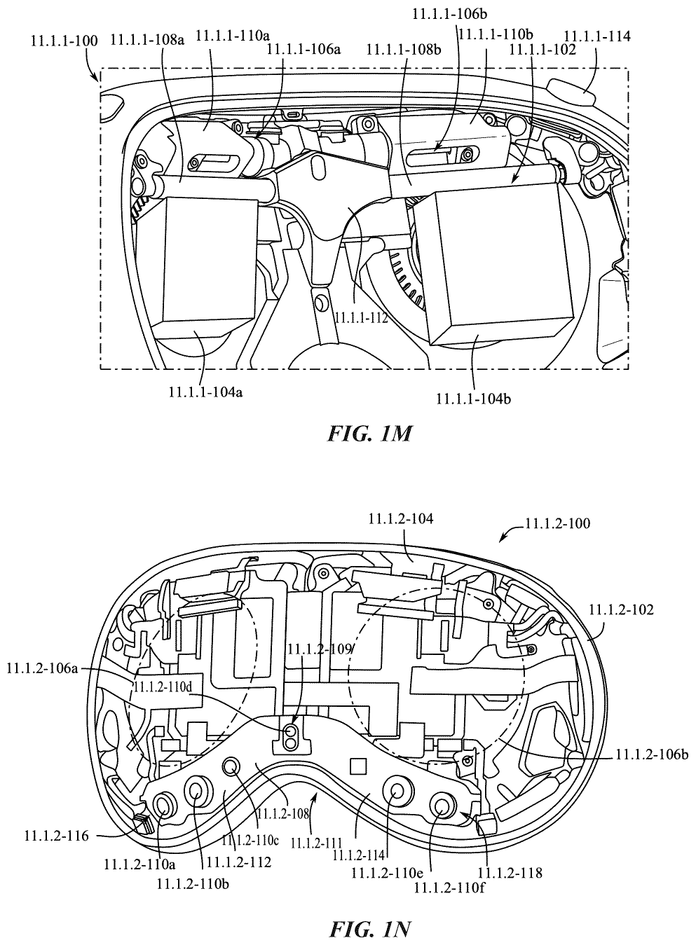

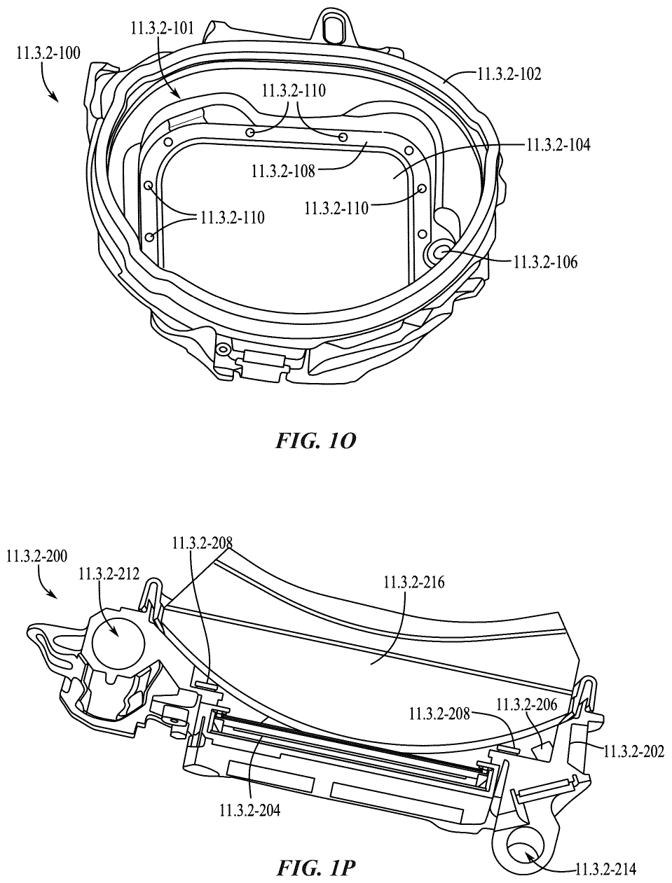

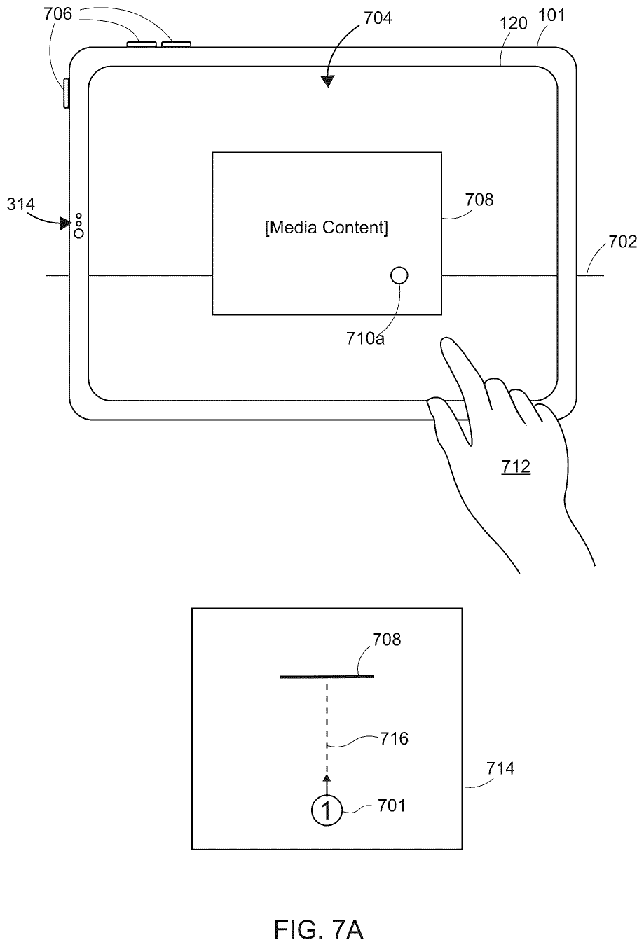

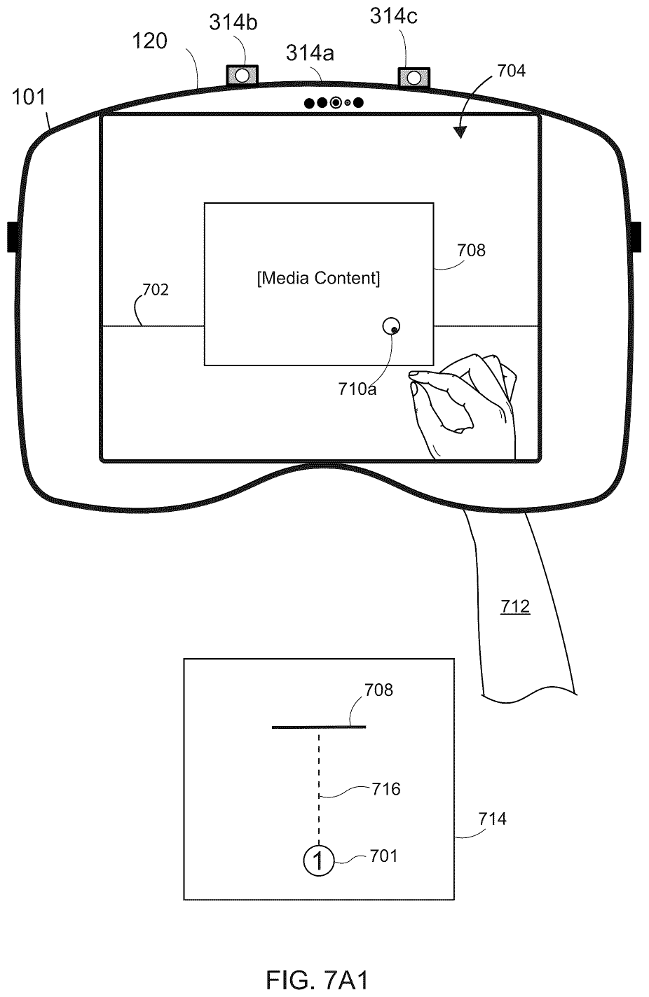

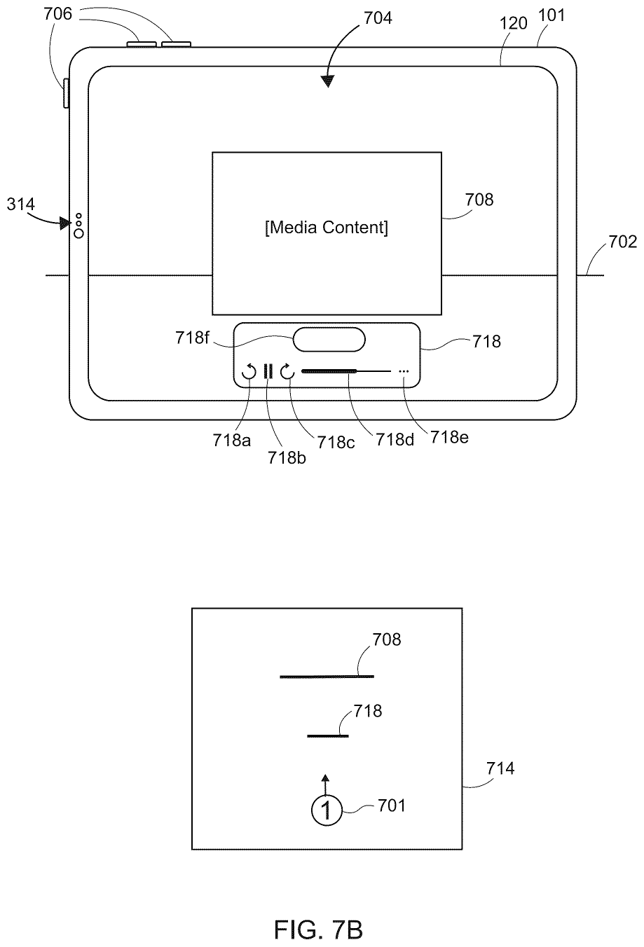

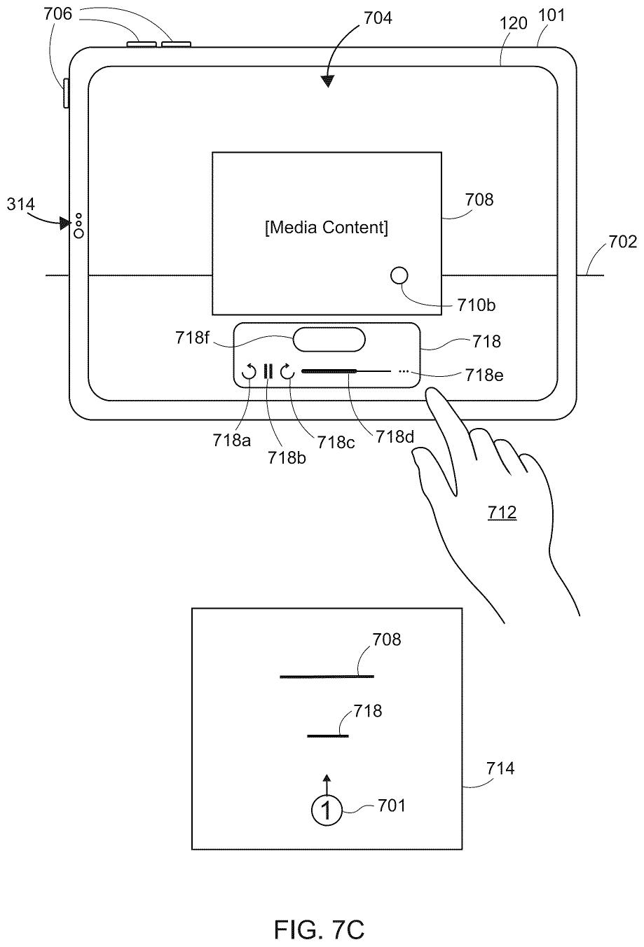

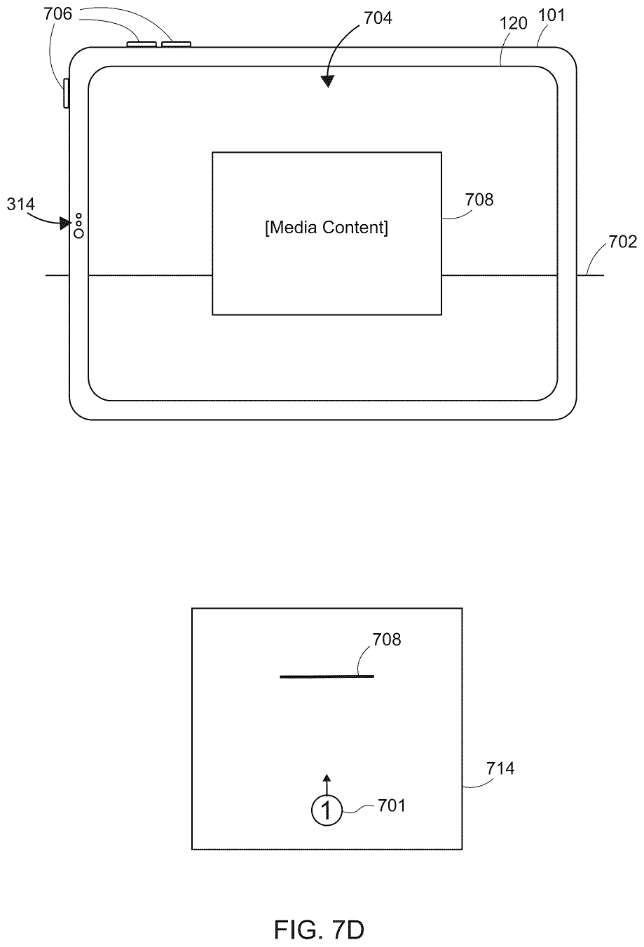

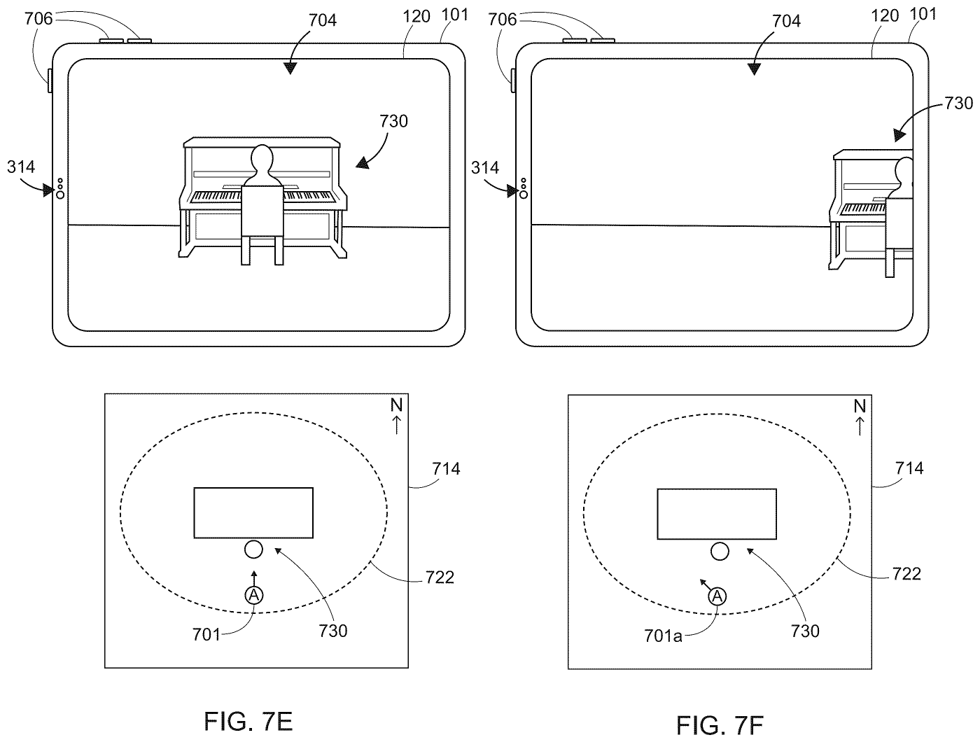

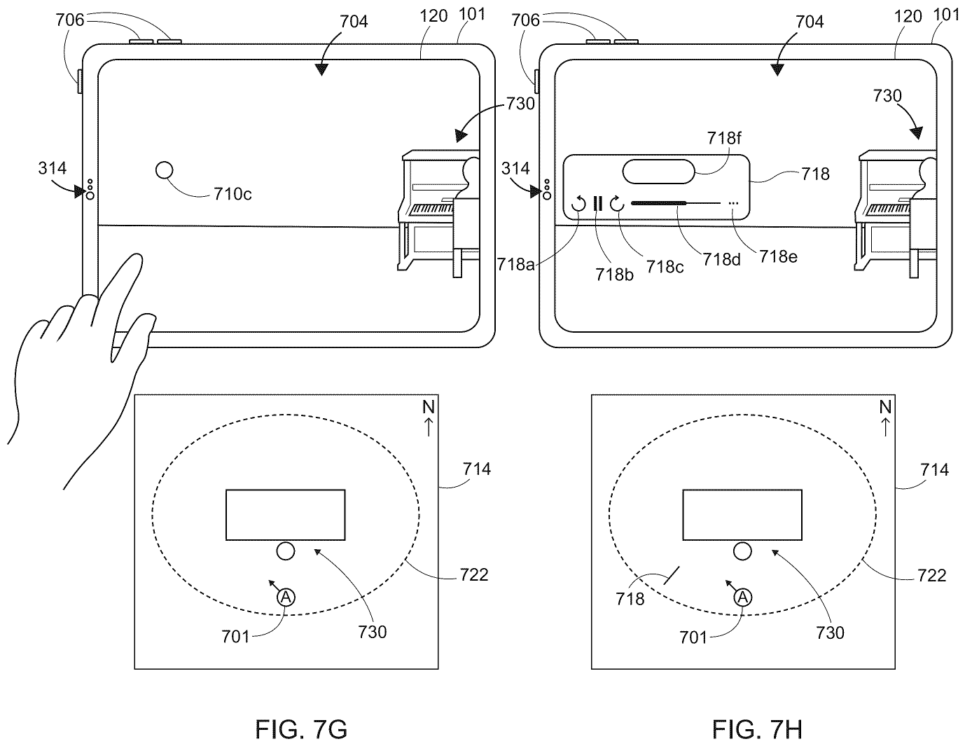

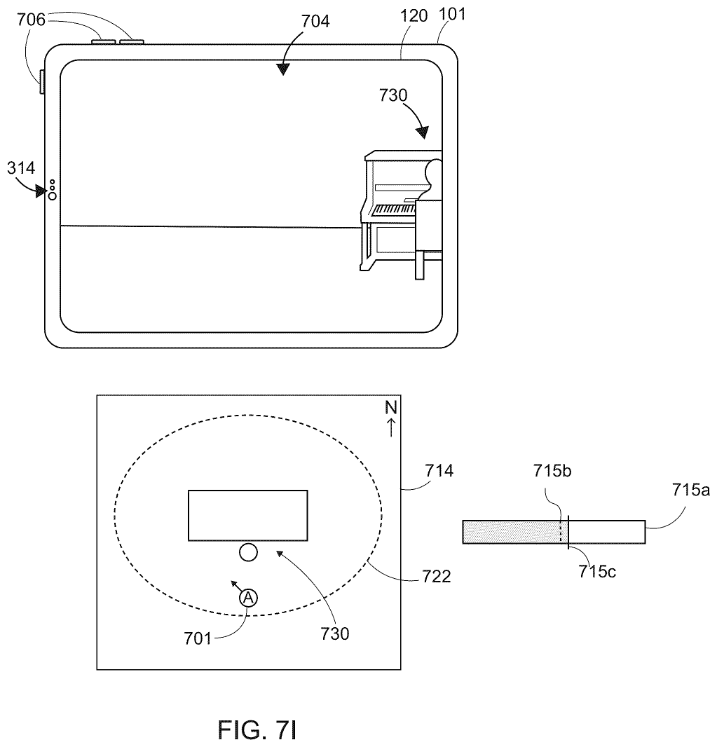

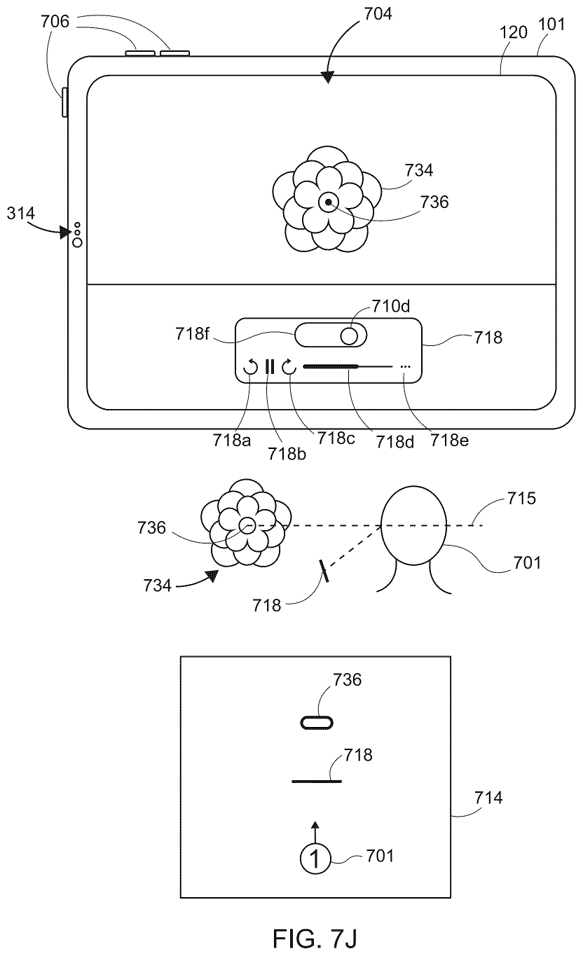

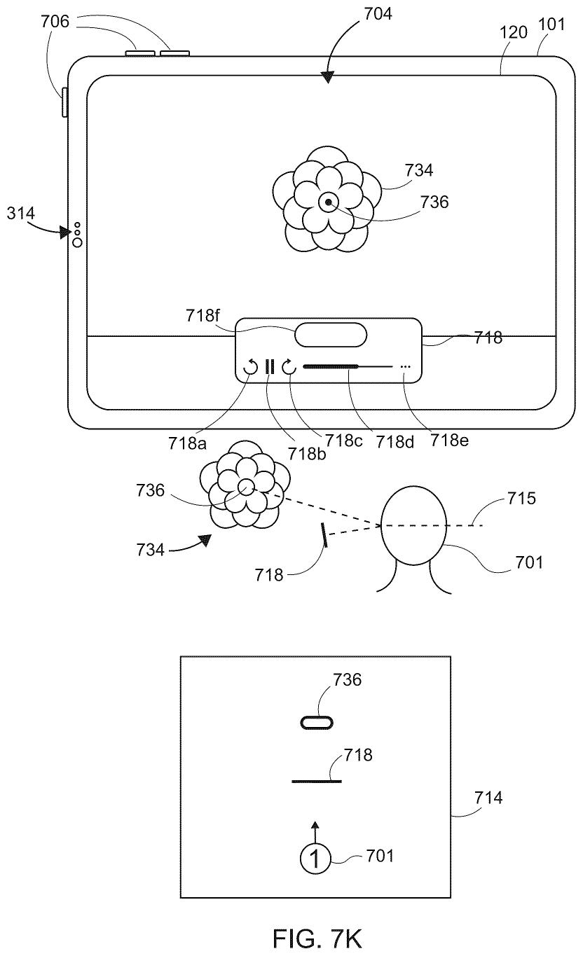

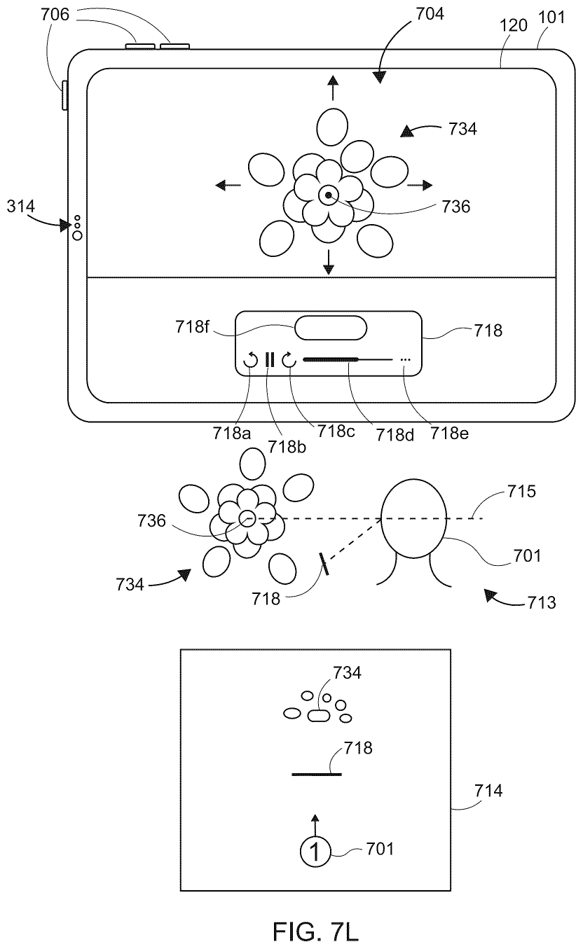

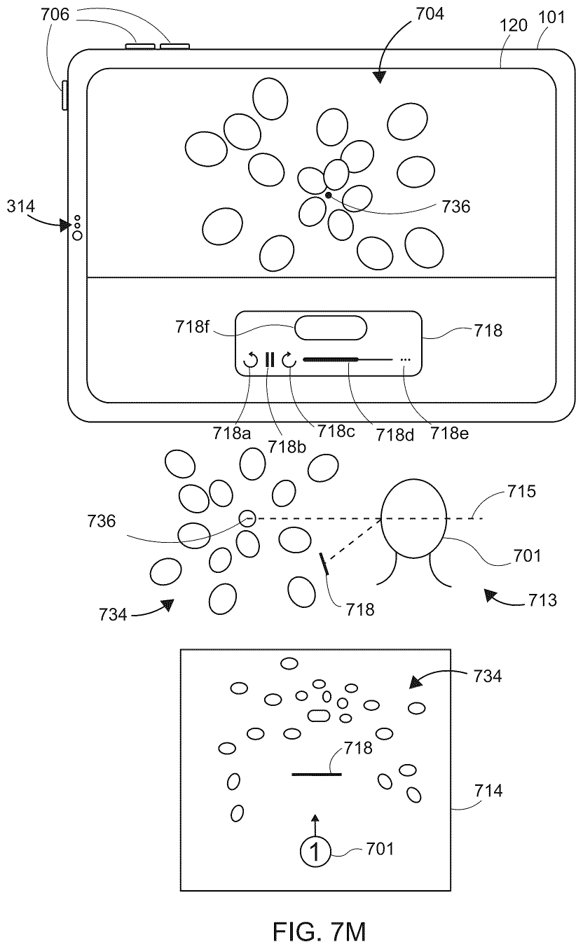

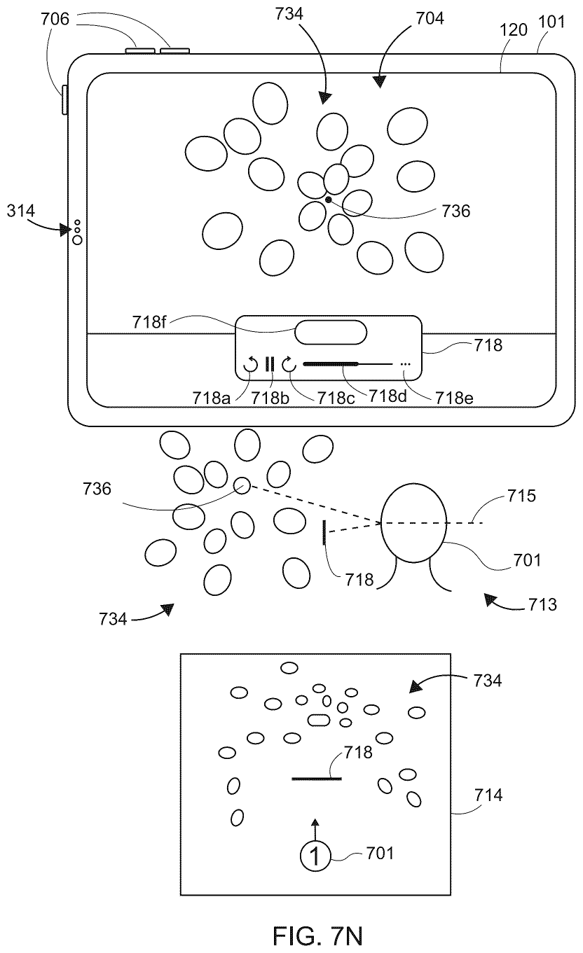

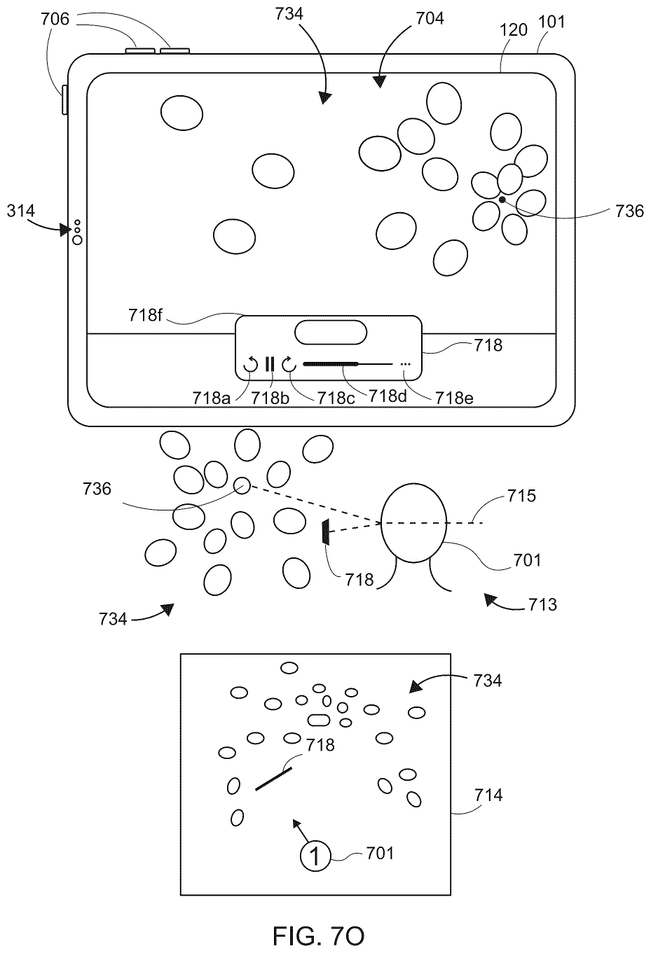

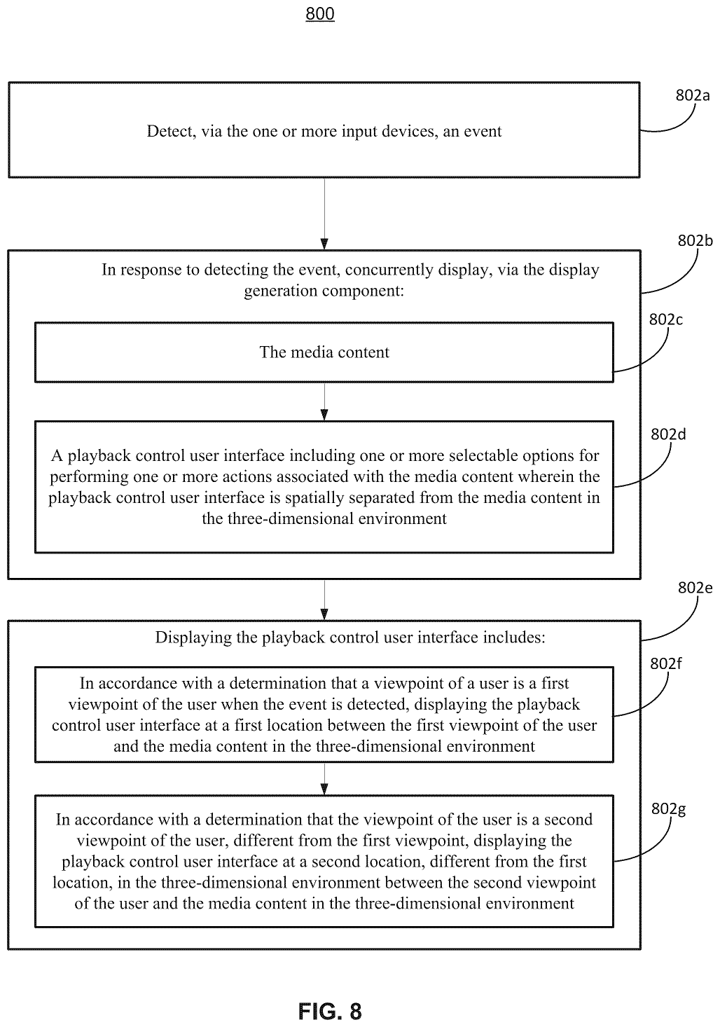

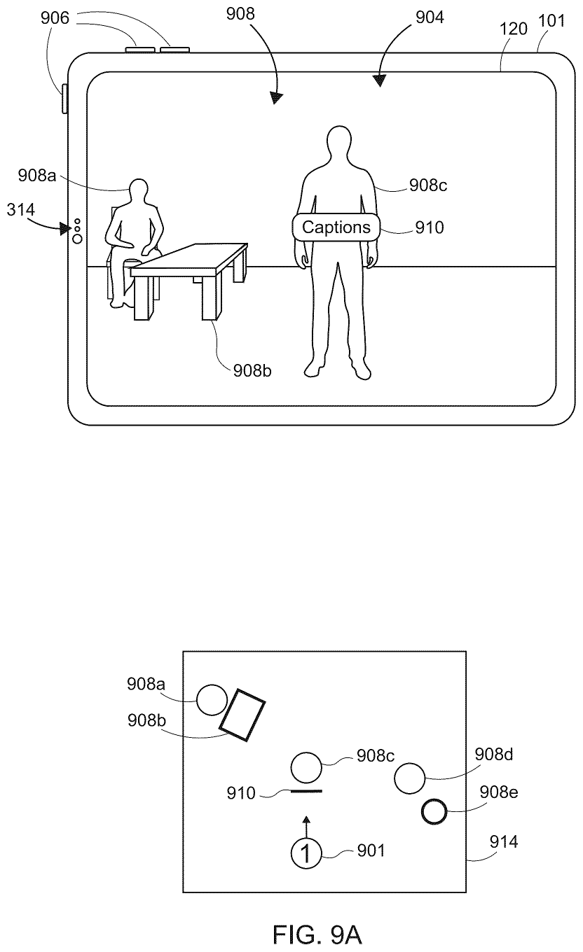

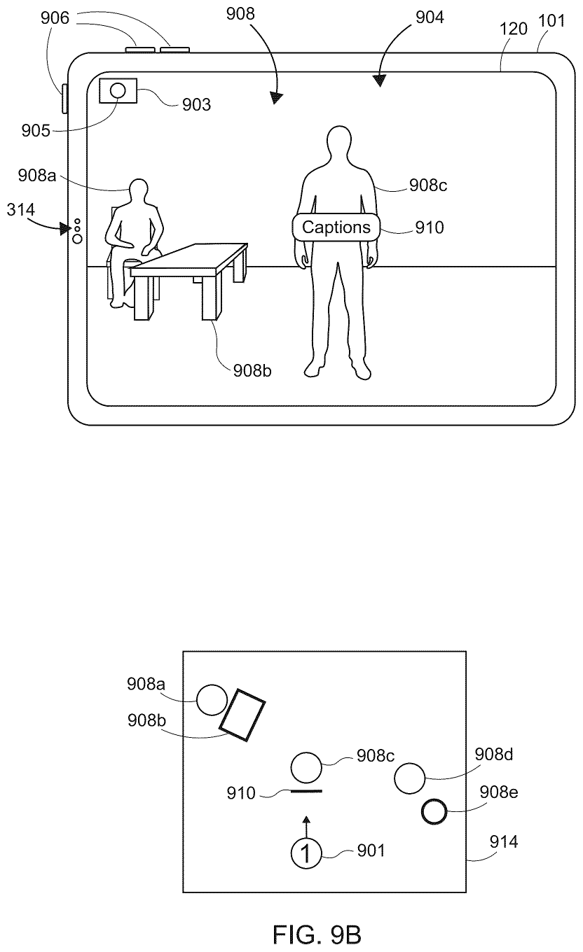

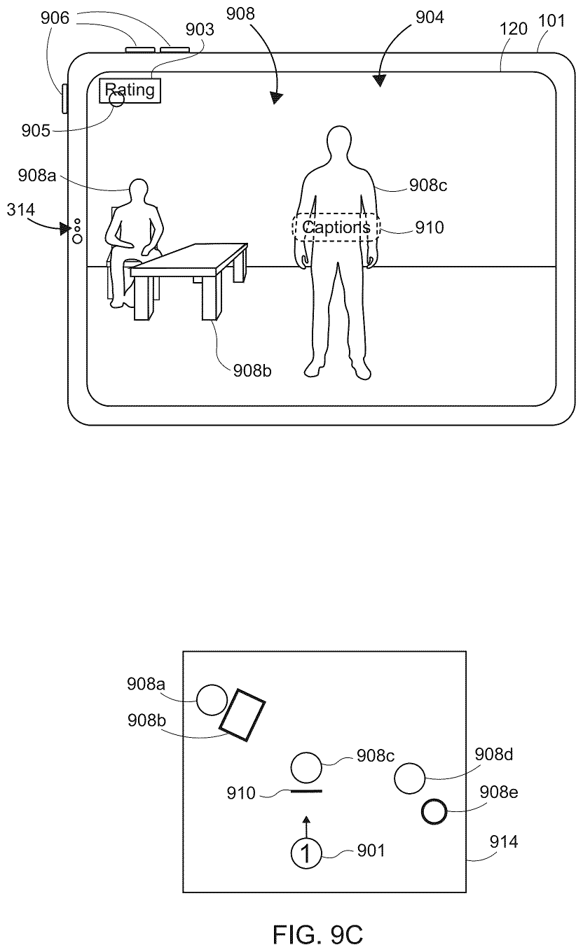

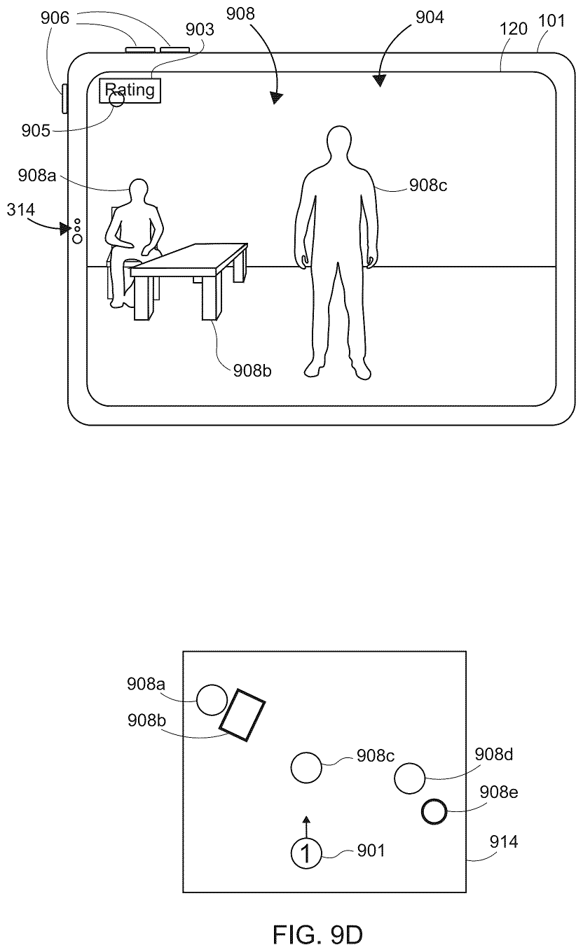

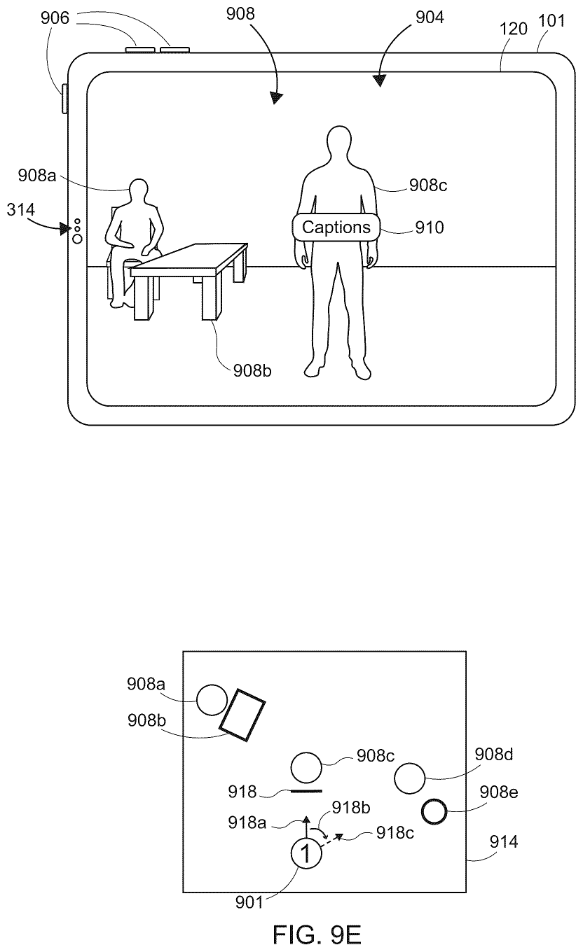

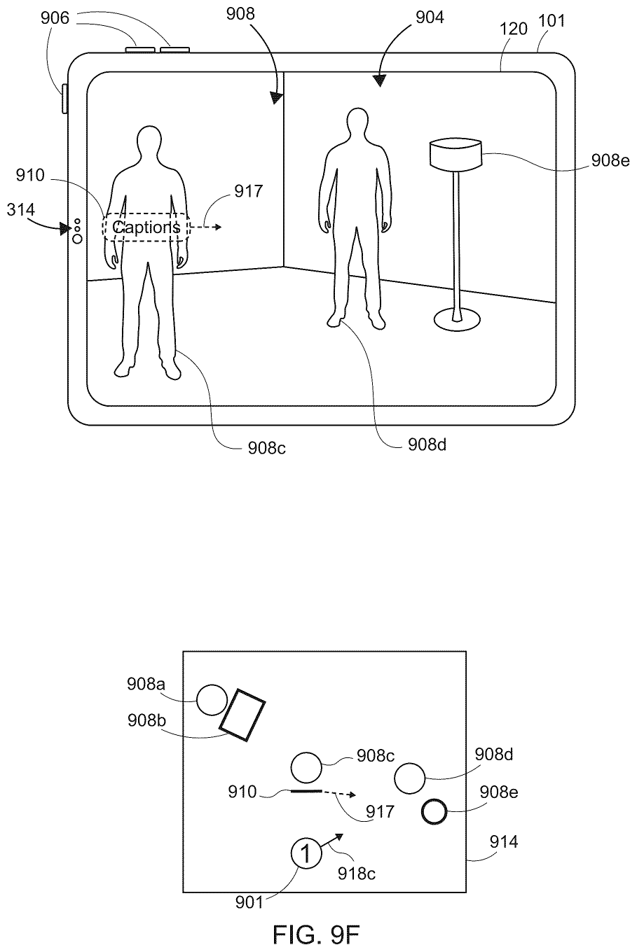

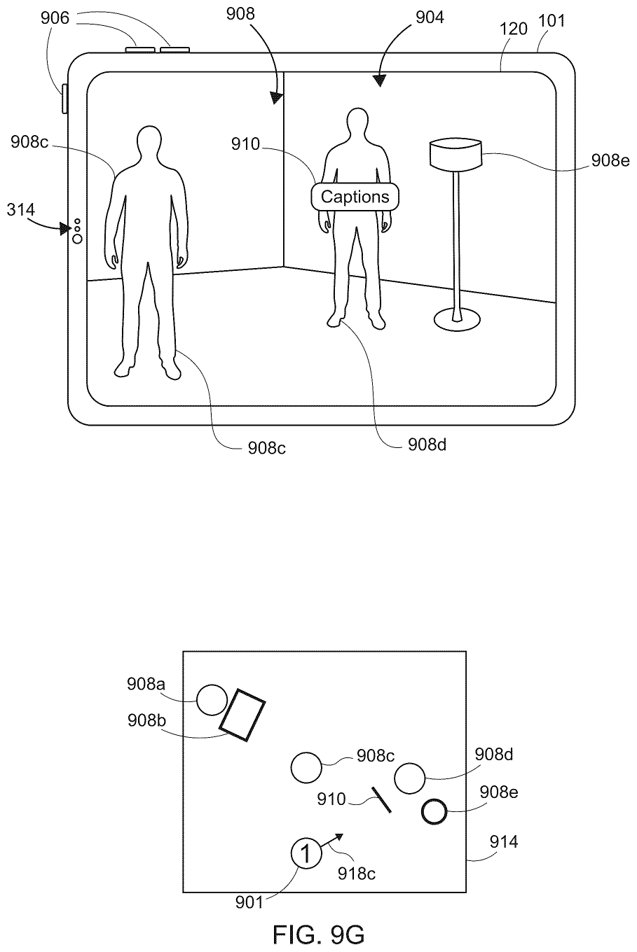

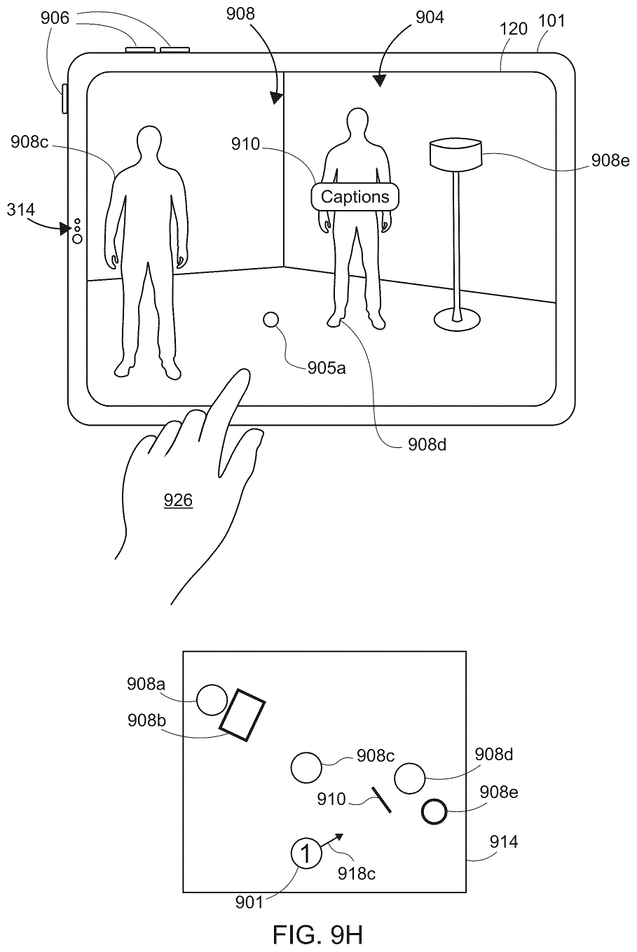

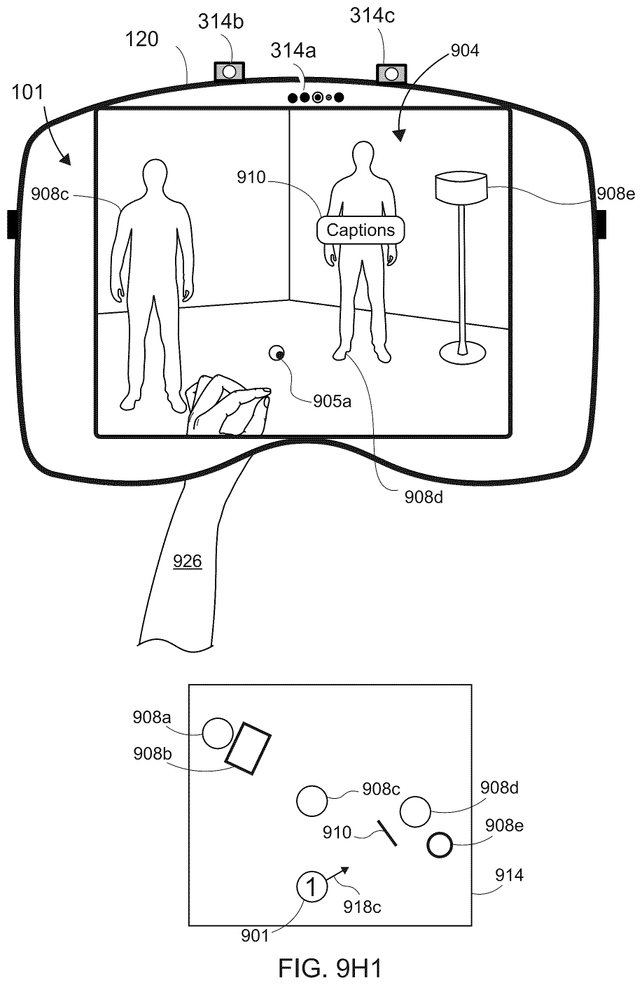

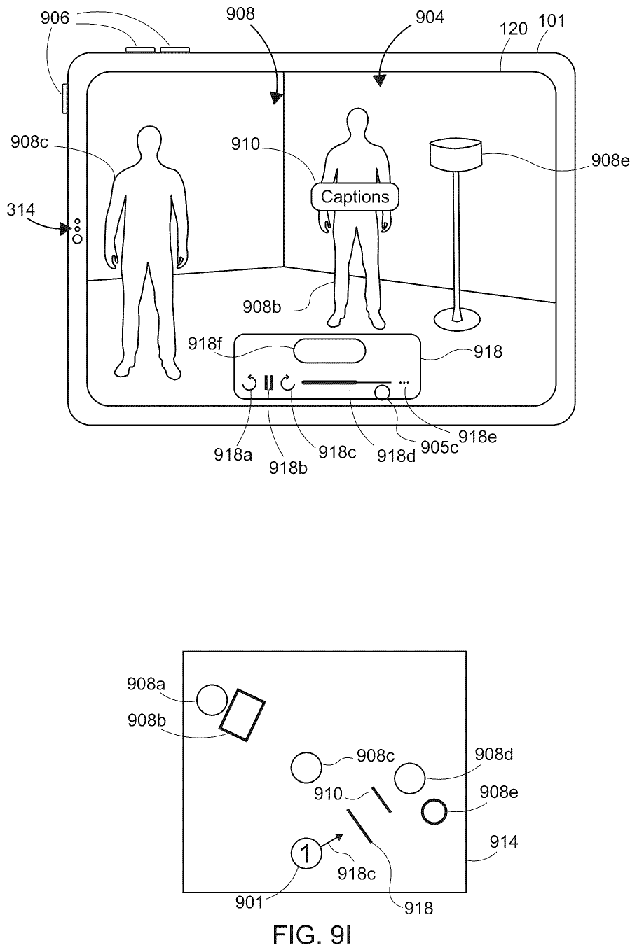

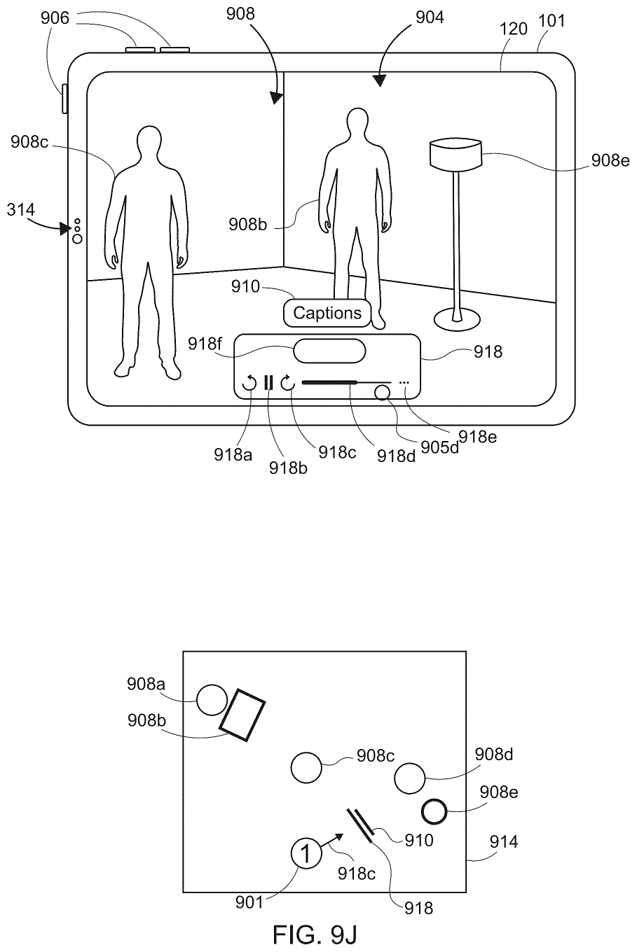

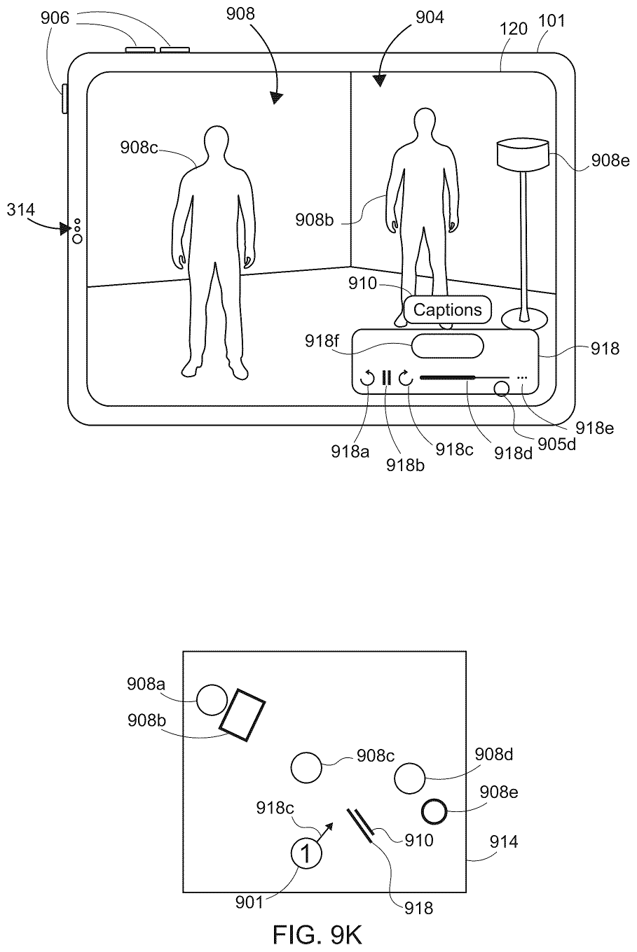

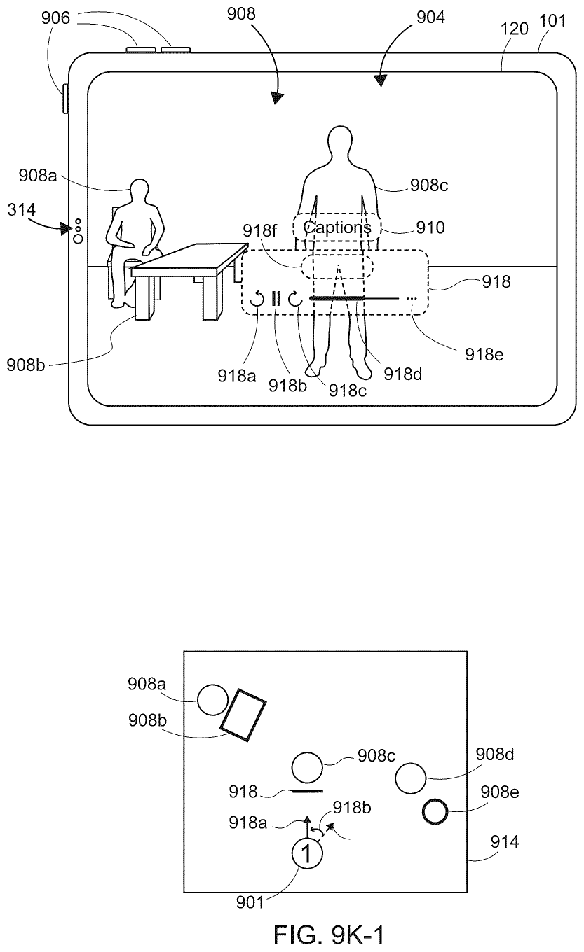

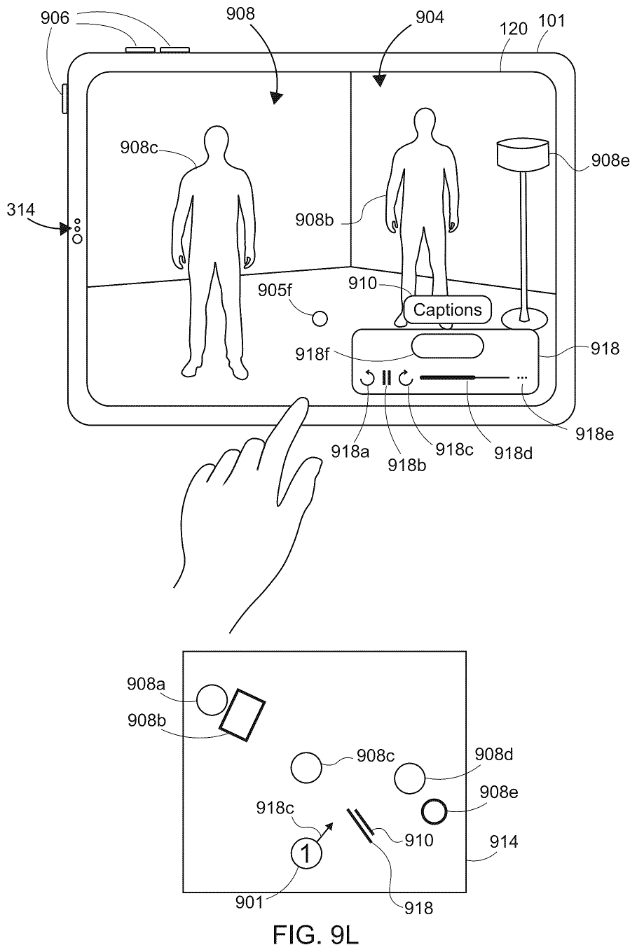

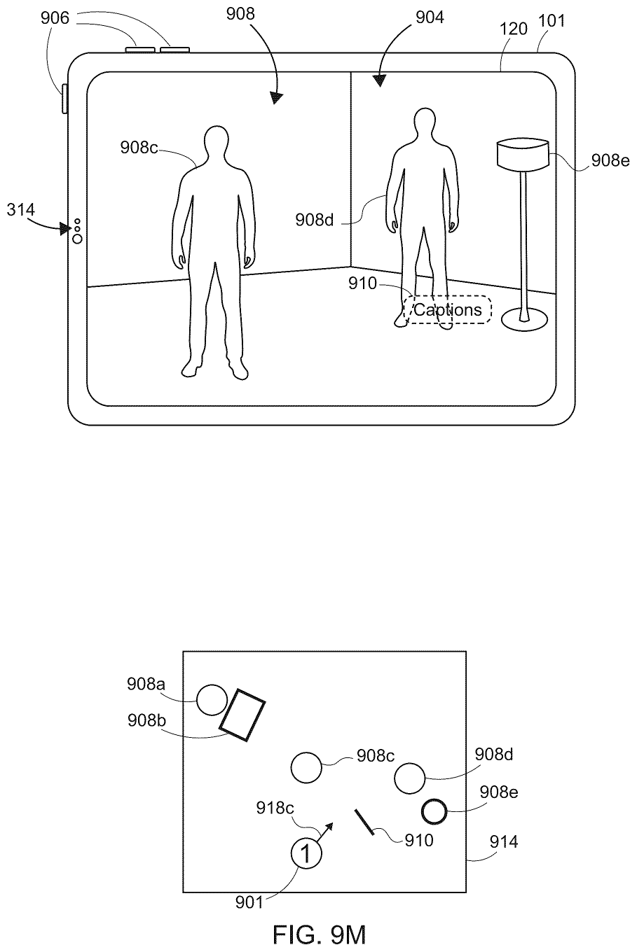

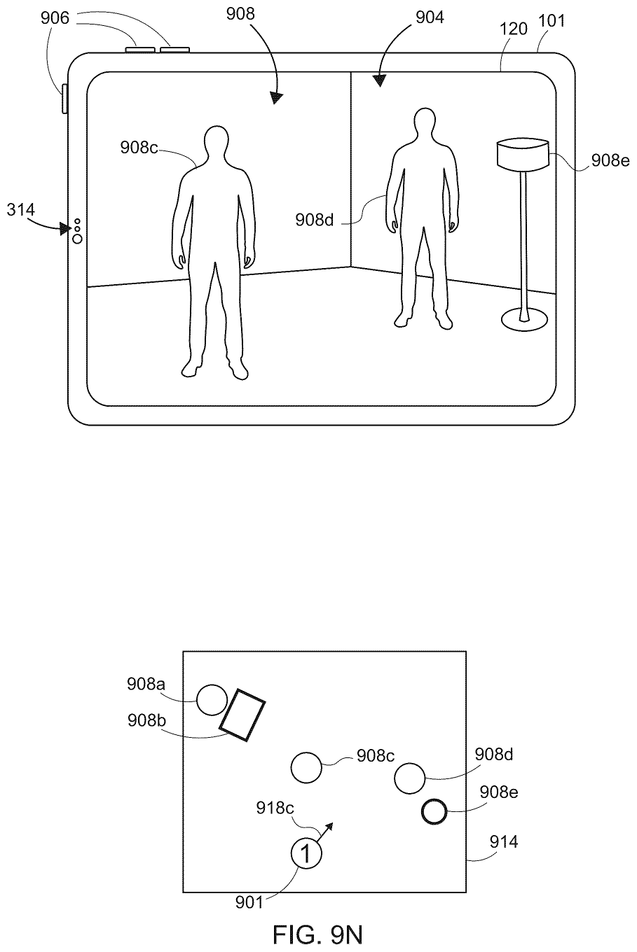

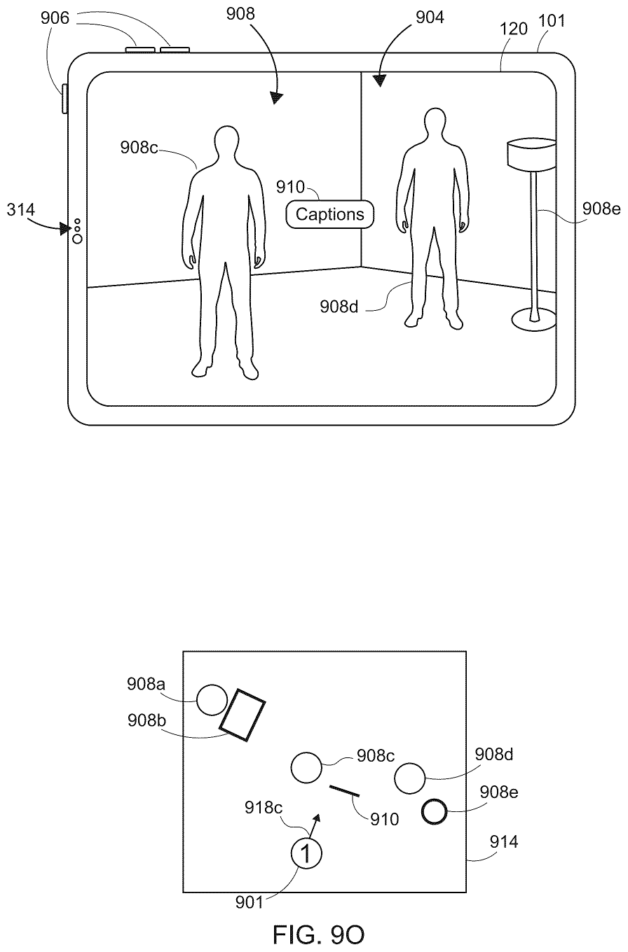

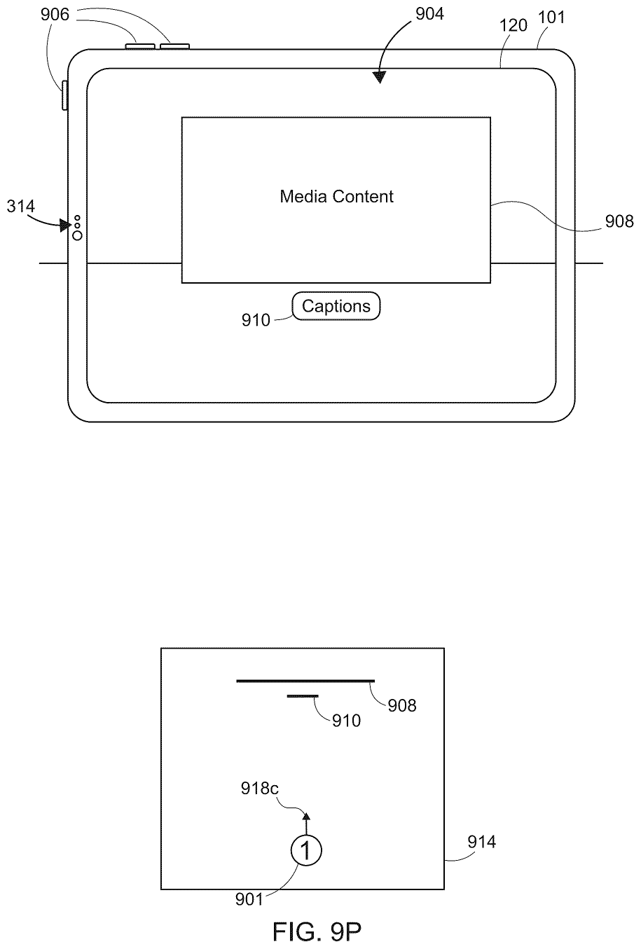

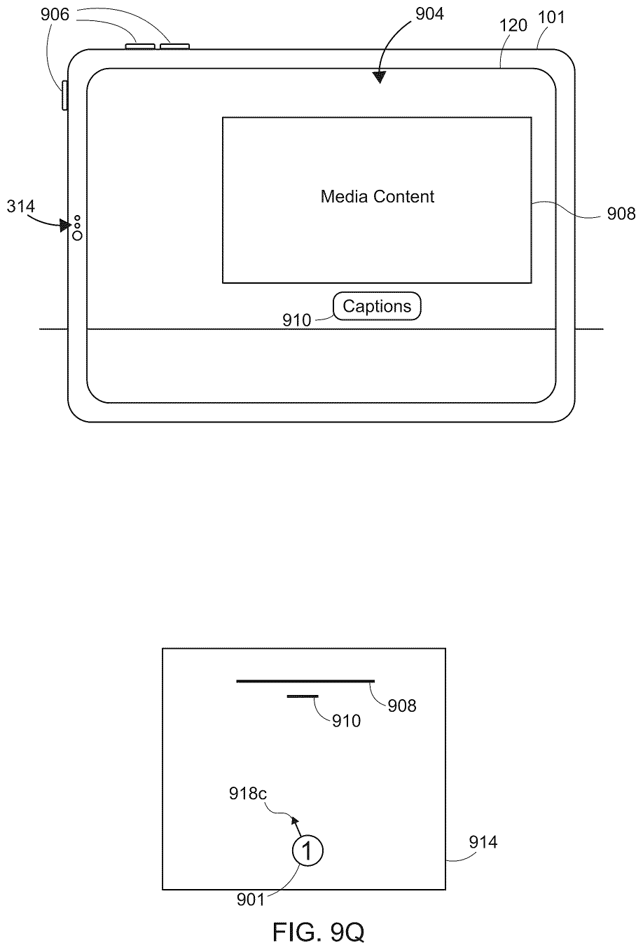

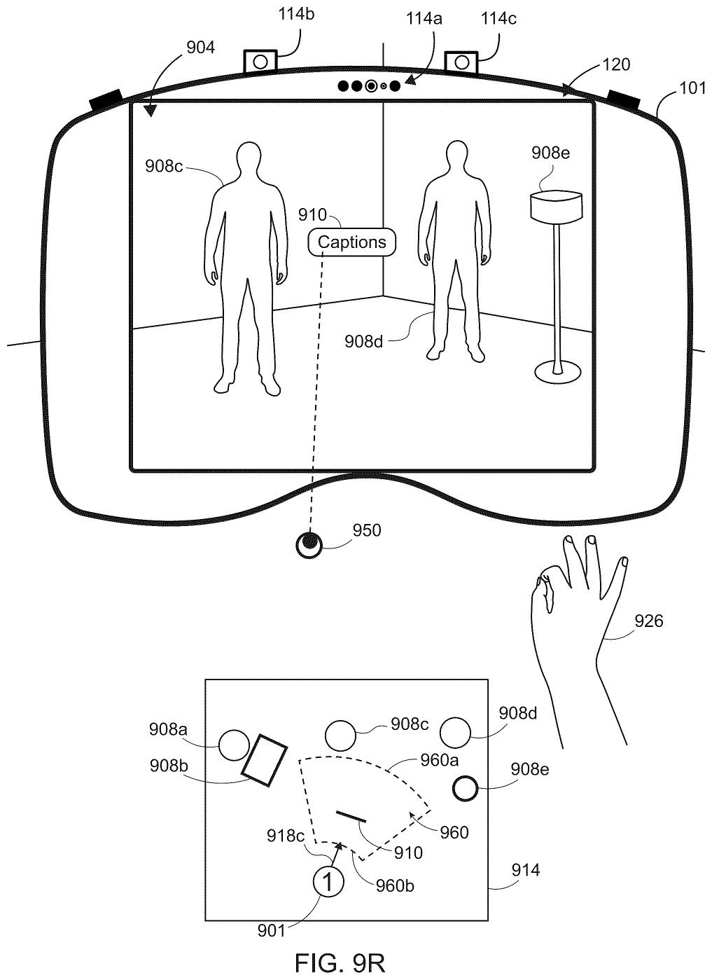

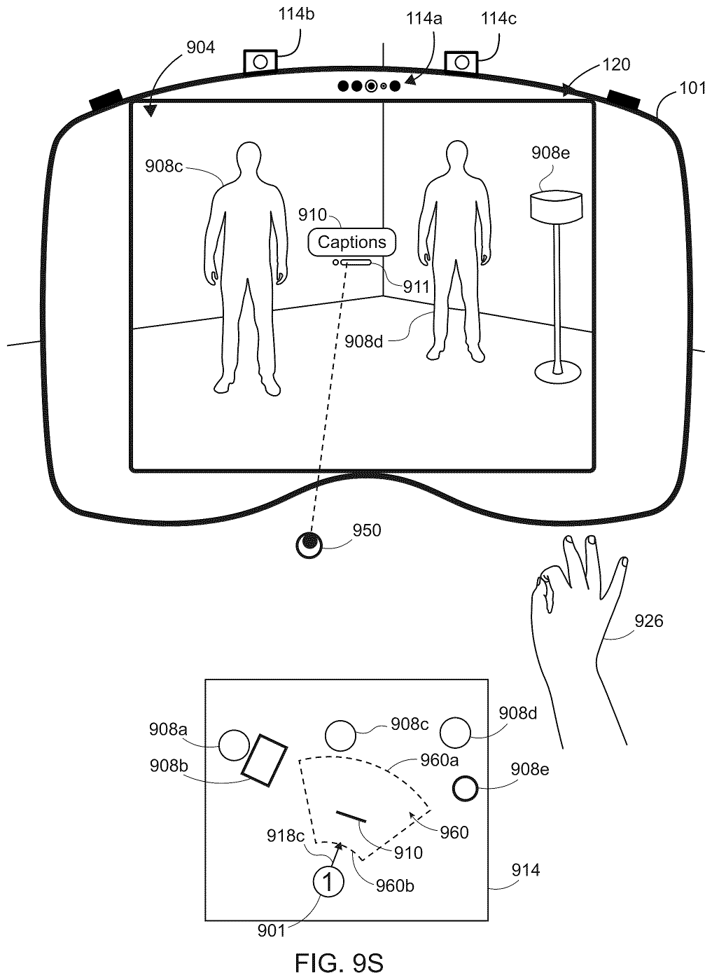

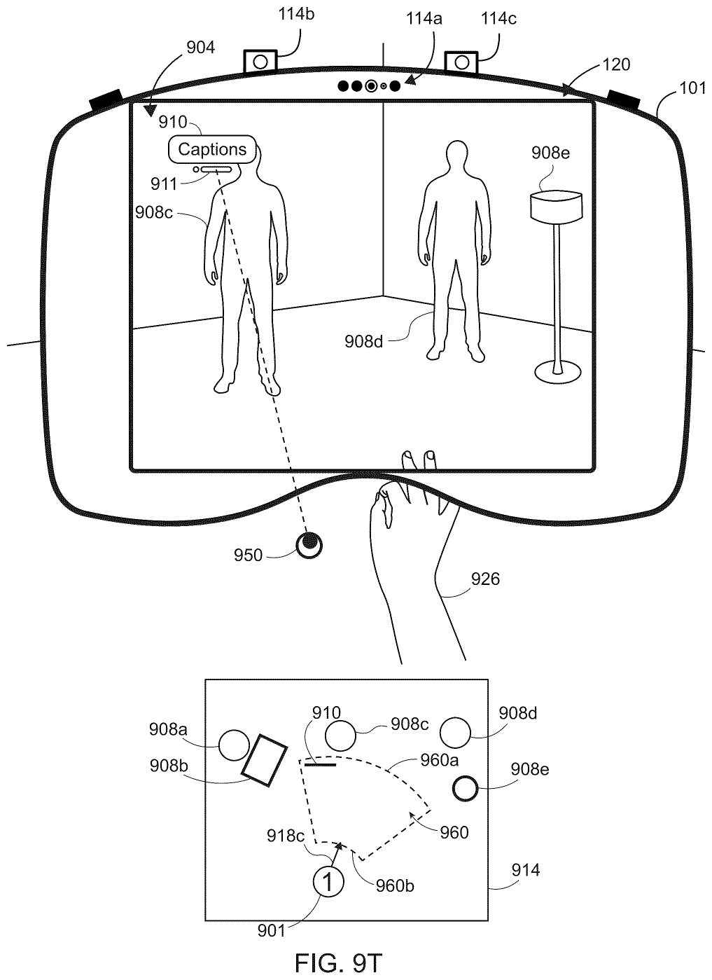

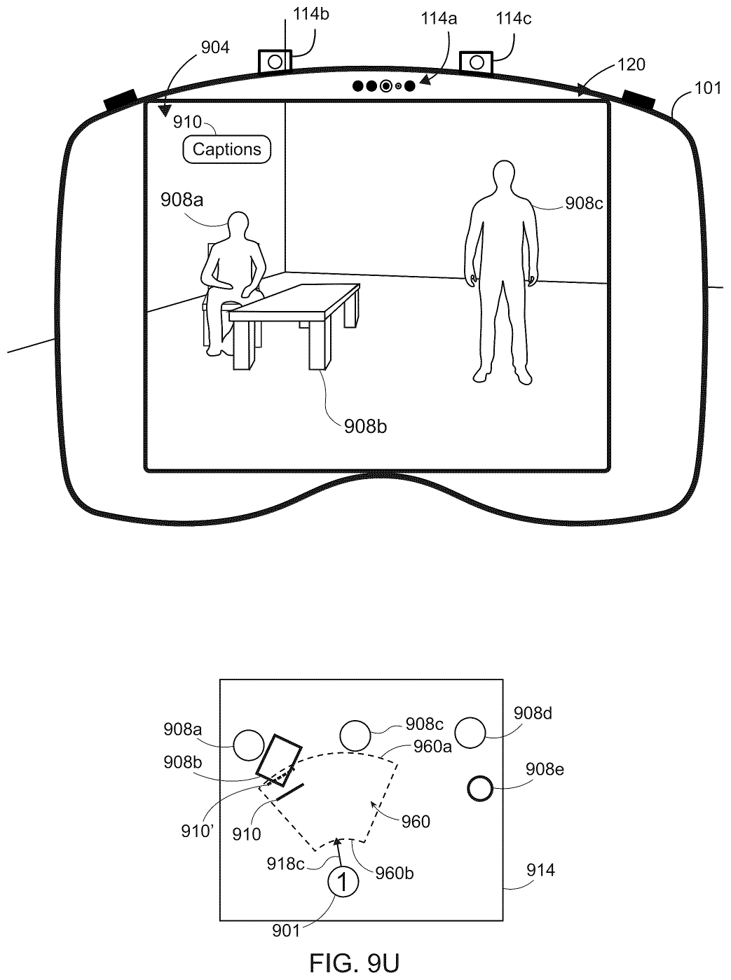

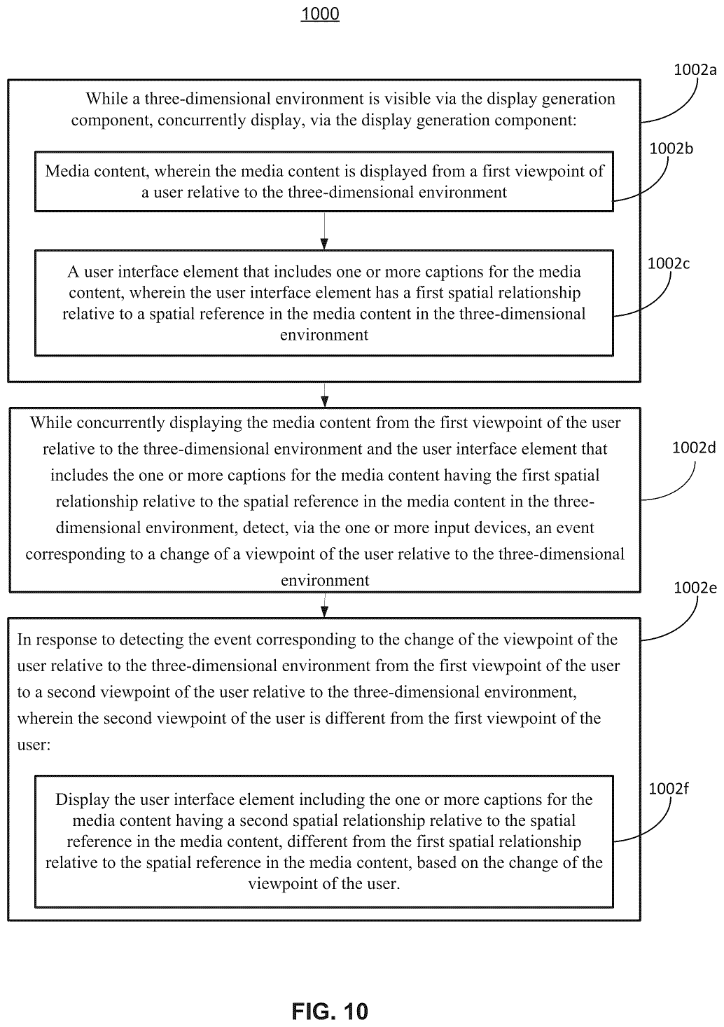

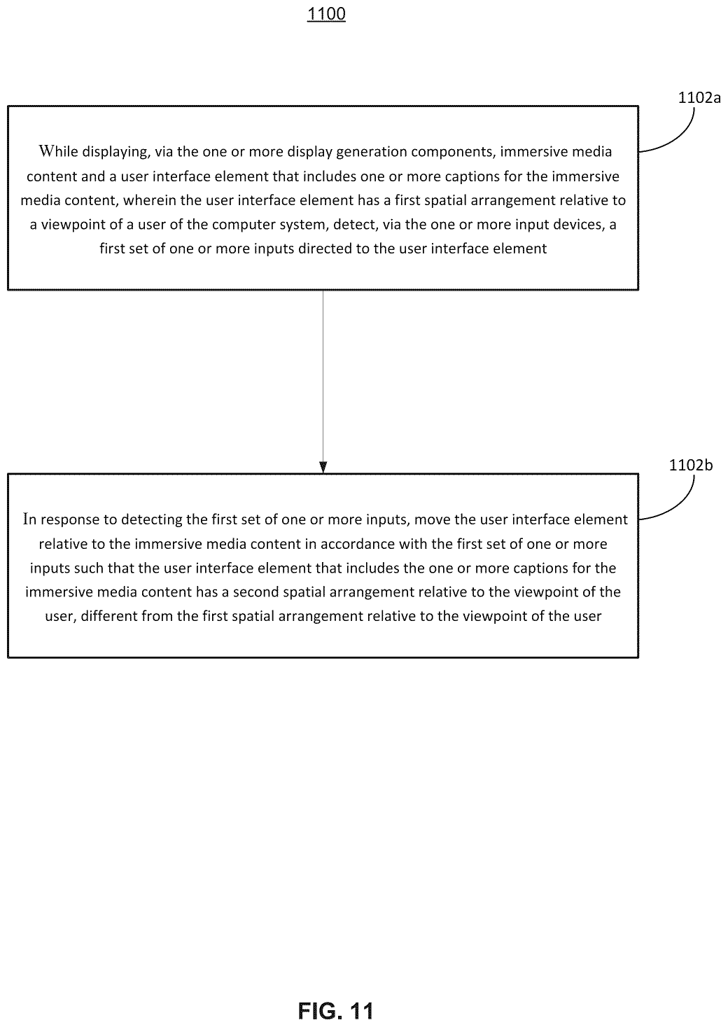

FIGS. 1A-6 provide a description of example computer systems for providing XR experiences to users (such as described below with respect to methods 800, 1000 and/or 1100). FIGS. 7A-7O illustrate examples of a computer system that displays media controls for media content based on a type of the media content, in accordance with some embodiments. FIG. 8 is a flow diagram illustrating an exemplary method of displaying media controls for media content based on a type of the media content in accordance with some embodiments. The user interfaces in FIGS. 7A-7O are used to illustrate the processes in FIG. 8. FIGS. 9A-9U illustrate examples of a computer system that displays captions for immersive media content that can move relative to a reference in the immersive media content, in accordance with some embodiments. FIGS. 10 and 11 are flow diagrams illustrating exemplary methods of displaying captions for immersive media content moveable to a reference in the immersive media content in accordance with some embodiments. The user interfaces in FIGS. 9A-9U are used to illustrate the processeses in FIGS. 10 and 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

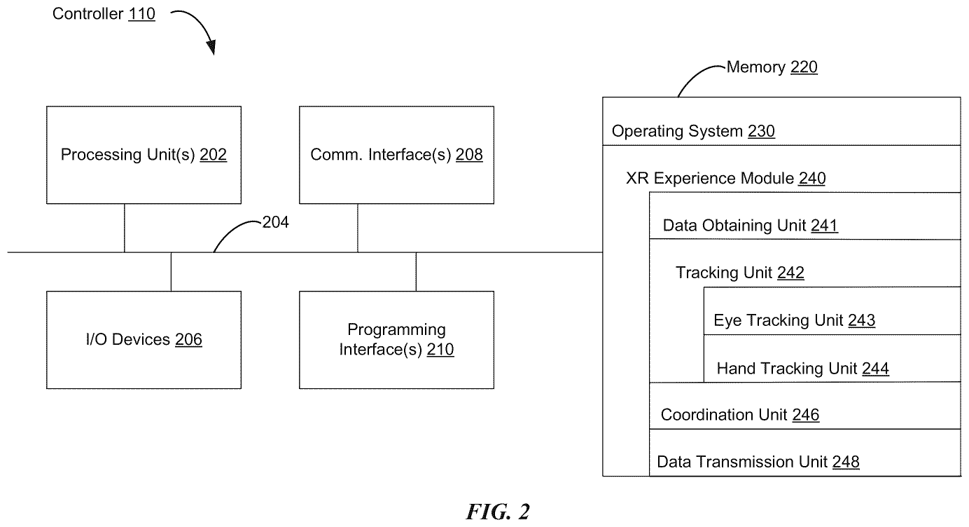

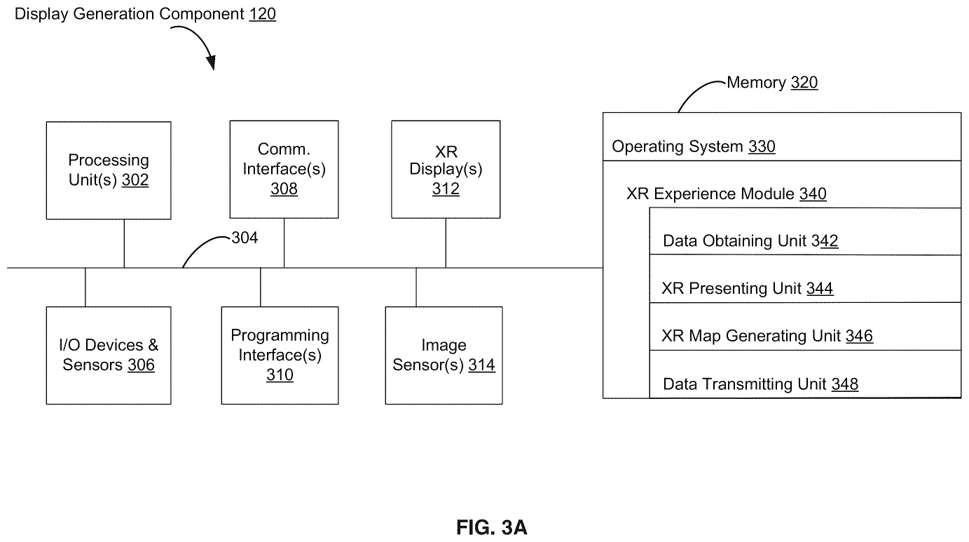

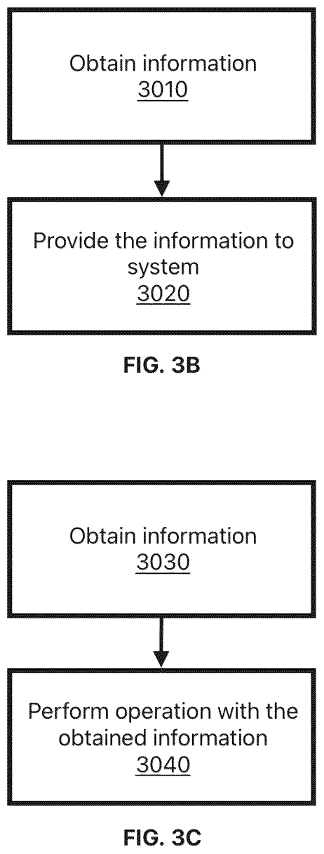

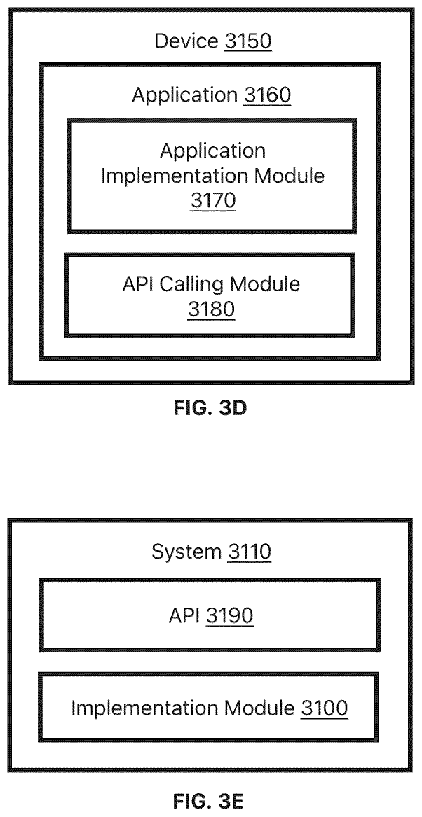

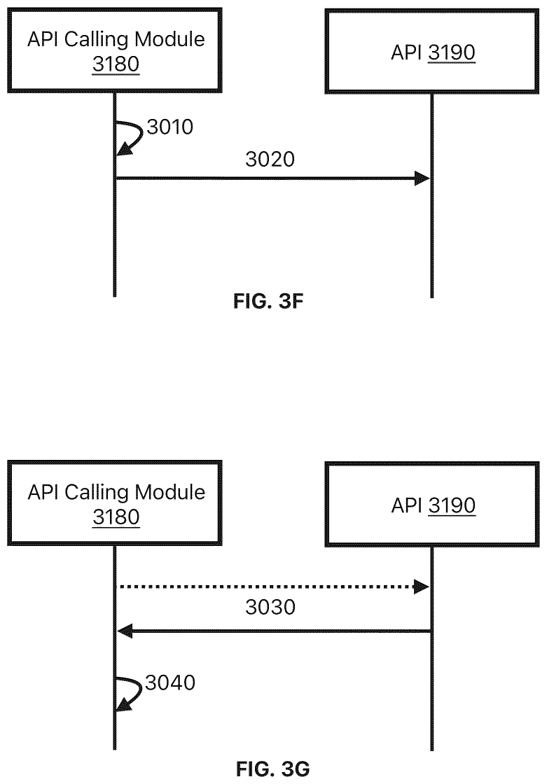

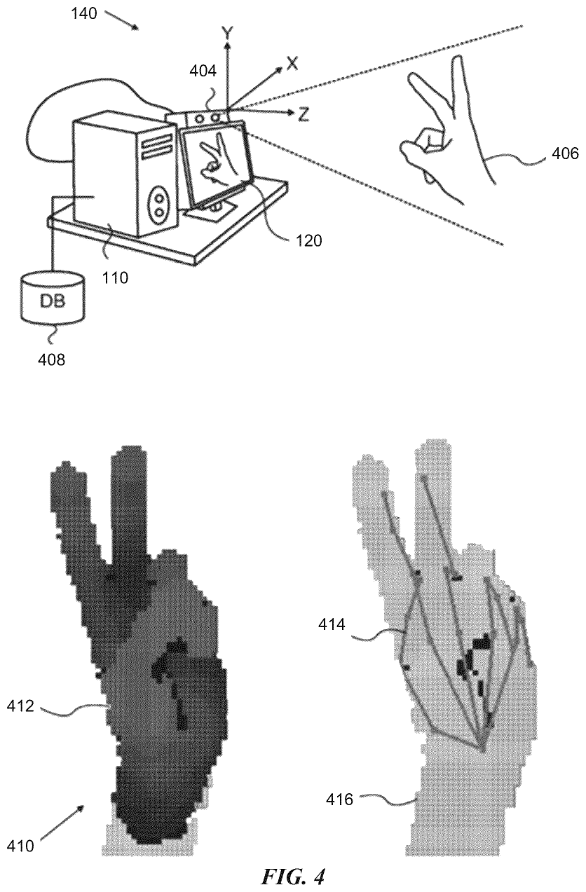

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be clastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-IF and described herein. Likewise, any of the features, components, and/or parts, including the arrangements and configurations thereof shown and described with reference to FIGS. 1D-IF can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-IF can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and IF can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the checks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, cither alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, cither alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, cither alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

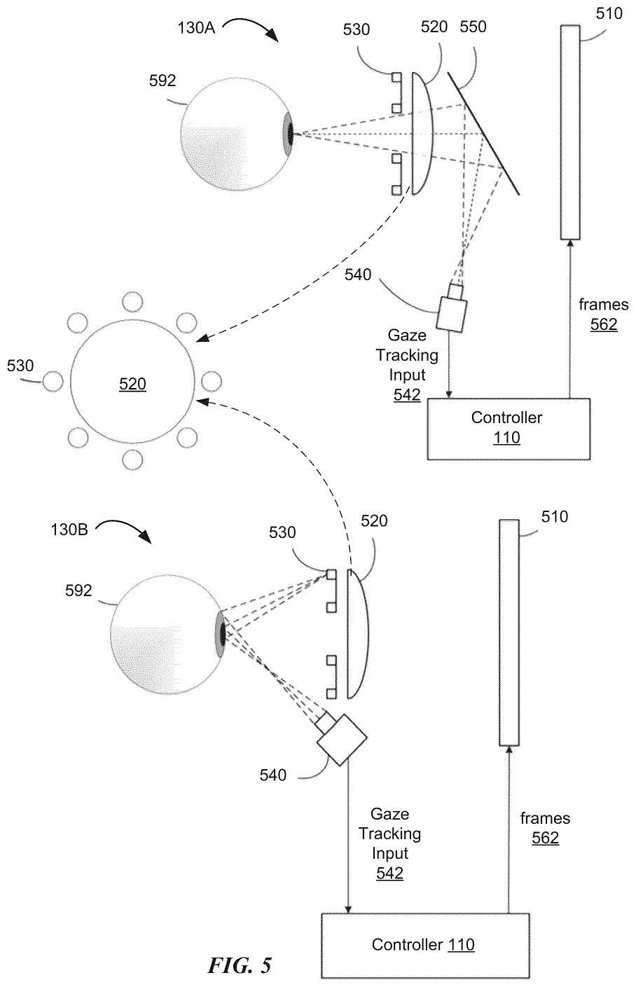

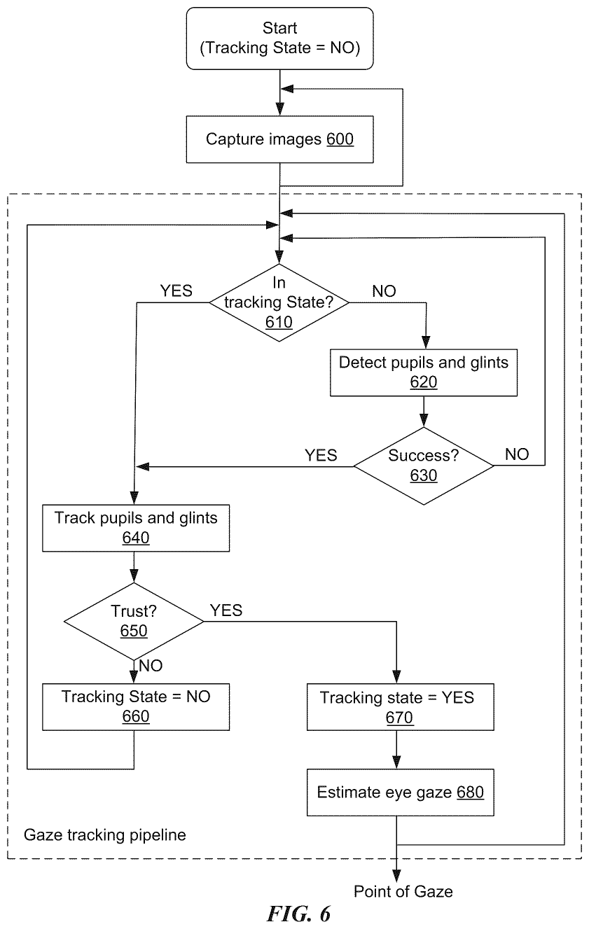

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In other embodiments, application 3160 is an application that is provided to device 3150 via an operating system update file (e.g., a first party application or a second party application). In other embodiments, application 3160 is an application that is provided via an application store. In some embodiments, the application store can be an application store that is pre-installed on device 3150 at purchase (e.g., a first party application store). In other embodiments, the application store is a third-party application store (e.g., an application store that is provided by another application store, downloaded via a network, and/or read from a storage device).

Referring to FIG. 3B and FIG. 31F, application 3160 obtains information (e.g., 3010). In some embodiments, at 3010, information is obtained from at least one hardware component of the device 3150. In some embodiments, at 3010, information is obtained from at least one software module of the device 3150. In some embodiments, at 3010, information is obtained from at least one hardware component external to the device 3150 (e.g., a peripheral device, an accessory device, a server, etc.). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on the device 3150. In some embodiments, the system (e.g., 3110 shown in FIG. 3E) is an external device (e.g., a server, a peripheral device, an accessory, a personal computing device, etc.) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and operating system (e.g., system 3110 shown in FIG. 3E). Application 3160 includes application implementation module 3170 and API calling module 3180. System 3110 includes API 3190 and implementation module 3100. It should be recognized that device 3150, application 3160, and/or system 3110 can include more, fewer, and/or different components than illustrated in FIGS. 3D and 31E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API calling module to communicate with system 3110 via API 3190 (shown in FIG. 3E).

In some embodiments, API 3190 is a software module (e.g., a collection of computer-readable instructions) that provides an interface that allows a different module (e.g., API calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In other embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is an system (e.g., operating system, server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or other hardware logic.

In some embodiments, implementation module 3100 returns a value through API 3190 in response to an API call from API-calling module 3180. While API 3190 defines the syntax and result of an API call (e.g., how to invoke the API call and what the API call docs), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus be both an API calling module and an implementation module. It should be recognized that implementation module 3100 can include additional functions, methods, classes, data structures, and/or other features that are not specified through API 3190 and are not available to API calling module 3180. It should also be recognized that API calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected the direct sensor data is frequently processes into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 3190 defines a first API call that can be provided by API calling module 3190. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7O illustrate examples of a computer system that displays media controls for media content differently based on a type of media content.

FIG. 7A illustrates a computer system (e.g., an electronic device) 101 displaying, via a display generation component (e.g., display generation component 120 of FIG. 1), a three-dimensional environment 704 from a viewpoint of the user of the computer system 101 (e.g., facing the back wall of the physical environment in which computer system 101 is located). In some embodiments, computer system 101 includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. Computer system 101 also includes physical buttons 706. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

In some embodiments, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 704. In some embodiments, portions of physical environment 702 are visible via the display generation component 120, such as via optical passthrough.

In FIG. 7A, computer system 101 (e.g., a desktop computer, laptop computer, a smartphone, tablet, smartwatch, wearable computer, or HMD) displays media 708 (e.g., a photo, a video, a movie, or another type of media) in three-dimensional environment 704 (e.g., an AR, VR, XR, MR, or AV environment). In some embodiments, media 708 is non-immersive media. For example, media 708 is optionally displayed and/or bounded within a planar or curved plane in three-dimensional environment 704 from the perspective of user 701. For example, media 708 is optionally displayed as a planar or curved user interface of an application (e.g., a media playback application). In FIG. 7A, computer system 101 detects input 710a from hand 712 (e.g., air pinch gesture) directed to media 708 (e.g., while attention of the user is directed to media 708). In response, computer system 101 displays playback control user interface 718, which includes media controls for controlling media 708. Playback control user interface 718 includes a rewind control 718a, a pause control 718b, a fast forward control 718c, a playback time indication that shows a relative playback position within media 708 that the media 708 has in FIG. 7A, and a user interface element 718e that is optionally selectable to display more controls. Playback control user interface 718 also includes user interface element 718f, which will be described in more detail with reference to FIG. 7J.

FIG. 7A1 illustrates similar and/or the same concepts as those shown in FIG. 7A (with many of the same reference numbers). It is understood that unless indicated below, elements shown in FIG. 7A1 that have the same reference numbers as elements shown in FIGS. 7A-7O have one or more or all of the same characteristics. FIG. 7A1 includes computer system 101, which includes (or is the same as) display generation component 120. In some embodiments, computer system 101 and display generation component 120 have one or more of the characteristics of computer system 101 shown in FIGS. 7A-7O and display generation component 120 shown in FIGS. 1 and 3, respectively, and in some embodiments, computer system 101 and display generation component 120 shown in FIGS. 7A-7O have one or more of the characteristics of computer system 101 and display generation component 120 shown in FIG. 7A1.

In FIG. 7A1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 7A-7O.

In FIG. 7A1, display generation component 120 is illustrated as displaying content that optionally corresponds to the content that is described as being displayed and/or visible via display generation component 120 with reference to FIGS. 7A-7O. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 7A1.

Display generation component 120 has a field of view (e.g., a field of view captured by external image sensors 314b and 314c and/or visible to the user via display generation component 120) that corresponds to the content shown in FIG. 7A1. Because display generation component 120 is optionally a head-mounted device, the field of view of display generation component 120 is optionally the same as or similar to the field of view of the user.

In FIG. 7A1, the user is depicted as performing an air pinch gesture (e.g., with hand 712) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 7A-7O.

In some embodiments, computer system 101 responds to user inputs as described with reference to FIGS. 7A-7O.

In the example of FIG. 7A1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 7A-7O and/or described with reference to the corresponding method(s) are optionally implemented on computer system 101 and display generation unit 120 in a manner similar or analogous to that shown in FIG. 7A1.

In FIG. 7B, as shown in overhead view 714, computer system 101 displays playback control user interface 718 in between the viewpoint of user 701 and media 708. In FIG. 7B, as shown in three-dimensional environment 704, the playback control user interface 718 is lower vertically than media 708. In FIG. 7B, computer system 101 displays playback control user interface 718 at a location in three-dimensional environment 704 that is based on a line (e.g., line 716 in FIG. 7A) between media 708 and the viewpoint of user when the input 710 from hand 712 was detected. As shown in overhead 714, a width of the playback control user interface 718 is optionally normal to a plane that is perpendicular to the line between line media 708 and the viewpoint of user when the input 710 from hand 712 was detected. In FIG. 7A, line 716 is optionally a line from the viewpoint of the user 701 to a center of the media 708. In FIG. 7A, in overhead view 714, the user 701 appears to be facing the normal of the center of media 708 head-on (e.g., an angular distance between the normal of the center of media 708 and part of the line 716 that intersects with viewpoint of user 701 (which is opposite the part of line 716 that intersects with center of media 708), as shown in overhead view 714 in FIG. 7A, is zero when viewed from overhead view 714 (e.g., independent of vertical components)). In some embodiments, playback controls user interface 718 is displayed at some angular distance (e.g., 3, 5, 10, 15, 30 or 45 degrees) below or above line 716 (and, optionally at some distance from the viewpoint of the user (e.g., 0.8 m, 0.9 m, 1 m, 1.1 m, 1.2 m. 1.3 m, 1.4 m, 1.5 m, 1.6 m, 1.7 m, 1.9 m, 2 m, 8 m, 12 m, or another distance away from the viewpoint of the user in FIG. 7A). In some embodiments, if the viewpoint of the user 701 was different than in FIG. 7A such that, for example, line 716 was rotated clockwise (e.g., by 0.9, 3, 7, 10, 20, 30, 40, 50 degrees or by another amount of rotation clockwise) about its pivot on the center of media 708 (e.g., such that in overhead view 714 of FIG. 7A, viewpoint of user 701 would be to the right of center of media 708) when the input to display playback controls is detected, computer system 101 optionally displays the playback controls based on that line that is in between the viewpoint of the user 701 and the location of the media 708 in three-dimensional environment 704. In some embodiments, if the viewpoint of the user 701 was different than in FIG. 7A such that, for example, the line 716 was rotated counterclockwise (e.g., by 0.9, 3, 7, 10, 20, 30, 40, 50 degrees or by another amount of rotation counterclockwise) about its pivot on the center of media 708 (e.g., such that in overhead view 714 of FIG. 7A, viewpoint of user 701 would be to the left of center of media 708) when the input to display playback controls is detected, the computer system optionally displays the playback controls based on that line that is in between the viewpoint of the user 701 and the location of the media 708 in three-dimensional environment 704. As such, computer system 101 optionally displays playback control user interface 718 based on a line that is in between the viewpoint of the user 701 and the media 708 when the input to display the playback control user interface 718 is detected, optionally perpendicular to a such that in the given example, in the overhead view 714. In FIG. 7B, the playback control user interface 718 is placed based on the line between media 708 and the viewpoint of user 701 when input 710 is received, optionally regardless of an orientation of the viewpoint of the user 701 (e.g., independent of a direction with which the user faces in three-dimensional environment e701). The placement of playback control user interface 718 in three-dimensional environment 704 when media is non-immersive is described further with reference to method 800.

In FIG. 7C, computer system 101 detects input 710b from hand 712 (e.g., air pinch gesture) directed to media 708, which is the same media as in FIG. 7B. In response, computer system 101 ceases display of playback control user interface 718, as shown in FIG. 7D. Input 710b from hand 712 can be directed anywhere outside of playback control user interface 718 and computer system 101 optionally ceases display of playback control user interface 718 as a result. Inputs to display playback control user interface 718 and inputs to cease display of playback control user interface 718 are described further with reference to method 800.

In FIG. 7E, three-dimensional environment 704 includes media 730 which is immersive media (e.g., three-dimensional content that optionally at least partially surrounds the user of computer system 101 in a view of the three-dimensional environment, 180 degree media, 360 degree media, and/or three-dimensional content for which the computer system simulates depth effect(s) optionally relative to a viewpoint(s) of the user, such that the user of computer system visually experiences the three-dimensional content as three-dimensional content, such as described regarding immersive media content with reference to method 800). Media 730 includes a piano concert scene. While user 701 observes the media 730, a gaze direction of the user changes so as to view various portions of media 730 and/or user 701 performs a head rotation to the left of media 730 to explore media 730 further, such as shown in FIG. 7F with the counter-clockwise rotation from FIG. 7E to FIG. 7F in overhead view 714 and resulting display of three-dimensional environment 704 in FIG. 7F. In FIG. 7G, while computer system 101 displays three-dimensional environment 704, computer system 101 detects input 710c from hand 712 (e.g., air pinch gesture) directed to a portion of three-dimensional environment 704 that optionally is part of immersive media 708. In response, computer system 101 displays playback control user interface 718 based on the direction of the gaze of the user when the input 710c was detected, optionally because media 730 is immersive media, as shown in FIG. 7H. In some embodiments, if the viewpoint of the user is same as in FIG. 7E relative to media 730 and the gaze direction of the user is on the piano when the input to display the playback control user interface 718 is received, computer system 101 optionally displays playback control user interface 718 based on the gaze direction of the user when the input was received, which was on the piano. In some embodiments, if the viewpoint of the user is same as in FIG. 7E relative to media 730 and the gaze direction of the user is directed to an element of the media 730 that is different from the piano when the input to display the playback control user interface is received, computer system 101 optionally displays playback control user interface 718 based on the gaze direction of the user when the input was received. As such, when media in three-dimensional environment is immersive, when playback controls for the immersive media are displayed, the computer system optionally displays the immersive media based on a gaze direction of the user when the input to display playback controls was received and/or based on an orientation of the viewpoint of the user when the input to display the playback controls was received. For example, when computer system 101 displays the playback controls corresponding to immersive media, the playbacks controls are placed (optionally, initially placed) based on the direction the user faces (e.g., the direction of the user head) in three-dimensional environment 704, optionally at an angle below a line facing the orientation of the viewpoint of the user (e.g., below the line connected to viewpoint of user 701 in FIG. 7G) when the input to display the playback controls is detected. The placement of playback control user interface 718 in three-dimensional environment 704 when media is immersive is described further with reference to method 800.

In some embodiments, computer system 101 ceases displaying playback control user interface 718 when no input is detected for a threshold period of time (e.g., 1, 3, 5, 10, 15 or 30 seconds), such as shown in FIG. 71. In FIG. 71, time indication glyph 715a shows a representation of a current amount of time since detecting input directed to playback control user interface 718 (e.g., playback control user interface 718 of FIG. 7H), as shown with the fill 715c of time indication glyph 715a, and the fill has passed the threshold amount of time 715b. As such, computer system 101 ceases displaying playback control user interface 718 because computer system 101 has not detect input directed to playback control user interface 718 of FIG. 7H for the threshold period of time 715b. Ceasing display of display playback control user interface 718 in response to not detecting input directed to playback control user interface 718 is described further with reference to method 800.

In FIG. 7J, computer system 101 displays expandable, immersive media 734 in three-dimensional environment 704. Expandable, immersive media 734 can optionally be displayed in a compact mode and in an expanded mode, such as described further with reference to method 800. In FIG. 7J, computer system 101 displays expandable, immersive media 734 in compact mode. In FIG. 7J, computer system 101 also displays playback control user interface 718. In FIG. 7J, playback control user interface 718 is optionally displayed at a location that is based a location of the media 734. For example, in FIG. 7J, playback control user interface 718 is optionally displayed at some angle (e.g., 3, 5, 10, 15, 30, 45 or 50 degrees) below the line between viewpoint of the user and/or head of user and expandable, immersive media 734 in compact mode (optionally, based on line between viewpoint of the user and center 736 of expandable, immersive media 734 in compact mode), with playback control user interface titled up or down towards the viewpoint of the user and/or head of user based on whether the playback control user interface is displayed above or below the user's head. For example, in FIG. 7J, playback control user interface is displayed below the head of user 701 and is titled up as shown in side view 713. For example, computer system 101 optionally displays playback control user interface 718 of FIG. 7J in the compact mode based on a vertical component magnitude of the location of expandable, immersive media 734 in compact mode, as shown in FIGS. 7J and 7K. In FIG. 7K, the vertical component magnitude of the location of expandable, immersive media 734 in compact mode is higher (e.g., relative to the location of the viewpoint of the user and/or the location of the head of the user) than the vertical component magnitude of the location of expandable, immersive media 734 in compact mode in FIG. 7J (e.g., in FIG. 7J, in representative side view 713, the horizontal reference line 715 extends through the center of user 701 and through center 736 of expandable, immersive media 734 in compact mode, while in FIG. 7K, in representative side view 713, the horizontal reference line 715 extends through the center of user 701, without extending through center 736 of expandable, immersive media 734 in compact mode). In FIG. 7K, computer system 101 displays playback control user interface 718 at a location (e.g., a three-dimensional location) that has a vertical component magnitude that is larger than the vertical component magnitude of playback control user interface 718 in FIG. 7J. For example, computer system 101 optionally displays playback control user interface 718 based on a vertical component magnitude of a center 736 of expandable, immersive media 734 in compact mode, which has a higher vertical component magnitude in FIG. 7K than FIG. 7J.

While displaying expandable, immersive media 734 in compact mode and while displaying playback control user interface 718, computer system 101 detects an input 710d directed to user interface element 718f, as shown in FIG. 7J. In FIG. 7J, user interface element 718f corresponds to a request to display expandable, immersive media 734 in expanded mode. In response to detecting input 710d, computer system 101 visually transitions from displaying expandable, immersive media 734 in compact mode to displaying expandable, immersive media 734 in expanded mode, such as shown in FIGS. 7L and 7M.

FIG. 7L illustrates computer system 101 displaying expandable, immersive media 734 of FIG. 7J transitioning from the compact mode to the expanded mode. FIG. 7M illustrates computer system 101 displaying expandable, immersive media 734 of FIG. 7J in the expanded mode and displaying playback control user interface 718 while displaying expandable, immersive media 734 of FIG. 7J in the expanded mode. As shown in overhead view 714 of FIG. 7M, expandable, immersive media 734 of FIG. 7M surrounds the user. In some embodiments, expandable, immersive media 734 of FIG. 7M optionally partially or fully surrounds the user (e.g., as a 180 degree or 360 degree video). In some embodiments, computer system 101 displays playback control user interface 718 in FIG. 7M in response to detecting input to display playback control user interface 718 while displaying expandable, immersive media 734 in expanded mode (e.g., an air pinch input while attention of the user is directed to expandable, immersive media 734). In some embodiments, in FIG. 7M, computer system 101 displays playback control user interface 718 because playback control user interface 718 was displayed while displaying expandable, immersive media 734 in compact mode and a threshold period of time since detecting interaction with playback control user interface 718 (which optionally was displayed in response to detecting input to display playback control user interface while displaying expandable, immersive media 734 in compact mode) has not yet passed, such as threshold 715b described with reference to FIG. 71.

In FIG. 7M, computer system 101 displays playback control user interface 718 and expandable, immersive media 734 in the expanded mode as a result of input 710c of FIG. 7J that was for displaying expandable, immersive media 734 of FIG. 7J in the expanded mode. In FIG. 7N, computer system 101 displays playback control user interface 718 and expandable, immersive media 734 in the expanded mode as a result of input for displaying expandable, immersive media 734 of FIG. 7K (which has a center 736 that has a higher vertical magnitude than the center 736 of expandable, immersive media 734 of FIG. 7J). The placement of playback control user interface 718 in FIGS. 7M and 7N is optionally based on the orientation of the viewpoint of user 701 and the vertical component of the placement of playback control user interface 718 is optionally based on (e.g., is the same as) the vertical component of the location of playback control user interface 718 when the computer system 101 displayed the expandable, immersive media 734 in compact mode. For example, the vertical component of the location of playback control user interface 718 in FIG. 7M is optionally the same as the vertical component of the location of playback control user interface 718 when computer system 101 displayed playback control user interface 718 in FIG. 7J with expandable, immersive media 734 in compact mode. Also, the vertical component of the location of playback control user interface 718 in FIG. 7N is optionally the same as the vertical component of the location of playback control user interface 718 when computer system 101 displayed playback control user interface 718 in FIG. 7K with expandable, immersive media 734 in compact mode.

In some embodiments, computer system 101 displays expandable, immersive media 734 in expanded mode after a threshold period of time (0.5, 3, 5, 10, 20, 30 seconds, or another time threshold) has passed since displaying expandable, immersive media 734 in compact mode. In some embodiments, computer system 101 automatically switches displaying expandable, immersive media 734 from compact mode to expanded mode and automatically switches displaying expandable, immersive media 734 from compact mode to expanded mode based on timing data associated with expandable, immersive media 734. In some embodiments, computer system 101 automatically switches displaying expandable, immersive media 734 from compact mode to expanded mode and automatically switches displaying expandable, immersive media 734 from expanded mode to compact mode based on data that is associated with a user (e.g., timing between breaths of the user) such that computer system 101 automatically switches displaying expandable, immersive media 734 from compact mode to expanded mode and automatically switches displaying expandable, immersive media 734 from expanded mode to compact mode to simulate an ideal breathing pattern for user 701 (e.g., to match a cadence or period of such breathing pattern).

In some embodiments, while displaying playback control user interface 718 and while displaying expandable, immersive media 734 of FIG. 7J in the expanded mode, the yaw of playback control user interface 718 can change in accordance with movement of the user 701 (e.g., the yaw optionally moves with the head of user 701), as shown in FIG. 7O. For example, from FIG. 7N to FIG. 7O, the orientation of the viewpoint of user 701 has shifted counterclockwise in overhead view 714, which optionally corresponds to an event of user 701 performing a head rotation left from FIG. 7N to FIG. 7O. As a result of detecting the event, computer system 101 changes the yaw of playback control user interface 718 in three-dimensional environment 704, as shown in overhead view 714 and representative side view 713 in FIG. O, optionally to cause user 701 to have an ideal view of playback control user interface 718 while exploring the expandable, immersive media 734 of FIG. O in the expanded mode (e.g., the playback controls remaining perpendicular to the viewpoint of the user and/or remaining at the same relative position relative to the viewpoint of the user as the user changes their viewpoint). The vertical component of the playback control user interface 718 is optionally maintained in response to the event, as shown from FIG. 7N to 70. In some embodiments, when computer system 101 displays expandable, immersive media 734 with playback control user interface 718, the playback control user interface 718 is optionally is world-locked; as such, as user 701 explores expandable, immersive media 734, playback control user interface 718 optionally remain at the same position in three-dimensional environment 704. The placement of playback control user interface 718 in three-dimensional environment 704 when media is expandable, immersive media is described further with reference to method 800.

FIGS. 7A-7O are further described with reference to method 800.

FIG. 8 is a flow diagram illustrating an exemplary method of displaying media controls for media content based on a type of the media content in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a computer system in communication with a display generation component and one or more input devices. For example, the computer system is or includes a mobile device (e.g., a tablet, a smartphone, a media player, or a wearable device), or a computer. In some embodiments, the display generation component is a display integrated with the computer system, such as a touch-sensitive display or a non touch-sensitive display, external display such as a monitor, projector, television, and/or a hardware component (optionally integrated or external) for projecting a user interface or causing a user interface to be visible to one or more users. In some embodiments, the one or more input devices include a device or component capable of receiving a user input (e.g., capturing a user input, and/or detecting a user input) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor). In some embodiments, the computer system is in communication with a hand tracking device (e.g., one or more cameras, depth sensors, proximity sensors, and/or touch sensors (e.g., a touch screen, trackpad)). In some embodiments, the hand tracking device is a wearable device, such as a smart glove.

In some embodiments, while a three-dimensional environment is visible via the display generation component, the computer system displays, via the display generation component, media content, such as content 708 in FIGS. 7A and 7A1. In some embodiments, the three-dimensional environment includes objects of virtual passthrough and/or objects of optical passthrough, such as discussed above in this present disclosure. In some embodiments, the three-dimensional environment does not include virtual passthrough and does not include optical passthrough. In some embodiments, the media content is planar media content such as content including an appearance of being two-dimensional from the viewpoint of the user, or three-dimensional media content. In some embodiments, the computer system displays the media content in an immersive viewing environment, such as in a cinematic environment that the computer system simulates and displays via the display generation component. In some embodiments, the media content is docked in the three-dimensional environment (e.g., a docked location or a predetermined location that the three-dimensional environment or computer system optionally defines, at which the respective media content optionally resides and/or is not movable during a full-screen or docked mode of the respective media content or another mode). In some embodiments, the media content is immersive media content, such that a user of the computer system can observe the media content from different perspectives (e.g., different viewpoints and depths). In some embodiments, the media content is non-immersive media content, such as a two-dimensional representation of a movie, an episode, a clip, or an image. In some embodiments, the media content is a photo, video, a virtual object, an augmentation of a physical object, a user interface of an application, a media playback application including media content, and/or another type of media content. In some embodiments, the media content is associated with audio that the computer system generates. In some embodiments, the three-dimensional environment includes a virtual environment. The virtual environment optionally includes a visual scene in which the user is fully or partially immersed, such as a scene of a campground, a sky, of outer space, and/or other suitable virtual scenes. In some embodiments, the virtual environment is a simulated three-dimensional environment that is displayed in the three-dimensional environment, optionally instead of the representations of the physical environment (e.g., full immersion) or optionally concurrently with the representation of the physical environment (e.g., partial immersion). Some examples of a virtual environment include a lake environment, a mountain environment, a sunset scene, a sunrise scene, a nighttime environment, a grassland environment, and/or a concert scene. In some embodiments, a virtual environment is based on a real physical location, such as a museum and/or an aquarium, or is based on an artist-designed location. Thus, displaying a virtual environment in the three-dimensional environment optionally provides the user with a virtual experience as if the user is physically located in the virtual environment. In some embodiments, the computer system displays the media content in the virtual environment.

In some embodiments, the computer system detects, via the one or more input devices, an event, such as an input from hand 712 in FIGS. 7A and 7A1. In some embodiments, the event corresponds to a request to change a playback status of the media content. For example, the event optionally corresponds to a request to initiate, stop, and/or change a playback speed of the media content. In some embodiments, the event corresponds to a trigger to display playback controls for the media content while the computer system continues to display the media content. In some embodiments, the event is or includes attention of the user (e.g., gaze) and/or an air gesture (e.g., a respective air gesture described below), such as described throughout this disclosure above and below, corresponding to a request to display playback controls for the media content.

In some embodiments, in response to detecting the event, the computer system concurrently displays, via the display generation component the media content, and a playback control user interface including one or more selectable options for performing one or more actions associated with the media content, wherein the playback control user interface is spatially separated from the media content in the three-dimensional environment, such as controls 718 in FIG. 7B (optionally at a location in the three-dimensional environment that is based on a type of the media content). In some embodiments, the one or more selectable options that are selectable to play, pause, skip forward in the media content or beyond the media content in current playback, skip backward in the media content or beyond the media content in current playback, seek, modify a width or height of the media content that the computer system displays (e.g., to simulate changing seats and/or seat rows in a movie theater), and/or perform another playback control operation on the media content. In some embodiments, the selectable options include one or more options for changing a viewpoint in the three-dimensional environment from which a user of the computer system observes the media content. In some embodiments, while displaying the playback control user interface, the computer system detects an input corresponding to a selection of one of the one or more selectable options for performing one or more actions associated with the media content, and in response to detecting the selection, the computer system performs the one or more actions associated with the media content based on which control is selected. In some embodiments, in accordance with a determination that (e.g., in response to detecting that) the input corresponds to a selection of a first selectable option of the one or more selectable options, the computer system performs a first operation (e.g., a first set of one or more actions), and in accordance with a determination that the input corresponds to a selection of a second selectable option, different from the first selectable option, of the one or more selectable options, the computer system performs a second operation (e.g., a first set of one or more actions), different from the first operation. As such, the computer system optionally determines which operation to perform based on which selectable option is selected.

In some embodiments, displaying the playback control user interface includes in accordance with a determination that (e.g., in response to detecting that) a viewpoint of a user is a first viewpoint of the user when the event is detected, displaying the playback control user interface at a first location (e.g., a first position in a coordinate system, such as a three-dimensional environment coordinate system) between the first viewpoint of the user and the media content in the three-dimensional environment, such as the position of controls 718 in FIG. 7J (e.g., a distance between the first viewpoint of the user and the first location is smaller than a distance between the first viewpoint of the user and the media content (optionally such that a distance from the first viewpoint of the user to the playback control user interface (along an axis of a plane of the three-dimensional environment that is perpendicular to the up direction (e.g., the up direction described below)) is smaller than a distance from the first viewpoint of the user to the media content).

In some embodiments, displaying the playback control user interface includes in accordance with a determination that (e.g., in response to detecting that) the viewpoint of the user is a second viewpoint of the user, different from the first viewpoint, displaying the playback control user interface at a second location (e.g., a second position in a coordinate system, such as a three-dimensional environment coordinate system), different from the first location, in the three-dimensional environment between the second viewpoint of the user and the media content in the three-dimensional environment, such as the position of controls 718 in FIG. 7K (e.g., a distance between the second viewpoint of the user and the second location is smaller than a distance between the second viewpoint of the user and the media content (optionally such that a distance from the second viewpoint of the user to the playback control user interface (along an axis of a plane of the three-dimensional environment that is perpendicular to the up direction (e.g., the up direction described below)) is smaller than a distance from the second viewpoint of the user to the media content). As such, the computer system optionally displays the playback control user interface relative to a viewpoint of the user at a location between the viewpoint and the media content, based on the location and/or orientation of the viewpoint when the computer system detects the event. In some embodiments, the computer system displays the playback control user interface with a predefined orientation relative to the three-dimensional environment (e.g., with a pitch, yaw, and/or roll that is optionally zero and/or nonzero in amount relative to the three-dimensional environment). In some embodiments, the computer system displays the playback control user interface based on the media content and the viewpoint of the user relative to the media content. For example, the computer system optionally determines a location of the viewpoint of the user relative to a portion of the media content, such as relative to a center position of the media content, and/or determines a location of the portion of the media content relative to a viewpoint of a user. Continuing with this example, based on a determination of one or both of these relative locations, the computer system optionally displays the playback control user interface at a position between the media content and the viewpoint of the user. Additionally or alternatively, the computer system optionally displays the playback control user interface based on a type of the media content, optionally in addition to based on the media content and the viewpoint of the user relative to the media content; such features are described further below. Displaying the playback control user interface spatially separate from the media content relative to a viewpoint of the user at a location between the viewpoint of the user and the media content in response to detecting an event enables more accurate recognitions of inputs directed to the playback control user interface because the computer system displays the playback content user interface spatially separate from the media content in the three-dimensional environment and ensures that the playback control user interface is interactable from different viewpoints, thus reducing inputs involved with placing the playback control user interface at an appropriate location.

In some embodiments, the media content is non-immersive, such as content 708 in FIGS. 7A and 7A1 (e.g., is optionally displayed and/or bounded within a planar or curved plane from the perspective of the first user and/or in which elements of the media content optionally do not include depth dimensions (e.g., user-perceivable depth dimensions)), the first location (described above with reference to step(s) 802) is based on (e.g., is a function of) a respective line (e.g., a hypothetical line) between the media content and the first viewpoint of the user, and the second location (described above with reference to step(s) 802) is based on (e.g., is a function of) a respective line (e.g., a hypothetical line) between the media content and the second viewpoint of the user, such as line 716 in FIGS. 7A and 7A1. For example, when (e.g., in accordance with a determination that) the respective line between the media content and the first viewpoint of the user is a first line from the first viewpoint of the user to the media content (e.g., to a reference location (e.g., a reference position in a coordinate system, such as a three-dimensional environment coordinate system) in the media content) when the event is detected, the playback control user interface optionally has a first respective location (e.g., a first respective position and/or orientation in the coordinate system); when (e.g., in accordance with a determination that) the respective line between the media content and the first viewpoint of the user is a second line from the first viewpoint of the user to the media content (e.g., to the reference location (e.g., the reference position discussed above) in the media content) when the event is detected, different from the first line from the first viewpoint of the user to the media content, the playback control user interface optionally has a second respective location (e.g., a second position in the coordinate system discussed above) that is different from the first respective location. In another example, when (e.g., in accordance with a determination that) the respective line between the media content and the second viewpoint of the user is a first line from the second viewpoint of the user to the media content (e.g., to a reference location in the media content) when the event is detected, the playback control user interface optionally has a second respective location; when (e.g., in accordance with a determination that) the respective line between the media content and the second viewpoint of the user is a second line from the first viewpoint of the user to the media content (e.g., to a first reference location in the media content) when the event is detected, different from the first line from the second viewpoint of the user to the media content (e.g., to the first reference location in the media content), the playback control user interface optionally has a second respective location that is different from the first respective location. In some embodiments, the reference location in the media content is a center location in the media content, and the respective line between the media content and the first viewpoint of the user is a line from the first viewpoint of the user to the center location in the media content, such as a center of a virtual screen (e.g., application window) in which the media content is displayed. In some embodiments, when (e.g., in accordance with a determination that) the media content is immersive, the computer system displays the playback control user interface at an angular distance below the respective line (described above) relative to the respective viewpoint of the user, such as 0.9 degrees, 1 degree, 3 degrees, 5 degrees, 7 degrees, 10 degrees, 14 degrees, 21 degrees, 25 degrees, 27 degrees, 30 degrees, 35 degrees, or another angular distance below the respective line relative to the respective viewpoint of the user, and at distance (e.g., 0.8 m, 0.9 m, 1 m, 1.1 m, 1.2 m. 1.3 m, 1.4 m, 1.5 m, 1.6 m, 1.7 m, 1.9 m, 2 m, 8 m, 12 m, or another distance) from the respective viewpoint of the user). In some embodiments, the respective line is associated with a respective vector from the first viewpoint of the user to the media content, such as a vector from the first viewpoint of the user to the center of the media content that is optionally also zeroed vertically such that a magnitude of the vertical component of the respective vector is zero, and the first location (e.g., of the center of the playback control user interface) is derived by rotating the respective vector around an axis defined by the cross product of the respective vector and an up direction (e.g., a unit vector that faces a vertically upward direction that at the location of the computer system, such as a direction that is antiparallel to a direction of gravity (e.g., the direction of gravity is optionally vertically downward) at the computer system) by an angular distance (e.g., +0.9 degrees, +1 degrees, +3 degrees, +5 degrees, +7 degrees, +10 degrees, +14 degrees, +21 degrees, +25 degrees, +27 degrees, +30 degrees, +35 degrees, or another angular distance) and displaying the playback control user interface at a respective distance away from the first viewpoint of the user, such as 0.8 m, 0.9 m, 1 m, 1.1 m, 1.2 m. 1.3 m, 1.4 m, 1.5 m, 1.6 m, 1.7 m, 1.9 m, 2 m, 8 m, 12 m, or another distance away from the first viewpoint of the user, that is optionally in between the media content and the first viewpoint of the user and/or is optionally normal the respective vector, as rotated above. When the media content is non-immersive, displaying the playback control user interface based on a respective line between the viewpoint of the user and the media content in response to detecting an event permits user interaction with the playback control user interface while the media content is visible from the viewpoint of the user, enables more accurate recognitions of inputs directed to the playback control user interface because the computer system displays the playback content user interface spatially separate from the media content in the three-dimensional environment, and reduces user inputs involved with placing the playback control user interface at an appropriate location.

In some embodiments, the media content is immersive, such as content 730 in FIG. 7E (e.g., three-dimensional content that optionally at least partially surrounds the user of the computer system in a view of the three-dimensional environment, 180 degree media, 360 degree media, and/or three-dimensional content for which the computer system simulates depth effect(s) optionally relative to a viewpoint(s) of the user, such that the user of computer system visually experiences the three-dimensional content as three-dimensional content), the first location (described above with reference to step(s) 802) is based on (e.g., is determined as a function of) a respective orientation of the first viewpoint of the user (and/or optionally a first gaze direction of the user) when the event is detected, and such as the orientation of the viewpoint of the user 701 in FIG. 7F, the second location (described above with reference to step(s) 802) is based on (e.g., is determined as a function of) a respective orientation of the second viewpoint of the user when the event is detected, different from the respective orientation of the first viewpoint of the user, such as the orientation of the viewpoint of the user 701 in FIG. 7E (and/or a second gaze direction of the user that is optionally different from the first gaze direction of the user). For example, when (e.g., in accordance with a determination that) the respective orientation of the first viewpoint of the user is a first orientation when the event is detected, the first location of the playback control user interface is optionally a first respective location; when (e.g., in accordance with a determination that) the respective orientation of the first viewpoint of the user is a second orientation when the event is detected, different from the first orientation, the first location of the playback control user interface is optionally a second respective location different from the first respective location. In another example, when (e.g., in accordance with a determination that) the respective orientation of the second viewpoint of the user is a first orientation when the event is detected, the second location of the playback control user interface is optionally a first respective location; when (e.g., in accordance with a determination that) the respective orientation of the second viewpoint of the user is a second orientation when the event is detected, different from the first orientation, the second location of the playback control user interface is optionally a second respective location different from the first respective location. In some embodiments, the respective orientation of the respective viewpoint of the user corresponds to a direction that the respective viewpoint of the user faces in (e.g., relative to) the three-dimensional environment. In some embodiments, the respective orientation is based on an orientation of portion of the user (e.g., a head) in (e.g., relative to) the three-dimensional environment. In some embodiments, the computer system displays the playback controls at a location that is based on the direction (e.g., head direction and/or head orientation) that the respective viewpoint of the user faces in (e.g., relative to) the three-dimensional environment, optionally alternatively to, or in addition to displaying the playback controls at a location that is based on direction of the user's gaze in the three-dimensional environment from the respective viewpoint of the user (e.g., 2 degrees, 5 degrees, 10 degrees, 20 degrees, 30 degrees, and/or another angle below a line that corresponds to the direction that the respective viewpoint of the faces in (e.g., relative to the three-dimensional environment). In some embodiments, the respective orientation is associated with a respective vector, such as a vector that corresponds to a direction and/or orientation of the first viewpoint of the user in the three-dimensional environment that is optionally independent of a reference location in the media content and/or is optionally the direction and/or orientation of the first viewpoint of the user in the three-dimensional environment, but at zero pitch, and the first location is derived by rotating the respective vector around an axis defined by the cross product of the respective vector and an up direction (e.g., a unit vector that faces a vertically upward direction that at the location of the computer system, such as a direction that is antiparallel to a direction of gravity (e.g., the direction of gravity is optionally vertically downward)) by an angular distance (e.g., ±0.9 degrees, ±1 degrees, ±3 degrees, ±5 degrees, ±7 degrees, ±10 degrees, ±14 degrees, ±20 degrees, ±25 degrees, ±27 degrees, ±30 degrees, ±35 degrees, or another angular distance) and displaying the playback control user interface at a respective distance away from the first viewpoint of the user, such as 0.5 m, 0.6 m, 0.7 m, 0.8 m, 0.9 m, 1 m, 1.1 m, 1.2 m. 1.3 m, 1.4 m, 1.5 m, 1.6 m, 1.7 m, 1.9 m, 2 m, 8 m, 12 m, or another distance away from the first viewpoint of the user, that is optionally in between the media content and the first viewpoint of the user and/or is optionally normal the respective vector, as rotated above. When the media content is immersive, displaying the playback control user interface based on a respective orientation of the viewpoint of the user (and/or optionally a respective gaze direction of the user) when the event is detected overcomes conflicting technical aspects of displaying immersive content and the playback control user interface, different from the immersive media content, simultaneously, by way of displaying the playback control user interface in between the viewpoint of the user and the immersive content at a location that is optionally based on the gaze of the user when the event is detected, permits user interaction with the playback control user interface while the media content is visible from the viewpoint of the user, enables more accurate recognitions of inputs directed to the playback control user interface because the computer system displays the playback content user interface spatially separate from the media content in the three-dimensional environment, and reduces user inputs involved with placing the playback control user interface at an appropriate location.

In some embodiments, displaying the playback control user interface at the first location between the first viewpoint of the user and the media content in the three-dimensional environment (as described above with reference to step(s) 802) is performed in response to detecting, via the one or more input devices, a first portion (e.g., a hand) of a body of the user performing a respective air gesture, such as the air pinch gesture described with reference to hand 712. In some embodiments, detecting the event described with reference to step(s) 802 includes detecting, via the one or more input devices, the first portion of the body of the user performing the respective air gesture.

In some embodiments, displaying the playback control user interface at the second location between the second viewpoint of the user and the media content in the three-dimensional environment (as described above with reference to step(s) 802) is performed in response to detecting, via the one or more input devices, the first portion of the body of the user performing the respective air gesture, such as the air pinch gesture described with reference to hand 712. In some embodiments, the respective air gesture is directed to the media content (e.g., because attention of the user is directed to the media content). In some embodiments, the respective air gesture is not directed to the media content. In some embodiments, the respective air gesture is optionally a “hand shake gesture” in which the hand of the user shakes, twitches, and/or rotates (about the wrist of the user), optionally for a threshold amount of time (e.g., 0.05 s, 0.1 s, 0.5 s, 0.75 s, 0.9 s, 1 s, 1.5 s, 2 s, 3 s, 5 s, or another amount of time). In some embodiments, the respective air gesture is a “knob turning gesture” in which the hand of the user twists and/or rotates (about the wrist of the user), optionally while the fingers of the hand (e.g., index finger, middle finger, ring finger, pinky finger, and/or thumb of the hand) are in a curled state relative to the palm of the hand while the tips of those fingers remain separated from each other (e.g., mimicking gripping and turning a knob of a door). In some embodiments, the respective air gesture is an air pinch gesture and/or another air gesture described throughout this disclosure above. In some embodiments, when the respective air gesture includes an air pinch gesture, the air pinch gesture is performed using a respective set of fingers, such as a middle finger (e.g., or ring finger or pinky finger) and thumb of the hand of the user. In some embodiments, the air pinch gesture corresponds to a double air pinch gesture in which the respective set of fingers form the pinch hand shape twice in succession (e.g., within a threshold amount of time of one another, such as 0.01 s, 0.05 s, 0.1 s, 0.5 s, 0.75 s, 1 s, 1.5 s, or 2 s). In some embodiments, the respective air gesture is a direct touch gesture (e.g., an air tap or touch) that is optionally directed to the media content. In some embodiments, the respective air gesture is detected while attention (e.g., gaze) of the user is directed to the media content in the three-dimensional environment. For example, the computer system optionally detects the respective air gesture while the gaze of the user is directed to an object (e.g., a selectable option or button, an image, a text-entry field, text, and/or a scroll region) in the user interface. Displaying the playback control user interface in response to detecting a performance of a respective air gesture corresponds specific air gestures to requests to display the playback control user interface, which enables more accurate recognitions of inputs for displaying the playback control user interface.

In some embodiments, while displaying the playback control user interface at the first location between the first viewpoint of the user and the media content in the three-dimensional environment or at the second location between the second viewpoint of the user and the media content in the three-dimensional environment, the computer system detects, via the one or more input devices, a first portion of a body of the user performing a respective air gesture, such as the air pinch gesture from hand 712 in FIG. 7C, such as the respective air gesture described above.

In some embodiments, in response to detecting, via the one or more input devices, the first portion of the body of the user performing, the respective air gesture, the computer system ceases display (e.g., reducing a visual prominence, fading out, increasing a respective translucency, increasing a transparency, decreasing a color saturation, and/or decreasing a brightness) of the playback control user interface, such as shown in FIG. 7D. In some embodiments, in accordance with a determination that (e.g., in response to detecting that) the playback control user interface was displayed at the first location between the first viewpoint of the user and the media content in the three-dimensional environment when the first portion of the body of the user performing the respective air gesture was detected (e.g., when the hand of the user is detected performing the respective air gesture), the computer system ceases display (e.g., reduces a visual prominence, fades out, increases a respective translucency, increases a transparency, decreases a color saturation, and/or decreases a brightness) of the playback control user interface at the first location between the first viewpoint of the user and the media content in the three-dimensional environment. In some embodiments, in accordance with a determination that (e.g., in response to detecting that) the playback control user interface was displayed at the second location between the second viewpoint of the user and the media content in the three-dimensional environment when the first portion of the body of the user performing the respective air gesture was detected, the computer system ceases display (e.g., reduces a visual prominence, fades out, increases a respective translucency, increases a transparency, decreases a color saturation, and/or decreases a brightness) of the playback control user interface at the second location between the second viewpoint of the user and the media content in the three-dimensional environment. As such, the computer system optionally ceases display of the playback control user interface in response to detecting performance of a respective air gesture that optionally corresponds to a request to cease display of the playback control user interface. In some embodiments, the respective air gesture that corresponds to the request to cease display of the playback control user interface is the same respective air gesture that corresponds to a request to display the playback control user interface. Ceasing display of the playback control user interface in response to detecting a performance of a respective air gesture corresponds specific air gestures to requests to cease displaying the playback control user interface, which enables more accurate recognitions of inputs for ceasing displaying the playback control user interface.

In some embodiments, while displaying the playback control user interface at the first location between the first viewpoint of the user and the media content in the three-dimensional environment or at the second location between the second viewpoint of the user and the media content in the three-dimensional environment (such as described above with reference to step(s) 802), and in accordance with a determination that (or, optionally, in response to detecting that) an input directed to the playback control user interface (e.g., attention of the user (e.g., gaze) directed to the playback control user interface and/or one or more of the gestures, such as the respective air gesture described above but directed to the playback control user interface to select and/or interact with one or more options of the playback control user interface, such as the options described above with reference to step(s) 802), is not detected for a threshold period of time (0.5 s, 1 s, 2 s, 3 s, 5 s, 10 s, 20 s or 30 s, or another threshold period of time) the computer system ceases display (e.g., reducing a visual prominence, fading out, increasing a respective translucency, increasing a transparency, decreasing a color saturation, and/or decreasing a brightness) of the playback control user interface, such as shown in FIG. 71. In some embodiments, in accordance with a determination that (e.g., in response to detecting that) the playback control user interface is displayed at the first location between the first viewpoint of the user and the media content in the three-dimensional environment (described above with reference to step(s) 802) (and optionally when the determination that the input directed to the playback control user interface is not detected within the threshold period of time is detected), the computer system ceases display (e.g., reduces a visual prominence, fades out, increases a respective translucency, increases a transparency, decreases a color saturation, and/or decreases a brightness) of the playback control user interface at the first location between the first viewpoint of the user and the media content in the three-dimensional environment. In some embodiments, in accordance with a determination that (e.g., in response to detecting that) the playback control user interface is displayed at the second location between the second viewpoint of the user and the media content in the three-dimensional environment (described above with reference to step(s) 802) (and optionally when the determination that the input directed to the playback control user interface is not detected within the threshold period of time is detected), the computer system ceases display (e.g., reduces a visual prominence, fades out, increases a respective translucency, increases a transparency, decreases a color saturation, and/or decreases a brightness) of the playback control user interface at the second location between the second viewpoint of the user and the media content in the three-dimensional environment. As such, the computer system optionally ceases display of the playback control user interface in response to detecting no user interaction with the playback control user interface with the threshold time period described above. Ceasing display of the playback control user interface in response to detecting that no input for interacting with the playback control user interface has been detected within a threshold period of time, smoothly transitions out the playback control user interface without user input, which reduces an amount of user inputs involved with ceasing display of the playback control user interface.

In some embodiments, a vertical component (e.g., a component of the first location that is optionally opposite direction of gravity at the location of the computer system and/or optionally perpendicular to the floor/ground plane in the three-dimensional environment (or at the physical location of the computer system)) of the first location (described above with reference to step(s) 802) of the playback control user interface (e.g., a center of the playback control user interface) between the first viewpoint of the user and the media content in the three-dimensional environment is based on (e.g., is determined as a function of) a first respective location of the media content in the three-dimensional environment, and a vertical component (e.g., a component of the second location that is optionally opposite direction of gravity at the location of the computer system and/or optionally perpendicular to the floor/ground plane in the three-dimensional environment (or at the physical location of the computer system)) of the second location (described above with reference to step(s) 802) of the playback control user interface between the second viewpoint of the user and the media content in the three-dimensional environment is based on (e.g., is determined as a function of) the first respective location of the media content in the three-dimensional environment, such as described with reference to media 734 in FIG. 7J. For example, when (e.g., in accordance with a determination that) the first respective location of the media content in the three-dimensional environment is a first position in the three-dimensional environment (and optionally while the viewpoint of the user is the first viewpoint of the user), the vertical component of the first location of the playback control user interface between the first viewpoint of the user and the media content in the three-dimensional environment is optionally is first amount (e.g., of elevation relative to a floor of the physical environment of the computer system); when (e.g., in accordance with a determination that) the first respective location of the media content in the three-dimensional environment is a second position in the three-dimensional environment (and optionally while the viewpoint of the user is the first viewpoint of the user), different from the first position in the three-dimensional environment, the vertical component of the first location of the playback control user interface between the first viewpoint of the user and the media content in the three-dimensional environment is optionally a second amount (e.g., of elevation relative to a floor of the physical environment of the computer system) that is different from the first amount. In another example, when (e.g., in accordance with a determination that) the first respective location of the media content in the three-dimensional environment is a first position in the three-dimensional environment (and optionally while the viewpoint of the user is the second viewpoint of the user), the vertical component of the first location of the playback control user interface between the second viewpoint of the user and the media content in the three-dimensional environment is optionally a first amount (e.g., of elevation relative to a floor of the physical environment of the computer system); when (e.g., in accordance with a determination that) the first respective location of the media content in the three-dimensional environment is a second position in the three-dimensional environment (and optionally while the viewpoint of the user is the second viewpoint of the user), different from the first position in the three-dimensional environment, the vertical component of the first location of the playback control user interface between the second viewpoint of the user and the media content in the three-dimensional environment is optionally a second amount (e.g., of elevation relative to a floor of the physical environment of the computer system) that is different from the first amount. For instance, the higher the computer system displays the media content (e.g., relative to the viewpoint of the user and/or relative to the three-dimensional environment), the higher computer system displays the playback control user interface (e.g., relative to the viewpoint of the user and/or relative to the three-dimensional environment), and the lower the computer system displays the media content (e.g., relative to the viewpoint of the user and/or relative to the three-dimensional environment), the lower the computer system displays the playback control user interface (e.g., relative to the viewpoint of the user and/or relative to the three-dimensional environment). As such, the computer system optionally displays the playback controls with a vertical component of the location of the playback controls being based on a location of the media content. Displaying the playback control user interface at a location in which a vertical component of the location is based on a location of the media content reduces inputs involved with placing the playback control user interface at an appropriate location and permits user interaction with the playback control user interface while the media content is visible from the viewpoint of the user.

In some embodiments, the media content is expandable, immersive media content that is configured to be displayed in a compact mode, such as media 734 in FIG. 7J (e.g., a mode in which one or more or all visual elements of the media content and/or of a virtual object in the media content is compact and/or concentrated in a region and/or location in the three-dimensional environment, such that in the compact mode the elements optionally consume a 0.01 m3,0.02 m3, 0.04 m3, 0.08 m3, 0.1 m3, 0.2 m3, 0.4 m3, 0.8 m3,1 m3, or another volume in the three-dimensional environment) and is configured to be displayed in an expanded mode, such as media 734 in FIG. 7M (e.g., as 180 degree media, 360 degree media and/or a mode in which one or more or all visual elements of the media content and/or of a virtual object in the media content that was displayed in the compact mode is expanded and/or dispersed throughout the three-dimensional environment, such that in the expanded mode the elements optionally consume a 0.03 m3, 0.09 m3, 0.27 m3, 0.54 m3, 1 m3, 3 m3, 9 m3, 20 m3, or another volume in the three-dimensional environment that is greater in volume in the three-dimensional environment than the volume of the media content in the compact mode), different from the compact mode.

In some embodiments, the media content is displayed at a respective location in the three-dimensional environment when (e.g., in accordance with a determination that) the media content is displayed in the compact mode, such as shown with controls 718 in FIG. 7J, and in accordance with a determination that (e.g., in response to detecting that) the event is detected while the media content is displayed in the expanded mode, such as in FIG. 7M (and/or optionally in accordance with a determination the event is detected while the media content is displayed in the compact mode, and the playback control user interface while the media content is displayed in the compact mode, and the playback control user interface is continuing to be displayed in the expanded mode), and in accordance with a determination that (e.g., in response to detecting that) the respective location of the media content in the three-dimensional environment is a first respective location in the three-dimensional environment (e.g., has a first respective vertical component magnitude at the first respective location in the three-dimensional environment), a vertical component (e.g., a component of the location that is optionally opposite direction of gravity at the location of the computer system and/or optionally perpendicular to the floor/ground plane in the three-dimensional environment (or at the physical location of the computer system) of a location of the playback control user interface (e.g., the first location between the first viewpoint of the user and the media content in the three-dimensional environment or the second location between the second viewpoint of the user and the media content in the three-dimensional environment described with reference to step(s) 802) has a first magnitude (e.g., 0.1, 0.4, 0.6, 0.8, 1, 2, 3, 4 meters, or another magnitude), such as shown with controls 718 in FIG. 7M. For example, when (e.g., in accordance with a determination that) the respective line between the media content and the first viewpoint of the user is a first line from the first viewpoint of the user to the media content (e.g., to a reference location in the media content) when the event is detected, the playback control user interface optionally has a first respective location; when (e.g., in accordance with a determination that) the respective line between the media content and the first viewpoint of the user is a second line from the first viewpoint of the user to the media content (e.g., to the reference location in the media content) when the event is detected, different from the first line from the first viewpoint of the user to the media content, the playback control user interface optionally has a second respective location that is different from the first respective location.

In some embodiments, the media content is displayed at a respective location in the three-dimensional environment when (e.g., in accordance with a determination that) the media content is displayed in the compact mode, such as shown with controls 718 in FIG. 7J, and in accordance with a determination that (e.g., in response to detecting that) the event is detected while the media content is displayed in the expanded mode, such as in FIG. 7M, in accordance with a determination that (e.g., in response to detecting that) the respective location of the media content in the three-dimensional environment is a second respective location in the three-dimensional environment (e.g., has a second respective vertical component magnitude at the first respective location in the three-dimensional environment), different from the first respective location in the three-dimensional environment (e.g., different from the first respective vertical component magnitude described above), a vertical component (e.g., a component of the location that is optionally opposite direction of gravity at the location of the computer system and/or optionally perpendicular to the floor/ground plane in the three-dimensional environment (or at the physical location of the computer system)) of the location of the playback control user interface (e.g., the first location between the first viewpoint of the user and the media content in the three-dimensional environment or the second location between the second viewpoint of the user and the media content in the three-dimensional environment described with reference to step(s) 802) has a second magnitude (e.g., 0.1, 0.4, 0.6, 0.8, 1, 2, 3, 4 meters, or another magnitude), different from the first magnitude, such as shown with controls 718 in FIG. 7N. As such, when the computer system displays expandable, immersive media content, a vertical component the media content in the expanded mode of the media content is based on a location of the media content (e.g., a vertical component of the location of the media content) that the media content had in the three-dimensional environment before the media content was displayed in the expanded mode. When the media content is immersive, able to be displayed in a compact mode and in an expanded mode, and is displayed in the expanded mode, displaying the playback control user interface at a location in which a vertical component of the location is based on a location of the media content when the media content was displayed in the compact mode smoothly transitions the positioning of the playback control user interface between the compact and expanded modes of the media content, reduces inputs involved with placing the playback control user interface at an appropriate location, and may permit user interaction with the playback control user interface while the media content is visible from the viewpoint of the user.

In some embodiments, in accordance with a determination that (e.g., in response to detecting that) the event is detected while the media content is displayed in the compact mode, such as the input 710d in FIG. 7J, such as the compact mode described above, while the viewpoint of the user is a respective viewpoint of the user (e.g., the first viewpoint of the user or the second viewpoint of the user described above with reference to step(s) 802), a location of the playback control user interface is based on (e.g., is determined as a function of) a respective line (e.g., a hypothetical line) between the media content and the respective viewpoint of the user, such as the position of controls 718 in FIG. 7M (e.g., the first viewpoint of the user or the second viewpoint of the user described above with reference to step(s) 802). For example, when (e.g., in accordance with a determination that) the respective line between the media content and the respective viewpoint of the user is a first line from the respective viewpoint of the user to the media content (e.g., to a reference location in the media content) when the event is detected, the playback control user interface optionally has a first respective location; when (e.g., in accordance with a determination that) the respective line between the media content and the respective viewpoint of the user is a second line from the respective viewpoint of the user to the media content (e.g., to the reference location in the media content) when the event is detected, different from the first line from the respective viewpoint of the user to the media content, the playback control user interface optionally has a second respective location that is different from the first respective location. In some embodiments, the reference location in the media content is a center location in the media content, and the respective line between the media content and the respective viewpoint of the user is a line from the respective viewpoint of the user to the center location in the media content, such as a center of a virtual screen (e.g., application window) in which the media content is displayed. In some embodiments, the respective line is associated with a respective vector from the respective viewpoint of the user to the media content, such as a vector from the respective viewpoint of the user to the center of the media content, and the location of the playback control user interface is derived by rotating the respective vector around an axis defined by the cross product of the respective vector and an up direction (e.g., a unit vector that faces a vertically upward direction that at the location of the computer system, such as a direction that is antiparallel to a direction of gravity (e.g., the direction of gravity is optionally vertically downward)) by an angular distance (e.g., ±0.9 degrees, ±1 degrees, ±3 degrees, ±5 degrees, ±7 degrees, ±10 degrees, ±14 degrees, ±21 degrees, ±25 degrees, ±27 degrees, ±30 degrees, ±35 degrees, or another angular distance) and displaying the playback control user interface at a respective distance away from the first viewpoint of the user, such as 0.8 m, 0.9 m, 1 m, 1.1 m, 1.2 m. 1.3 m, 1.4 m, 1.5 m, 1.6 m, 1.7 m, 1.9 m, 2 m, 8m, 12 m, or another distance away from the respective viewpoint of the user, that is optionally in between the media content and the respective viewpoint of the user and/or is optionally normal the respective vector, as rotated above.

In some embodiments, the method comprises in accordance with a determination that (e.g., in response to detecting that) one or more criteria are satisfied (optionally including a criterion that is satisfied when (e.g., in accordance with a determination that) a threshold period of time (e.g., 0.5 s, 1 s, 5 s, 10 s, or another time threshold) has passed since displaying the media content in the compact mode with the playback control user interface and/or a criterion that is satisfied when the event is detected while the media content is displayed in the expanded mode) while the media content is displayed in the compact mode, (e.g., compact mode described above) while the viewpoint of the user is the respective viewpoint of the user, and while displaying the playback control user interface that has the location that is based the respective line (e.g., a hypothetical line) between the media content and the respective viewpoint of the user, the computer system initiates a process to display, via the display generation component, the media content in the expanded mode (e.g., expanded mode described above), such as shown in FIG. 7M, wherein when the media content is displayed in the expanded mode, a location (and/or optionally an orientation) of the playback control user interface is based on (e.g., is a function of) the vertical component (e.g., a component of the location that is optionally opposite direction of gravity at the location of the computer system and/or optionally perpendicular to the floor/ground plane in the three-dimensional environment (or at the physical location of the computer system) of the location of the playback control user interface (e.g., the first location between the first viewpoint of the user and the media content in the three-dimensional environment or the second location between the second viewpoint of the user and the media content in the three-dimensional environment described with reference to step(s) 802) from when the media content was displayed in the compact mode (such as described above), such as described with reference to controls 718 in FIG. 7M. For example, when (e.g., in accordance with a determination that) the vertical component of the location of the playback control user interface from when the media content was displayed in the compact mode is a first magnitude, the vertical component of the playback control user interface when the media content is displayed in the expanded mode is optionally the first magnitude; when (e.g., in accordance with a determination that) the vertical component of the location of the playback control user interface from when the media content was displayed in the compact mode is a second magnitude, the vertical component of the playback control user interface when the media content is displayed in the expanded mode is optionally the second magnitude.

In some embodiments, the location of the playback control user interface is also based on a respective orientation of the respective viewpoint of the user (such as described above), such as described with reference to FIG. 7O. As such, when the media content is expandable, immersive media content, and is displayed in the expanded mode, the computer system optionally displays the playback controls at a location in the three-dimensional environment that is based on the vertical component of the location of the playback controls from when the media content was displayed in the compact mode and on a respective orientation of the respective viewpoint of the user. For instance, in the expanded mode, the computer system optionally displays the playback control user interface having a vertical component equal to the vertical component of the playback control user interface when the media content was displayed in the compact mode (e.g., the greater the magnitude of the vertical component of the location that the playback control user interface had when the media content was displayed in the compact mode, the greater the magnitude of the vertical component of the location that the playback control user interface is displayed in the expanded mode), and in the expanded mode, the computer system optionally displays the playback control user interface having a yaw component (e.g., an amount of rotation around the a vertical axis (e.g., a vertical axis extending through a center of the playback control user interface) that is parallel to the direction of gravity at the location of the computer system) that is based on the respective orientation of the respective viewpoint of the user, optionally such that the yaw component increases as the respective orientation of the respective viewpoint of the user tends away from the location of the playback control user interface in the three-dimensional environment (e.g., moves away from the location of the playback control user interface in the three-dimensional environment being displayed in a center of a field of view of the viewpoint of the user) and such that the yaw component decreases as the respective orientation of the respective viewpoint of the user tends toward the location of the playback control user interface (e.g., moves towards the location of the playback control user interface being displayed in a center of a field of view of the viewpoint of the user). In some embodiments, the location in the three-dimensional environment that is based on the vertical component of the location of the playback controls from when the media content was displayed in the compact mode and on a respective orientation of the respective viewpoint of the user with which the playback controls are displayed while the computer system displays the immersive, expandable media content in the expanded mode is derived by rotating a vector with a vertical component magnitude being the same as the vertical component magnitude of the location of the playback controls from when the media content was displayed in the compact mode, and having a yaw component that is parallel to (e.g., equal to) a yaw of the respective orientation of the respective viewpoint of the user relative to the three-dimensional environment, by an angular distance (e.g., ±3 degrees, ±5 degrees, ±7 degrees, ±10 degrees, ±15 degrees, +21 degrees, ±25 degrees, ±27 degrees, ±30 degrees, ±35 degrees, or another angular distance) about axis of the vertical component (e.g., opposite the direction of gravity) and displaying the playback control user interface at a respective distance away from the respective viewpoint of the user, such as 0.8 m, 0.9 m, 1 m, 1.1 m, 1.2 m. 1.3 m, 1.4 m, 1.5 m, 1.6 m, 1.7 m, 1.9 m, 2 m, 8m, 12 m, or another distance away from the respective viewpoint of the user, that is optionally in between the media content and the respective viewpoint of the user and/or is optionally normal the respective vector, as rotated above. When the media content is expandable, immersive media content, and is displayed in the expanded mode, displaying the playback control user interface at a location in which a vertical component of the location is based on 1) a vertical component of the location of the media content when the media content was displayed in the compact mode and 2) an orientation of the viewpoint of the user smoothly transitions the positioning of the playback control user interface between the compact and expanded modes of the media content, permits rotation of the playback control user interface based on the orientation of the viewpoint of the user, reduces inputs involved with placing the playback control user interface at an appropriate location, and may permit user interaction with the playback control user interface while the media content is visible from the viewpoint of the user.

In some embodiments, while displaying the media content in the compact mode at the respective location in the three-dimensional environment, such as media 734 in FIG. 7J, the playback control user interface is displayed at a third respective location, different from the respective location, in the three-dimensional environment, wherein a yaw (e.g., an amount of rotation around the vertical axis (e.g., the vertical axis extending through a center of the playback control user interface) that is parallel to the direction of gravity at the location of the computer system, such as described above) of the playback control user interface at the third respective location in the three-dimensional environment is based on (e.g., is a function of) the respective location of the media content in the three-dimensional environment, such as the location of controls 718 in FIG. 7J. For example, when (e.g., in accordance with a determination that) the respective location of the media content in the three-dimensional environment is a first respective location, a yaw of the playback control user interface a first angular distance; when (e.g., in accordance with a determination that) the respective location of the media content in the three-dimensional environment is a second respective location, different from the first respective location, a yaw of the playback control user interface a second angular distance, that is optionally different from the first angular distance.

In some embodiments, while displaying the media content in the expanded mode, the yaw of the playback control user interface in the three-dimensional environment is based on (e.g., is a function of) a respective orientation of the viewpoint of the user while displaying the media content in the expanded mode when the event is detected (such as described above), such as described with reference to FIG. 7O. For example, when (e.g., in accordance with a determination that) the respective orientation of the viewpoint of the user is a first orientation of the viewpoint of the user, the yaw of the playback control user interface is a first angular distance; when (e.g., in accordance with a determination that) the respective orientation of the viewpoint of the user is a second orientation of the viewpoint of the user, different from the first orientation of the viewpoint of the user, the yaw of the playback control user interface is a second angular distance that is optionally different from the first angular distance. When the media content is immersive, able to be displayed in a compact mode and in an expanded mode, and is displayed in the expanded mode, displaying the playback control user interface at a location in which a vertical component of the location is based on 1) a vertical component of the location of the media content when the media content was displayed in the compact mode and 2) an orientation of the viewpoint of the user smoothly transitions the positioning of the playback control user interface between the compact and expanded modes of the media content, permits rotation of the playback control user interface based on the orientation of the viewpoint of the user, reduces inputs involved with placing the playback control user interface at an appropriate location, and may permit user interaction with the playback control user interface while the media content is visible from the viewpoint of the user.

In some embodiments, in accordance with a determination that (e.g., in response to detecting that) one or more criteria is satisfied, wherein the one or more criteria include a requirement that the media content is expandable, immersive content that is configured to be displayed in a compact mode and in an expanded mode (e.g., the compact mode and the expanded mode described above), different from the compact mode, in order for the one or more criteria to be met, such as media 734 in FIGS. 7J-70, a vertical component (e.g., a component of the second location that is optionally opposite direction of gravity at the location of the computer system, which is optionally perpendicular to the floor/ground plane in the three-dimensional environment (or at the physical location of the computer system)) of a location of the playback control user interface (such as described above) in the three-dimensional environment is based on (e.g., is a function of) an angle of elevation from a portion of a body (e.g., a head) of the user to a reference location of the media content (that is optionally a center location of the media content or another location) in the three-dimensional environment, such as the angle of elevation between location 736 and the head of the user in FIG. 7N. For example, when (e.g., in accordance with a determination that) the angle of elevation is a first angle (e.g., 1 degree, 5 degrees, 7 degrees, 10 degrees, 14 degrees, 20 degrees, 25 degrees, 30 degrees, 35 degrees, 45 degrees, or another angle) that is optionally measured from a horizon plane that is parallel to the floor/ground in the three-dimensional environment (or at the physical location of the computer system), the vertical component of the location of the playback control user interface is a first magnitude; when (e.g., in accordance with a determination that) the angle of elevation is a second angle, larger than the first angle, the vertical component of the location of the playback control user interface is a second magnitude that is larger than the first magnitude. The location of the playback control user interface for the expandable, immersive content is described above.

In some embodiments, in accordance with a determination that (e.g., in response to detecting that) the media content is planar, such as media 708 in FIG. 7B (e.g., is optionally displayed and/or bounded within a planar or curved plane from the perspective of the first user and/or in which elements of the media content optionally do not include user perceivable depth dimensions), the vertical component (e.g., a component of the second location that is optionally opposite direction of gravity at the location of the computer system, which is optionally perpendicular to the floor/ground plane in the three-dimensional environment (or at the physical location of the computer system)) of the location of the playback control user interface in the three-dimensional environment is independent of (e.g., is the same regardless of) the angle of elevation from the portion of the body of the user to the reference location of the media content in the three-dimensional environment (e.g., independent of the angle of elevation described above), such as described with reference to controls 718 in FIG. 7B. The location of the playback control user interface for the planar content is described above with reference to non-immersive media content.

In some embodiments, in accordance with a determination that (e.g., in response to detecting that) the media content is immersive, such as content 730 in FIG. 7E, the vertical component (e.g., a component of the second location that is optionally opposite direction of gravity at the location of the computer system, which is optionally perpendicular to the floor/ground plane in the three-dimensional environment (or at the physical location of the computer system)) of the location of the playback control user interface in the three-dimensional environment is independent of (e.g., is the same regardless of) the angle of elevation from the portion of the body of the user to the reference location of the media content in the three-dimensional environment, such as the location of controls 718 in FIG. 7H. The location of the playback control user interface for the immersive content is described above. As such, when (e.g., in accordance with a determination that) the media content is non-immersive or immersive (e.g., immersive and not expandable, immersive), the computer system optionally displays the playback controls having a vertical component that is independent of the angle of elevation described above, and when (e.g., in accordance with a determination that) the media content is immersive, expandable, the computer system optionally displays the playback controls having a vertical component that is based on the angle of elevation described above When the media content is non-immersive or immersive, displaying the playback control user interface at a location in which a vertical component of the location is independent of an angle of elevation from a portion of user to a reference location of the media content permits consistency of placement of the playback control user interface, which may reduce errors in interaction with the media content, playback control user interface, and/or computer system; when the media content is expandable immersive, displaying the playback control user interface at a location in which a vertical component of the location is based on an angle of elevation from the portion of user to the reference location of the media content reduces inputs involved with placing the playback control user interface at an appropriate location that permits display of the media content while the playback control user interface is displayed.

In some embodiments, the viewpoint of the user is a respective viewpoint of the user (e.g., the first viewpoint of the user or the second viewpoint of the user described above with reference to step(s) 802) when the event is detected. In some embodiments, displaying the playback control user interface includes in accordance with a determination that (e.g., in response to detecting that) the media content is immersive (e.g., three-dimensional content that optionally at least partially surrounds the user of the computer system in a view of the three-dimensional environment, 180 degree media, 360 degree media, and/or three-dimensional content for which the computer system simulates depth effect(s) optionally relative to a viewpoint(s) of the user, such that the user of computer system visually experiences the three-dimensional content as three-dimensional content, such as described above), displaying the playback control user interface at a first distance (such as described above with reference to distances at which the computer system displays the playback control user interface when (e.g., in accordance with a determination that) the media content is immersive) from the respective viewpoint of the user, such as the distance of controls 718 in FIG. 7H.

In some embodiments, displaying the playback control user interface includes in accordance with a determination that (e.g., in response to detecting that) the media content is planar media content (e.g., is optionally displayed and/or bounded within a planar or curved plane from the perspective of the first user and/or in which elements of the media content optionally do not include generally include depth dimensions (e.g., user-perceivable depth dimensions), such as described above) or immersive media content that is configured to be displayed in a compact mode (e.g., the compact mode described above) and in an expanded mode (e.g., the expanded mode described above), different from the compact mode, displaying the playback control user interface at a second distance (such as described above with reference to distances at which the computer system displays the playback control user interface when (e.g., in accordance with a determination that) the media content is immersive) from the respective viewpoint of the user that is greater than the first distance from the respective viewpoint of the user, such as the distance of controls 718 in FIGS. 7B and 7J. As such, when (e.g., in accordance with a determination that) the media content is immersive, the computer system displays the playback control user interface at a distance from the viewpoint of the user that is closer than a distance at which the computer system displays the playback control user interface when (e.g., in accordance with a determination that) the media content is planar or immersive and configured to be displayed in a compact mode and an expanded mode. When the media content is immersive, displaying the playback control user interface closer to the viewpoint of the user than display of the playback control user interface when the media content is non-immersive content or immersive, expandable content permit disambiguation between inputs directed to the media content and inputs directed to the playback control user interface and reduce errors in interaction with the immersive media content, playback control user interface, and/or computer system because the playback control user interface is optionally closer to the viewpoint of the user than the immersive content.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIGS. 9A-9Q illustrate examples of a computer system that displays captions for media content differently based on a type of media content, in accordance with some embodiments.

FIGS. 9A-9O illustrate examples of a computer system that displays captions for immersive media content that can move relative to a reference in the immersive media content, in accordance with some embodiments.

FIG. 9A illustrates a computer system (e.g., an electronic device) 101 displaying, via a display generation component (e.g., display generation component 120 of FIG. 1), a three-dimensional environment 904 from a viewpoint of the user of the computer system 101 (e.g., facing the back wall of the physical environment in which computer system 101 is located). In some embodiments, computer system 101 includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. Computer system 101 also includes physical buttons 906. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

In some embodiments, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 904. In some embodiments, portions of physical environment in which computer system 101 is located is visible via the display generation component 120, such as via optical passthrough.

In FIG. 9A, computer system 101 (e.g., a desktop computer, laptop computer, a smartphone, tablet, smartwatch, wearable computer, or HMD) displays immersive media 908 (e.g., immersive media described with reference to method 1000) in three-dimensional environment 904 (e.g., an AR, VR, XR, MR, or AV environment). Immersive media 908 is optionally a movie or video. In FIG. 9A, the scene of immersive media 908 displayed via display generation component 120 includes a room including actor 908a sitting at a table 908b and actor 908c standing. Immersive media 908 also includes elements 908d and 908e shown in overhead view 914 in FIG. 9A. These elements are not displayed in display generation component 120 in FIG. 9A, but would be displayed if user 901 were to rotate the user's head to the right. In some embodiments, user 901 is fully immersed (e.g., three-dimensional environment 904 includes immersive media 908, without including visibility of one or more portions of the physical environment in which computer system 101 is located). In some embodiments, user 901 is partially immersed (e.g., three-dimensional environment 904 includes immersive media 908 and one or more portions of the physical environment in which computer system 101 is located). In FIG. 9A, computer system 101 displays captions 910 without displaying media controls for immersive media 908. In FIG. 9A, computer system displays captions 910 in front of actor 908c in immersive media 908. In FIG. 9A, a portion of actor 908c is not seen because computer system 101 displays captions in front of actor 908c with a level of visual prominence that excludes from visibility the portion of actor 908c that is behind captions 910 in FIG. 9A.

While displaying captions 910 and while the viewpoint of the user is the viewpoint of user 901 in FIG. 9A, computer system 101 optionally detects input (e.g., attention of the user, such as gaze of the user) directed to a respective portion 903 of the three-dimensional environment 904, such as shown in FIG. 9B. In some embodiments, respective portion 903 of three-dimensional environment 904 is not a part of immersive media 908. In some embodiments, respective portion 903 includes respective information about immersive media 908 (e.g., title, playback length, director, and rating). In response to detecting input (e.g., attention of the user, such as gaze of the user) directed to respective portion 903 of three-dimensional environment 904 (optionally for a predetermined amount of time (e.g., 0.3 s, 0.7 s, 1 s, 2 s, 5 s, 8 s, 10 s or another amount of time), computer system 101, fades-out captions 910, such as shown from FIG. 9C to 9D.

In FIG. 9C, computer system 101 has reduced the visual prominence of captions 910 in response to detecting input 905a. In FIG. 9C, computer system 101 has also increased in visual prominence information about immersive media 908 at respective portion 903 in three-dimensional environment 904, which in FIG. 9C indicates rating information that optionally provides a rating of immersive media 908 (e.g., a movie rating, such as G, PG, PG-13, R, or another rating). Also, in FIG. 9C, the portion of actor 908c that was hidden from display in display generation component 120 in FIG. 9A due to visual prominence of captions 910 in FIG. 9A is now visible display generation component 120 in FIG. 9C due to the reduction of visual prominence of captions 910. In FIG. 9C, computer system 101 continues to detect input 905 directed to respective portion 903 of three-dimensional environment 904, and in response, computer system 101 ceases displaying captions, as shown in FIG. 9D.

FIGS. 9E-9G illustrate an example of computer system 101 moving captions relative to a reference in immersive media 908.

As shown in overhead view 914 in FIG. 9E, user 901 performs an action, such as a head rotation toward element 908d. Performing this event optionally causes viewpoint of the user 901 in FIG. 9E to move (as indicated by arrow 918b in FIG. 9E) from orientation 918a to orientation 918c. In response to detecting the event, computer system 101 displays immersive media 908 based on viewpoint of the user 901 (e.g., from an updated perspective corresponding to the updated viewpoint of user 901), which has orientation 918c as shown in FIG. 9F. In FIG. 9F, computer system 101 displays actors 908c/d and lamp 908e of immersive media 908. Also, in FIG. 9F, captions 910 are moving in three-dimensional environment relative to immersive media 908, as illustrated by arrow 917 in FIG. 9F, and eventually stop moving at the location in three-dimensional environment 904 relative to immersive media 908 indicated in FIG. 9G. When captions 910 start moving to the location of captions 910 in FIG. 9G, computer system 101 optionally fades captions 910. In some embodiments, computer system 101 fades captions 910 by an amount that is based on a speed of movement of the shift of the viewpoint and/or an amount of movement associated with the shift in viewpoint of the user, such as described further with reference to method 1000. Also, after fading captions 910 as they are moving towards the location of captions 910 in FIG. 9G, computer system 101 optionally fades in captions 910 as they move toward and/or end up at the location of captions 910 in FIG. 9G. As such, in response to detecting movement of a viewpoint of the user, computer system 101 optionally moves captions relative to immersive media in three-dimensional environment, optionally fading out the captions partially or fully and the fading in the captions at the resulting viewpoint of the user. Computer system 101 optionally moves the captions from their location in FIG. 9E relative to immersive media 908 to their location in FIG. 9G relative to immersive media 908 optionally to maintain the same relative arrangement of the captions relative to the viewpoint. For example, in FIG. 9E, captions 910 has a first spatial relationship relative to immersive media 908 that optionally is an ideal relationship relative to viewpoint of the user 901 in FIG. 9E (e.g., the placement of captions 910 optionally enhances a view of the immersive media 908 including captions 910) and after the rotation of the viewpoint of the user 901 (e.g., as indicated by rotation arrow 918b in FIG. 9E), computer system 101 moves captions 910 to have a second spatial relationship relative to immersive media 908, that, at the viewpoint of the user 901 in FIG. 9G, is an ideal positioning of the captions 910 relative to the rotated viewpoint of the user 901 and is optionally similar to the placement of the captions relative to the viewpoint of the user 901 in FIG. 9E (e.g., the captions 910 are placed relative to viewpoint of the user 901 in FIG. 9E and are placed relative to viewpoint of the user 901 in FIG. 9G, and though these placements are different locations in three-dimensional environment 904, relative to the respective viewpoint of the user 901, they are the same).

In FIG. 9H, while displaying captions 910 and immersive media 908, computer system 101 detects input 905a from hand 926 (e.g., air pinch gesture) directed to immersive media 908 (e.g., optionally while attention of the user is directed to immersive media 908). In response, computer system 101 displays playback control user interface 918, as shown in FIG. 9I.

FIG. 9H1 illustrates similar and/or the same concepts as those shown in FIG. 9H (with many of the same reference numbers). It is understood that unless indicated below, elements shown in FIG. 9H1 that have the same reference numbers as elements shown in FIGS. 9A-9Q have one or more or all of the same characteristics. FIG. 9H1 includes computer system 101, which includes (or is the same as) display generation component 120. In some embodiments, computer system 101 and display generation component 120 have one or more of the characteristics of computer system 101 shown in FIGS. 9A-9Q and display generation component 120 shown in FIGS. 1 and 3, respectively, and in some embodiments, computer system 101 and display generation component 120 shown in FIGS. 9A-9Q have one or more of the characteristics of computer system 101 and display generation component 120 shown in FIG. 9H1.

In FIG. 9H1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 9A-9Q.

In FIG. 9H1, display generation component 120 is illustrated as displaying content that optionally corresponds to the content that is described as being displayed and/or visible via display generation component 120 with reference to FIGS. 9A-9Q. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 9H1.

Display generation component 120 has a field of view (e.g., a field of view captured by external image sensors 314b and 314c and/or visible to the user via display generation component 120) that corresponds to the content shown in FIG. 9H1. Because display generation component 120 is optionally a head-mounted device, the field of view of display generation component 120 is optionally the same as or similar to the field of view of the user.

In FIG. 9H1, the user is depicted as performing an air pinch gesture (e.g., with hand 926) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 9A-9Q.

In some embodiments, computer system 101 responds to user inputs as described with reference to FIGS. 9A-9Q.

In the example of FIG. 9H1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 9A-9Q and/or described with reference to the corresponding method(s) are optionally implemented on computer system 101 and display generation unit 120 in a manner similar or analogous to that shown in FIG. 9H1.

In FIG. 9I, computer system 101 displays immersive media 908, captions 910, and playback control user interface 918 including user interface elements 918a-f, which optionally are similar to one or more of user interface elements 718a-f described with reference to FIGS. 7A-7). Playback control user interface 918 is optionally as described with reference to method 800. In FIG. 9I, computer system 101 displays playback control user interface 918 closer to viewpoint of the user 901 than captions 910. In FIG. 9I, while displaying captions 910, immersive media 908, and playback control user interface 918, computer system 101 detects input 905c, which is optionally an attention-only input (e.g., gaze of the user) and/or input from hand 926 (e.g., air pinch gesture) directed to playback control user interface 918. In response, computer system 101 moves captions 910 towards the location of playback control user interface 918, as shown from FIG. 9I to FIG. 9J. For example, in overhead view 914, captions 910 are closer to playback control user interface compared to captions 910 and playback control user interface 918 in FIG. 9I. In some embodiments, captions 910 are locked to playback control user interface 918 (e.g., captions 910 maintain a distance of 0.2 cm, 0.7 cm, 1 cm, 5 cm, 10 cm, 20 cm, or another distance from the playback control user interface 918, maintain a relative orientation relative to playback control user interface 918 (e.g., maintains a specific amount of tilt (e.g., 1, 3, 5, 10, 15, 20 degrees, or another amount) relative to playback control user interface 918), or playback control user interface 918 and captions 910 maintains a relative distance and/or orientation between each other) while user 901 is interacting with playback control user interface 918 and/or while playback control user interface 918 is displayed, such as shown from FIG. 9J to FIG. 9K.

In particular, in FIG. 9K, as shown in overhead view 914, viewpoint of the user 901 has rotated in a counter-clockwise manner from viewpoint of the user 901 in FIG. 9J. Although the viewpoint of the user 901 as shifted, computer system 101 maintains the location of captions 910 in three-dimensional environment 904, optionally because captions 910 are locked to playback control user interface 918 while playback control user interface 918 is displayed with captions 910.

In some embodiments, viewpoint of the user 901 shifts such that in the resulting viewpoint of the user, the location of the captions 910 and/or playback control user interface 918 from FIG. 9K is not visible in the view of the three-dimensional environment 904 from the shifted viewpoint of the user. In some embodiments, computer system 101 displays captions 910 and/or playback control user interface 918 at a new location in three-dimensional environment 904 that is included in the shifted viewpoint of the user 901, such as shown in the shift of the viewpoint of the user 901 from FIG. 9K to FIG. 9K-1. In some embodiments, when viewpoint of the user 901 shifts such that in the resulting viewpoint of the user, the location of the captions 910 and/or playback control user interface 918 from FIG. 9K is not visible in the view of the three-dimensional environment 904 from the shifted viewpoint of the user, computer system 101 forgoes display of captions 910 and/or playback control user interface 918 at the new location in three-dimensional environment 904 that is included in the shifted viewpoint of the user 901 in FIG. 9K-1 and maintains the location of captions 910 and/or playback control user interface 918 relative to immersive media 908 in three-dimensional environment 904. In some embodiments, when viewpoint of the user 901 shifts such that in the resulting viewpoint of the user, the location of the captions 910 and/or playback control user interface 918 from FIG. 9K is not visible in the view of the three-dimensional environment 904 from the shifted viewpoint of the user, computer system 101 displays (e.g., fades in) captions 910 and/or playback control user interface 918 at the new location in three-dimensional environment 904 that is included in the shifted viewpoint of the user 901 in FIG. 9K-1.

In FIG. 9L, computer system detects input 905f (e.g., from hand of user 901 (e.g., air pinch gesture) and/or attention of user 901 directed outside of playback control user interface 918. In response, computer system 101 ceases displaying (e.g., fades out) playback control user interface 918, as shown in FIG. 9M, and also reduces in visual prominence (e.g., fades out) captions 910 that were locked to playback control user interface 918, as shown in FIG. 9M, then moves and/or displays captions 910 relative to immersive media 908 to or at a central location in the viewpoint of the user, respectively as shown in FIG. 90. Thus, when computer system 101 ceases displaying playback control user interface 918, computer system 101 moves the captions relative to immersive media 908 to where the captions 910 would have been displayed relative to viewpoint of the user had the playback control user interface 918 not been displayed, and the spatial relationship of captions 910 relative to viewpoint of the user 901 in FIG. 90 is optionally similar to (e.g., same as) the spatial relationship of captions 910 relative to viewpoints of the user 901 in FIGS. 9E and 9G.

FIG. 9P illustrates an example of a computer system displaying captions for media content that is non-immersive (e.g., non-immersive as described with reference to method 1000). In FIG. 9P, captions 910 are displayed below media 908. Also, in FIG. 9P, captions 910 are displayed near media 908 as seen in overhead view 914 of FIG. 9P (e.g., a center of captions 910 is 0.03 m 0.05m, 0.1 m, 0.2 m, 0.5 m, 2 m, or another distance horizontally spatially separate from media 908). Also, when media 908 is non-immersive, captions 910 optionally do not move when the viewpoint of the user shifts, such as shown in the maintaining of the position of the captions 910 relative to media 908 from FIG. 9P to 9Q while the viewpoint of the user has shifted from the viewpoint of the user in FIG. 9P to viewpoint of the user FIG. 9Q.

FIGS. 9A-9Q are further described with reference to method 1000.

FIG. 10 is a flow diagram illustrating an exemplary method of displaying captions for immersive media content moveable to a reference in the immersive media content in accordance with some embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at a computer system in communication with a display generation component and one or more input devices. The computer system optionally includes one or more features of the computer system of method 800. The display generation component optionally includes one or more features of the display generation component of method 800. The one or more input devices optionally include one or more features of the one or more input devices of method 800.

In some embodiments, while a three-dimensional environment is visible via the display generation component, such as shown in FIG. 9A, the computer system concurrently displays, via the display generation component media content, wherein the media content is displayed from a first viewpoint of a user relative to the three-dimensional environment, such as the content shown in FIG. 9A, and a user interface element that includes one or more captions (e.g., subtitles) for the media content, wherein the user interface element has a first spatial relationship (e.g., orientation, position and/or placement) relative to a spatial reference (e.g., reference point, reference axis, reference plane and/or reference volume) in the media content in the three-dimensional environment, such as element 910 in FIG. 9A. The three-dimensional environment optionally includes one or more features of the three-dimensional environment described with reference to method 800. In some embodiments, the three-dimensional environment includes objects of virtual passthrough and/or objects of optical passthrough, such as discussed above in this present disclosure. In some embodiments, the three-dimensional environment does not include virtual passthrough and does not include optical passthrough. The media content optionally includes one or more features of the media content described with reference to method 800. For example, the media content is optionally a two-dimensional video, an immersive video, a three-dimensional video, an image of one or more dimensions, and/or other content. In some embodiments, the media content is embedded and/or displayed in a user interface of an application, such as in an Internet application that includes a media playback application. The media content is optionally associated with audio that is playable via an audio generation component in communication with the computer system. The captions for the media content are optionally captions, closed captions, and/or subtitles for and/or corresponding to the media content. The first spatial relationship is optionally a position, placement, and/or orientation relative to reference position, volume, placement, and/or orientation in the media content, such as relative to a center position in the media content or an edge position in the media content. In some embodiments, the user interface element has a first angular relationship relative to a center of a viewpoint of the user. In some embodiments, the computer system fades the user interface element in and out based on changes in the virtual point source of audio generation (optionally while the viewpoint of the user is the first viewpoint of the user or the second viewpoint of the user). For example, when (e.g., in accordance with a determination that) the point source of audio is a first element in a first location, the computer system optionally displays the captions based on the first location, and when (e.g., in accordance with a determination that) the point source of audio is a second element in a second location different from the first location, the computer system optionally displays the captions based on the second location. In some embodiments, the user interface element is overlaid on the media content from the first viewpoint of the user.

In some embodiments, while concurrently displaying the media content from the first viewpoint of the user relative to the three-dimensional environment and the user interface element that includes the one or more captions for the media content having the first spatial relationship relative to the spatial reference in the media content in the three-dimensional environment, the computer system detects, via the one or more input devices, an event corresponding to a change of a viewpoint of the user relative to the three-dimensional environment, such as shown from FIGS. 9B to 9F. For example, the computer system optionally detects head rotation left, right, up, and/or down, touch inputs, and/or voice inputs and corresponds one or more of these inputs to the event.

In some embodiments, in response to detecting the event corresponding to the change of the viewpoint of the user relative to the three-dimensional environment from the first viewpoint of the user to a second viewpoint of the user relative to the three-dimensional environment, wherein the second viewpoint of the user is different from the first viewpoint of the user, the computer system displays the user interface element including the one or more captions for the media content having a second spatial relationship relative to the spatial reference in the media content, different from the first spatial relationship relative to the spatial reference in the media content, based on the change of the viewpoint of the user, such as the location of element 910 in FIG. 9G. In some embodiments, in response to detecting the event corresponding to the change of the viewpoint of the user of the computer system from the first viewpoint of the user relative to the three-dimensional environment to the second viewpoint of the user relative to the three-dimensional environment, the computer system displays displaying, via the display generation component, the media content, wherein the media content is displayed from the second viewpoint of the user relative to the three-dimensional environment. In some embodiments, such as in embodiments in which the three-dimensional environment is a virtual environment, in response to detecting the event, the computer system generates the change of viewpoint (e.g., displays the virtual environment from the second viewpoint) and displays the user interface element with the second spatial relationship. In some embodiments, in response to detecting the event corresponding to the change of the viewpoint of the user of the computer system from the first viewpoint of the user relative to the three-dimensional environment to the second viewpoint of the user relative to the three-dimensional environment, the computer system displays (and/or makes visible), via the display generation component, the three-dimensional environment from the second viewpoint of the user; and For example, the second viewpoint of the user is optionally of a different orientation and/or location relative to the three-dimensional environment than the first viewpoint of the user (e.g., is rotated by a certain amount (e.g., 1, 4, 7, 10, 20, 23, 60, or 90 degrees, or another amount) relative to the orientation of the first viewpoint and/or is offset by a certain amount (e.g., 1, 3, 5, 10, 100, 1,000 or 10,000 cm) relative to the first viewpoint of the user). The second spatial relationship is optionally a position, placement, and/or orientation relative to the reference position, volume, placement, and/or orientation in the media content, such as relative to the center position in the media content or the edge position in the media content, that is different from the first spatial relationship relative to the reference. In some embodiments, the computer system causes the user interface element to have the first angular relationship relative to a center of the second viewpoint of the user similar to how the computer system optionally displayed the user interface element having the first angular relationship relative to the center of the first viewpoint of the user. In some embodiments, in accordance with a determination (e.g., in response to detecting that) that the viewpoint of the user is a first viewpoint, the computer system displays the user interface element for the media content relative to the reference in the media content in a first location in the three-dimensional environment. For example, when (e.g., in accordance with a determination that) the viewpoint of the user has a first orientation in the three-dimensional environment (e.g., a first angular orientation relative to the three-dimensional environment), the computer system optionally displays the user interface element for the media content at the first location. Continuing with this example, in accordance with a determination that (e.g., in response to detecting that) the viewpoint of the user is a second viewpoint in the three-dimensional environment (that optionally is optionally due to the computer system detecting a head rotation of the user rightward, clockwise, upward, and/or another direction), the computer system optionally moves the user interface element for the media content in accordance with the movement of the viewpoint from the first orientation to the second orientation (e.g., moves the user interface element for the media content rightward, clockwise, upward, and/or the other direction). As such, the computer system optionally modifies the spatial relationship of the user interface element for the media content relative to the reference in the media content based on the change of the viewpoint of the user. Moving captions for media content in response to detecting a change in a viewpoint of a user maintains display of the captions for the user regardless of the viewpoint of the user, at which the user observes the three-dimensional environment that includes the media content, produces the technical effect of facilitating a continued human-machine interaction by resolving the technical requirements of displaying the media content and the captions for the media content in the three-dimensional environment when the captions for the media content would move “off screen” or “out of view” due to the change in viewpoint of the user, from which the user observes the media content in the three-dimensional environment, and reduces inputs that would otherwise be for manually repositioning the captions.

In some embodiments, while the three-dimensional environment is visible from a respective viewpoint of the user (e.g., the first or second viewpoint of the user discussed above with reference to step(s) 802) and while displaying the user interface element including the one or more captions for the media content having a respective spatial relationship to the spatial reference in the media content (e.g., the first or second spatial relationship relative to the spatial reference in the media content discussed above with reference to step(s) 802), wherein the user interface element including the one or more captions for the media content is displayed at a first location in the three-dimensional environment, the computer system detects, via the one or more input devices, an input to display a playback control user interface including one or more selectable options for performing one or more actions associated with the media content, such as the input from hand 926 in FIGS. 9H and 9H1 (e.g., detecting the respective air gesture that the first portion of the body of the user performs (and optionally, attention of the user as described above with reference to method 800) as described above with reference to method 800 to display the playback control user interface described above with reference to method 800).

In some embodiments, in response to detecting the input to display the playback control user interface including one or more selectable options for performing one or more actions associated with the media content, the computer system displays, via the display generation component, the playback control user interface including one or more selectable options for performing one or more actions associated with the media content (e.g., the playback control user interface described above with reference to method 800), wherein the playback control user interface is spatially separated from the media content in the three-dimensional environment (e.g., such as described above with reference to method 800), such as controls 918 in FIG. 9I.

In some embodiments, in accordance with a determination that (e.g., in response to detecting that) one or more criteria is met (such as the one or more criteria described below), the computer system displays, via the display generation component, the user interface element including the one or more captions for the media content at a second location, different from the first location, wherein when (e.g., in accordance with a determination that) the user interface element including the one or more captions for the media content is at the second location, the spatial arrangement of the playback control user interface and the user interface element including the one or more captions for the media content is a first spatial arrangement, such as the location of element 910 in FIG. 9J (e.g., the first spatial arrangement is optionally a first relative position, orientation, and/or distance between the playback control user interface and the user interface element including the one or more captions for the media content in the three-dimensional environment). In some embodiments, when (e.g., in accordance with a determination that) the one or more criteria described above is not met, the spatial arrangement is different from the first arrangement described above. For example, when (e.g., in accordance with a determination that) the computer system initially displays the playback control user interface, the spatial arrangement is different from the first spatial arrangement (e.g., a distance between the user interface element including the one or more captions for the media content and the playback control user interface is a first distance, and when (e.g., in accordance with a determination that) the one or more criteria is met, the computer system modifies the spatial arrangement to be the first spatial arrangement, which is optionally a second distance less than the first distance. Continuing with this example, when the computer system modifies the spatial arrangement to be the first spatial arrangement, the computer system maintains a position and/or orientation of the playback control user interface while changing the position of the user interface element including the one or more captions for the media content to be closer to the position of the playback control user interface in the three-dimensional environment. In some embodiments, when the computer system displays the user interface element including the one or more captions for the media content at the first location (described above) in the three-dimensional environment the user interface element including the one or more captions for the media content has a spatial relationship relative to the media content (e.g., relative to the spatial reference in the media content described above with reference to step(s) 1002), and when the computer system displays the playback control user interface, the computer system changes the spatial arrangement of the user interface element including the one or more captions for the media content relative to the media content to be a different spatial arrangement.

In some embodiments, the computer system visually moves the user interface element including the one or more captions for the media content from the first location and towards the second location. Moving the captions for media content towards the location of the playback control user interface maintains display of the captions for the user and directs the user to the location of the playback control user interface since the captions are moved toward the location of the playback control user interface, and reduces inputs that would otherwise be for manually repositioning the captions.

In some embodiments, the one or more criteria includes a requirement that attention of the user (e.g., attention of a user described throughout this disclosure, optionally in addition to attention of the user for a threshold amount of time as described throughout this disclosure) is directed to the playback control user interface in order for the one or more criteria to be met, such as attention 905c directed to controls 918 in FIG. 9I. As such, the computer system optionally moves the user interface element including the one or more captions for the media content to the second location that is optionally closer to the playback control user interface that the first location in response to detecting attention of the user (e.g., gaze of the user) directed towards the playback control user interface. In some embodiments, the computer system does not move the captions to the second location (described above) until the attention of the user is directed to the playback control user interface. Moving the captions for media content towards the location of the playback control user interface in response to detecting attention of the user directed toward the playback control user interface maintains display of the captions for the user (regardless of the location of the playback control user interface), and reduces inputs that would otherwise be for manually repositioning the captions.

In some embodiments, while the three-dimensional environment is visible via the display generation component from the respective viewpoint of the user (e.g., the first or second viewpoint of the user discussed above), while displaying, at the second location in the three-dimensional environment, the user interface element including the one or more captions for the media content (e.g., having the respective spatial relationship relative to the spatial reference in the media content in the three-dimensional environment discussed above), and while displaying the playback control user interface (e.g., the playback control user interface described above with reference to method 800), wherein the user interface element and the playback control user interface have the first spatial arrangement (discussed above), such as shown with element 910 and controls 918 in FIG. 9J, the computer system detects, via the one or more input devices, a second event corresponding to a second change of the viewpoint of the user relative to the three-dimensional environment, such as from FIGS. 9J to 9K-1. The second event optionally includes one or more features of the event described with reference to step(s) 1002, but corresponding to a second change of the viewpoint of the user relative to the three-dimensional environment.

In some embodiments, in response to detecting the second event corresponding to the second change of the viewpoint of the user relative to the three-dimensional environment, the computer system continues displaying, via the display generation component, of the user interface element including the one or more captions for the media content at the second location in the three-dimensional environment (described above) and the playback control user interface, with the spatial arrangement of the user interface element including the one or more captions for the media content and the playback control user interface being the first spatial arrangement, such as shown in FIG. 9K. As such, when the computer system concurrently displays the playback control user interface and the user interface element including the one or more captions for the media content (and optionally in accordance with the determination that (e.g., in response to detecting that) the one or more criteria discussed above is met), the location of the user interface element including the one or more captions for the media content and of the playback control user interface optionally remain the same regardless of the second event corresponding to the second change of the viewpoint of the user relative to the three-dimensional environment (and/or regardless of the change in viewpoint of the user). In some embodiments, when (e.g., in accordance with a determination that) the second change of viewpoint of the user is greater than a threshold change of viewpoint of the user (e.g., the second change of viewpoint of the user results in a viewpoint of the user relative to the three-dimensional environment that does not include visibility of the locations in the three-dimensional environment that the playback control user interface and the user interface element including the one or more captions for the media content had when the second event was detected), the computer system displays the user interface element including the one or more captions for the media content at a new location in the resulting viewpoint of the user that results from the second change of viewpoint of the user, optionally without displaying the playback control user interface in the resulting viewpoint of the user. Maintaining the location of the captions for media content and the playback control user interface in the three-dimensional environment in response to detecting a change in the viewpoint of the user corresponds the captions for media content and the playback control user interface to a specific location (e.g., region) in the three-dimensional environment, reduces errors associated with the computer system displaying the media content with the playback control user interface and the caption for media content, and reduces errors associated with user interaction with the computer system.

In some embodiments, after continuing display, via the display generation component, of the user interface element including the one or more captions for the media content (e.g., having the respective spatial relationship relative to the spatial reference in the media content described above) at the second location (described above) and the playback control user interface with the spatial arrangement of the user interface element including the one or more captions for the media content and the playback control user interface being the first spatial arrangement (e.g., as described above with reference to the computer system continuing display of the user interface element including the one or more captions for the media content at the second location in the three-dimensional environment and the playback control user interface, with the spatial arrangement of the user interface element including the one or more captions for the media content and the playback control user interface being the first spatial arrangement in response to detecting the second event corresponding to the second change of the viewpoint of the user relative to the three-dimensional environment), and in accordance with a determination that (e.g., in response to detecting that) one or more second criteria is met, such as an input to cease display of controls 918 in FIG. 9L (e.g., the second one or more criteria optionally includes a requirement that respective air gesture is performed by a portion of a body of the user and/or a requirement that input directed to the playback control user interface is not detected within a threshold period of time while the playback control user interface is displayed in order for the one or more criteria to be met, such as described above with reference to method 800, and/or a requirement that the second change of viewpoint of the user is greater than a threshold change of viewpoint of the user (e.g., the second change of viewpoint of the user results in a viewpoint of the user relative to the three-dimensional environment that does not include visibility of the locations in the three-dimensional environment that the playback control user interface and the user interface element including the one or more captions for the media content had when (e.g., in accordance with a determination that) the second event was detected), such as described above), the computer system reduces (via the display generation component) a visual prominence (e.g., fading out, ceasing display, increasing a respective translucency, increasing a transparency, decreasing a color saturation, and/or decreasing a brightness) of the playback control user interface, such as shown in FIG. 9M. For example, if the playback controls obscured media content, when the computer system reduces the visual prominence of the playback controls, the computer system optionally increases in visual prominence (e.g., fades-in, displays, decreases a respective translucency, decreases a transparency, increases a color saturation, and/or increases a brightness of) the media content that was obscured (e.g., not visible) by the playback controls.

In some embodiments, the computer system initiates a process to display, via the display generation component, the user interface element including the one or more captions for the media content at a location in the three-dimensional environment that is different from the second location in the three-dimensional environment, having a third spatial relationship (e.g., orientation, position and/or placement) relative to the spatial reference in the media content, based on the second change of viewpoint of the user relative to the three-dimensional environment, including displaying, via the display generation component, the user interface element including the one or more captions for the media content at the location in the three-dimensional environment having the third spatial relationship relative to the spatial reference in the media content, such as shown with element 910 in FIG. 90. The third spatial relationship optionally includes one or more features described regarding spatial relationships, such as the first spatial relationship and the second spatial relationship, with reference to step(s) 1002. In some embodiments, when (e.g., in accordance with a determination that) second change of viewpoint of the user is a change of viewpoint of the user to the first viewpoint of the user, the third spatial relationship relative to the spatial reference in the media content in the three-dimensional environment is optionally the same as the first spatial relationship discussed above with reference to step(s) 1002. In some embodiments, when (e.g., in accordance with a determination that) second change of viewpoint of the user is a change of viewpoint of the user to the second viewpoint of the user, the third spatial relationship relative to the spatial reference in the media content in the three-dimensional environment is optionally the same as the second spatial relationship discussed above with reference to step(s) 1002. In some embodiments, when the computer system displays the user interface element including the one or more captions for the media content at the second location (described above) in the three-dimensional environment, the user interface element including the one or more captions for the media content has a first spatial arrangement relative to the media content, and when the computer system ceases display of the playback control user interface, the computer system changes the spatial arrangement of the user interface element including the one or more captions for the media content relative to the media content to be a different spatial arrangement relative to the media content (e.g., relative to the spatial reference in the media content described above with reference to step(s) 1002). Moving the captions for media content based on the second change of viewpoint of the user (such that in the viewpoint of the user that results from the second change of viewpoint of the user, the captions are visible) in in accordance with the determination that the one or more second criteria described above is met permits playback control user interface permits display of the captions at an ideal location based the second change of viewpoint of the user, produces the technical effect of facilitating a continued human-machine interaction by resolving the technical requirements of displaying the media content and the captions for the media content in the three-dimensional environment when the captions for the media content would be “off screen” or “out of view” as a result of the second change in viewpoint of the user due to a maintaining of the location of the captions for media content when the second event corresponding to the second change of viewpoint of the user was detected, and reduces inputs that would otherwise be for manually repositioning the captions.

In some embodiments, initiating the process to display, via the display generation component, the user interface element including the one or more captions for the media content at the location in the three-dimensional environment having the third spatial relationship relative to the spatial reference in the media content (e.g., initiating the process to display, via the display generation component, the user interface element including the one or more captions for the media content at the location in the three-dimensional environment that is different from the second location in the three-dimensional environment, having the third spatial relationship (e.g., orientation, position and/or placement) relative to the spatial reference in the media content, based on the second change of viewpoint of the user relative to the three-dimensional environment, as discussed above) includes reducing a visual prominence (e.g., fading out, ceasing display, increasing a respective translucency, increasing a transparency, decreasing a color saturation, and/or decreasing a brightness) of the user interface element including the one or more captions for the media content that was displayed at the second location with the spatial arrangement of the user interface element including the one or more captions for the media content and the playback control user interface being the first spatial arrangement (described above), such as shown with element 910 in FIG. 9M. For example, if the captions obscured media content, when the computer system reduces the visual prominence of the captions, the computer system optionally increases in visual prominence (e.g., fades-in, displays, decreases a respective translucency, decreases a transparency, increases a color saturation, and/or increases a brightness of) the media content that was obscured (e.g., not visible) by the captions.

In some embodiments, after reducing the visual prominence of the user interface element including the one or more captions for the media content that was displayed at the second location with the spatial arrangement of the user interface element including the one or more captions for the media content and the playback control user interface being the first spatial arrangement, the computer system displays, via the display generation component, the user interface element including the one or more captions for the media content at the location in the three-dimensional environment having the third spatial relationship relative to the spatial reference in the media content, such as shown with element 910 in FIG. 90. For example, the computer system optionally moves the user interface element including the one or more captions for the media content to the location in the three-dimensional environment having the third spatial relationship relative to the spatial reference in the media content by fading-out the user interface element including the one or more captions for the media content that was displayed with playback control user interface and redisplaying the user interface element including the one or more captions for the media content at the location in the three-dimensional environment having the third spatial relationship relative to the spatial reference in the media content. Moving the captions for media content by fading-out the captions and then displaying the captions at the location in the three-dimensional environment having the third spatial relationship relative to the spatial reference in the media content smoothly transitions display of the captions to the location and reduces inputs that would otherwise be for manually repositioning the captions.

In some embodiments, displaying, via the display generation component, the user interface element including the one or more captions for the media content at the location in the three-dimensional environment having the third spatial relationship relative to the spatial reference in the media content includes increasing the visual prominence (e.g., fading-in, displaying, decreasing a respective translucency, decreasing a transparency, increasing a color saturation, and/or increasing a brightness) of the user interface element including the one or more captions for the media content while visually moving the user interface element including the one or more captions for the media content towards the location in the three-dimensional environment having the third spatial relationship relative to the spatial reference in the media content, such as indicating this movement of element 910 in FIG. 90 while element 910 is fading into view (optionally, after reducing the visual prominence of the user interface element including the one or more captions for the media content that was displayed at the second location with the spatial arrangement of the user interface element including the one or more captions for the media content and the playback control user interface being the first spatial arrangement). As such, the computer system optionally visually shows movement of the user interface element including the one or more captions for the media content towards the location in the three-dimensional environment while increasing the visual prominence of the user interface element including the one or more captions for the media content. Moving the captions for media content by visually showing movement of the captions while fading-in the captions towards the location in the three-dimensional environment smoothly transitions display of the captions to the location, reduces inputs that would otherwise be for manually repositioning the captions, and reduces computer system errors with displaying the captions in different locations.

In some embodiments, displaying the user interface element including the one or more captions for the media content having the second spatial relationship relative to the spatial reference in the media content is performed in accordance with a determination that (e.g., in response to detecting that) one or more criteria is met, wherein the one or more criteria includes a requirement that a threshold period of time (e.g., 0.05 s, 0.1 s, 0.5 s, 1 s, 2.5 s, 5 s, 10 s, 15 s or another threshold period of time) has passed since detecting the event corresponding to the change of the viewpoint of the user relative to the three-dimensional environment from the first viewpoint of the user to the second viewpoint of the user relative to the three-dimensional environment (described with reference to step(s) 3102) in order for the one or more criteria to be met, such as the time delay in moving element 910 with respect to the movement of the viewpoint of the user from FIGS. 9B to 9G. For example, a rate of movement of the user interface element including the one or more captions for the media content to the second spatial relationship (and second location in the three-dimensional environment) is optionally slower than a rate of change of viewpoint of the user from the first viewpoint of the user to the second viewpoint of the user, such that an angular speed (e.g., an instantaneous angular speed) of the captions relative to a respective viewpoint of the user that is the viewpoint of the user during the changing of the viewpoint of the user from the first viewpoint of the user to the second viewpoint of the user is optionally less than an angular speed (e.g., an instantaneous angular speed) of the change of the viewpoint of the user from the first viewpoint of the user to the second viewpoint of the user (e.g., less than the instantaneous angular speed of the viewpoint of the user when (e.g., in accordance with a determination that) the viewpoint of the user during the changing of the viewpoint of the user from the first to the second viewpoint of the user is the respective viewpoint of the user). In some embodiments, the computer system maintains display of the user interface element including the one or more captions for the media content at the location that the user interface element had in the three-dimensional environment before the one or more criteria described above is met, until the one or more criteria is met (e.g., until the threshold time has passed since the viewpoint of the user changed). Moving the captions for media content by visually showing movement of the captions while fading-in the captions towards a location in the three-dimensional environment (e.g., an ideal location in the three-dimensional environment from the viewpoint of the user) smoothly transitions display of the captions to the location, reduces inputs that would otherwise be for manually repositioning the captions, and reduces computer system errors with displaying the captions in different locations.

In some embodiments, in response to detecting the event corresponding to the change of the viewpoint of the user relative to the three-dimensional environment from the first viewpoint of the user to the second viewpoint of the user (such as described with reference to step(s) 1002), the computer system displays, via the display generation component, the user interface element including the one or more captions for the media content at a first respective location in the three-dimensional environment from the second viewpoint of the user, with a respective amount of visual prominence (e.g., a respective amount of translucency, respective amount of transparency, respective amount of color saturation, and/or respective amount of brightness), wherein the one or more captions are displayed as moving towards a second respective location in the three-dimensional environment, such as shown with element 910 in FIG. 9F. While the user interface element including the one or more captions for the media content is displayed at the first respective location in the three-dimensional environment from the second viewpoint of the user, with the respective amount of visual prominence, the user interface element including the one or more captions for the media content does not have the second spatial relationship relative to the spatial reference in the content in the three-dimensional environment. For example, while the captions are displayed with the respective amount of visual prominence at the first respective location, the computer system optionally partially or fully obscures a portion of the media content that is behind the captions in the view of the three-dimensional environment from the second viewpoint of the user (such as a partial or fully forgoing of display of the portion of the media content that is behind the captions in the view of the three-dimensional environment from the second viewpoint of the user).

In some embodiments, after displaying, via the display generation component, the user interface element including the one or more captions for the media content having the first respective location in the three-dimensional environment from the second viewpoint of the user and with the respective amount of visual prominence, the computer system displays, via the display generation component, the user interface element including the one or more captions for the media content having the second respective location in the three-dimensional environment from the second viewpoint of the user, different from the first respective location in the three-dimensional environment from the second viewpoint of the user, with an amount of visual prominence that is greater than the respective amount of visual prominence (discussed above), such as fading in of element 910 in FIG. 9G, and wherein when (e.g., in accordance with a determination that) the user interface element has the second respective location in the three-dimensional environment from the second viewpoint of the user, the user interface element including the one or more captions for the media content has the second spatial relationship relative to the spatial reference in the media content in the three-dimensional environment. For example, when (e.g., in accordance with a determination that) the first amount of visual prominence is a first amount of translucency, amount of transparency, amount of color saturation, and/or amount of brightness, the second amount of visual prominence is a second amount of translucency less than the first amount of translucency, second amount of transparency less than the first amount of transparency, second amount of color saturation greater than the first amount of color saturation, and/or a second amount of brightness greater than the first amount of brightness. For example, while the captions are displayed with the amount of visual prominence that is greater than the respective amount of visual prominence at the second respective location, the computer system optionally obscures, with an amount greater than the amount of obscuration of the portion of the media content described above, a second portion of the media content that is behind the captions (at the second respective location) in the view of the three-dimensional environment from the second viewpoint of the user described above. As such, the computer system optionally reduces the visual prominence (e.g., increases a transparency, reduces a size, reduces a color saturation) of the user interface element including the one or more captions for the media content while the user interface element including the one or more captions for the media content is moving. Visually fading-out the captions while showing movement of the captions towards a location in the three-dimensional environment (e.g., an ideal location in the three-dimensional environment from the viewpoint of the user) smoothly transitions display of the captions to the location, permits display of the media content that would be obscured due to the movement of the captions, reduces inputs that would otherwise be for manually repositioning the captions, and reduces computer system errors with displaying the captions in different locations.

In some embodiments, while displaying, via the display generation component, the user interface element including the one or more captions for the media content at the first respective location (as described above), in accordance with a determination that (e.g., in response to detecting that) the change in viewpoint of the user relative to the three-dimensional environment from the first viewpoint of the user to the second viewpoint of the user is a first amount of change of viewpoint of the user (and/or is associated with a first amount of rate of change of viewpoint of the user (optionally with respect to time), the respective amount of visual prominence is a first amount of visual prominence, such as a first amount of decrease in visual prominence of element 910 in FIG. 9F. For example, the first viewpoint of the user is optionally associated with a first orientation (and a first location relative to the three-dimensional environment), the second viewpoint of the user is optionally associated with a second orientation (and the first location relative to the three-dimensional environment) that is angularly offset from the first orientation, and the first amount of change of viewpoint of the user is optionally a first angular difference (e.g., 2 degrees, 5 degrees, 10 degrees, 15 degrees, 20 degrees, 30 degrees, or another angular difference) between the first viewpoint of the user and the second viewpoint of the user from the first location (e.g., the second viewpoint of the user optionally is angularly offset from the first orientation of the first viewpoint of the user by the first amount of change of viewpoint of the user). The first amount of rate of change of viewpoint of the user with respect to time is optionally 2 degrees/second, 5 degrees/second, 10 degrees/second, 15 degrees/second, 20 degrees/second, 30 degrees/second, 60 degrees/second, or another rate.

In some embodiments, while displaying, via the display generation component, the user interface element including the one or more captions for the media content at the first respective location, in accordance with a determination that (e.g., in response to detecting that) the change in viewpoint of the user relative to the three-dimensional environment from the first viewpoint of the user to the second viewpoint of the user is a second amount of change of viewpoint of the user, greater than the first amount of change of viewpoint of the user (and/or is associated with a second amount of rate of change of viewpoint of the user that is greater in absolute than the first amount of rate of change of viewpoint of the user (optionally with respect to time), the respective amount of visual prominence is a second amount of visual prominence that is less than the first amount of visual prominence, such as a second amount of decrease in visual prominence of element 910 in FIG. 9F. For example, the first viewpoint of the user is optionally associated with the first orientation, as described above, and the second viewpoint of the user is optionally associated with the second orientation, as described above, and the second amount of change of viewpoint of the user is optionally a larger angular difference (e.g., 4 degrees, 10 degrees, 20 degrees, 25 degrees, 30 degrees, 50 degrees, or another angular difference that is larger than the first angular difference described above) between the first viewpoint of the user and the second viewpoint of the user (e.g., the second viewpoint of the user is optionally angularly offset from the first orientation of the first viewpoint of the user by the second amount of change of viewpoint of the user). The second amount of rate of change of viewpoint of the user optionally with respect to time is optionally 3 degrees/second, 7 degrees/second, 12 degrees/second, 17 degrees/second, 22 degrees/second, 35 degrees/second, 68 degrees/second, or another rate that is larger than the first amount of rate of change of viewpoint of the user described above. As such, the amount of reduction in visual prominence of the user interface element including the one or more captions for the media content is optionally based on an amount (e.g., angular distance and/or speed) of movement corresponding to the change of the viewpoint of the user from the first viewpoint of the user to the second viewpoint of the user, such as described above. Increasing an amount of reduction in visual prominence of the captions as the amount of change of viewpoint of the user increases smoothly transitions display of the captions to a location in the three-dimensional environment (e.g., an ideal location from the viewpoint of the user), permits display of the media content that would be obscured due to movement of the captions without the reduction in visual prominence of the captions, reduces inputs that would otherwise be for manually repositioning the captions, and reduces computer system errors with displaying the captions in different locations.

In some embodiments, in response to detecting the event corresponding to the change of the viewpoint of the user relative to the three-dimensional environment from the first viewpoint of the user to the second viewpoint of the user, in accordance with a determination that (e.g., in response to detecting that) the change in viewpoint of the user relative to the three-dimensional environment from the first viewpoint of the user to the second viewpoint of the user is greater than a threshold change in viewpoint of the user (such as greater than the second amount of change of viewpoint of the user described above, and/or is greater than a threshold rate of change of viewpoint of the user, such as greater (in absolute) than the second rate of change of viewpoint of the user described above), forgoing display of the user interface element including the one or more captions for the media content via the display generation component at the first respective location, such as if element 910 is not displayed at all in FIG. 9F. Thus, the computer system optionally ceases display of the user interface element including the one or more captions for the media content when (e.g., in accordance with a determination that) the change in viewpoint is greater than the threshold change in viewpoint of the user. In addition, after forgoing display of the user interface element including the one or more captions for the media content at the first respective location, the computer system optionally displaying the user interface element including the one or more captions for the media content at the second respective location (described above) which is optionally visible via the display generation component while the viewpoint of the user changes from the first viewpoint of the user to the second viewpoint of the user described above. Forgoing displaying the captions when the change in viewpoint of the user is greater than a threshold change in viewpoint of the user permits display of the media content that would be obscured due to movement of the captions without the total reduction in visual prominence of the captions, reduces inputs that would otherwise be for manually repositioning the captions, and reduces computer system errors with displaying the captions in different locations.

In some embodiments, while displaying the user interface element including the one or more captions for the media content having the second spatial relationship relative to the spatial reference in the media content in the three-dimensional environment, the user interface element including the one or more captions for the media content is displayed at a first location in three-dimensional environment that, in a view of the three-dimensional environment from the second viewpoint of the user, is offset from a center (e.g., a center orientation) of the second viewpoint of the user, such as the offset location of element 910 in FIG. 9G (e.g., the center is optionally a vector extending out from the center of the field of view from the second viewpoint of the user, perpendicular to the second viewpoint of the user, and the computer system displays the user interface element including the one or more captions for the media content offset (e.g., perpendicularly offset by a distance (e.g., 0.2m, 0.5 m away, 1 m away, 5 m away, 10 m away, 25 m away, 50 m, or another distance). While displaying the user interface element including the one or more captions for the media content having the first spatial relationship relative to the spatial reference in the media content in the three-dimensional environment (described above with reference to step(s) 1002), the user interface element including the one or more captions for the media content is displayed at a location in three-dimensional environment that, in a view of the three-dimensional environment from the first viewpoint of the user, is offset from a center (e.g., a center orientation) of the first viewpoint of the user (e.g., the center is optionally a vector extending out from the center of the field of view from the first viewpoint of the user, perpendicular to the viewpoint, and the computer system displays the user interface element including the one or more captions for the media content offset (e.g., perpendicularly offset by a distance (e.g., 0.2m, 0.5 m away, 1 m away, 5 m away, 10 m away, 25 m away, 50 m, or another distance)) from the center of the viewpoint. Displaying the captions offset from the center of the viewpoint of the user placing the captions in an appropriate location that permits user interaction with the media content and the captions, without the captions significantly obscuring the media content.

In some embodiments, in response to detecting the event corresponding to the change of the viewpoint of the user relative to the three-dimensional environment from the first viewpoint of the user to the second viewpoint of the user relative to the three-dimensional environment, the computer system displays, via the display generation component, the media content, wherein the media content is displayed from the second viewpoint of the user (e.g., in a depth dimension, a vertical dimension, or a horizontal dimension) relative to the three-dimensional environment, wherein a closest element of the media content to the second viewpoint of the user is at a first distance from the second viewpoint of the user (e.g., a distance at which no other element of the media content has a smaller distance to the second viewpoint of the user), such as the media content in FIG. 9G, wherein the user interface element including the one or more captions for the media content is displayed at a second distance from the second viewpoint of the user that is less than the first distance from the second viewpoint of the user, such as the location of element 910 in FIG. 9G. In some embodiments, in accordance with a determination that (e.g., in response to detecting that) the closest element of the media content to the second viewpoint of the user is the first distance from the second viewpoint of the user, the user interface element including the one or more captions for the media content is displayed at the second distance from the second viewpoint of the user that is less than the first distance; and in accordance with a determination that (e.g., in response to detecting that) the closest element of the media content to the second viewpoint of the user is a third distance, different from the first distance, from the second viewpoint of the user, the user interface element including the one or more captions for the media content is displayed at a fourth distance from the second viewpoint of the user that is less than the third distance. As such, a distance between the viewpoint of the user and the user interface element including the one or more captions for the media content is optionally less than a distance between the closest element of the media content to the viewpoint of the user. Displaying the captions closer to the viewpoint of the user than the closest element of the media content maintains a separation distance between the captions and the media content, which reduces errors when interaction with the media content and/or captions.

In some embodiments, while displaying the media content in accordance with a determination that (e.g., in response to detecting that) attention of the user (e.g., gaze of the user and/or attention of the user described above) is directed to a respective user interface element of a first type, different from the user interface element of a second type including the one or more captions for the media content, such as attention 905 directed to element 903 in FIG. 9B, the computer system reduces a visual prominence (e.g., fading out, ceasing display, increasing a respective translucency, increasing a transparency, decreasing a color saturation, and/or decreasing a brightness) of the user interface element including the one or more captions for the media content, such as shown from FIGS. 9C-9D. In some embodiments, the respective user interface element optionally includes information associated with the media content, such as content rating information, release date, and/or other information associated with the media content. In some embodiments, the respective user interface element optionally does not include any information associated with the media content. In some embodiments, the computer system displays the respective user interface element overlaid on the media content from the viewpoint of the user, or outside of the media content from the viewpoint of the user. In some embodiments, when (e.g., in accordance with a determination that) attention of the user is directed to the media content while the computer system reduces the visual prominence of the user interface element including the one or more captions for the media content, the computer system optionally increases the visual prominence of the user interface element including the one or more captions for the media content. As such, the computer system optionally changes the visual prominence of the user interface element including the one or more captions for the media content based on a type of the respective user interface element to which the attention of the user is directed. Reducing the visual prominence of the captions in accordance with the determination that attention of the user is directed to a respective user interface element of the first type reduces the computer system consumption of resources because the computer system can cease displaying the captions while the attention of the user is directed to the respective user interface element, which further, reduces errors in interaction with the computer system.

In some embodiments, the media content is immersive media content, such as the content in FIG. 9A (e.g., three-dimensional content that surrounds the user of the computer system in a view of the three-dimensional environment and/or three-dimensional content for which the computer system simulates depth effect(s) optionally relative to a viewpoint(s) of the user, such that the user visually experiences the three-dimensional content as three-dimensional content).

In some embodiments, the computer system displays, via the display generation component, second media content that is non-immersive media content (e.g., is optionally displayed and/or bounded within a planar or curved plane from the perspective of the first user and/or in which elements of the media content optionally do not include depth dimensions) at a location in the three-dimensional environment, such as content 908f in FIG. 9P. The non-immersive media content is optionally surrounded by an application window. In some embodiments, the computer system displays the non-immersive media content in an application window.

In some embodiments, the computer system detects, via the one or more input devices, an event corresponding to a trigger to display a user interface element that includes one or more captions for the second media content, such as to display element 910 in FIG. 9P. The second user interface element including the one or more captions for the second media content optionally includes one or more features described relative to step(s) 1002 with reference to the user interface element including the one or more captions for the media content, but corresponding to the second media content. For example, the user interface element including the one or more captions for the media content optionally include captions, closed captions, and/or subtitles for and/or corresponding to the second media content. The event to display the user interface element that includes the one or more captions for the media content optionally includes one or more features of the event described with reference to method 800, but corresponding to a request to display the user interface element that includes the one or more captions for the media content. In some embodiments, the computer system detects the event while the computer system displays a playback control user interface, such as the playback control user interface described above with reference to method 800. In some embodiments, the playback control user interface includes, optionally among other selectable options, a selectable option for displaying the user interface element including the one or more captions for the media content (e.g., a selectable option for enabling display of captions). In some embodiments, the event to display the user interface element that includes the one or more captions for the media content includes an event corresponding to selection of the selectable option for displaying the user interface element including the one or more captions for the media content described above. In some embodiments, the event corresponds to a change in an application setting or a system setting. For example, the event optionally corresponds to a change in an application setting or a system setting to display (e.g., turn-on or enable) captions. As another example, the event optionally corresponds to starting to play the second media content while the captions are enabled (e.g., are already in a setting that would cause captions to be displayed when playback of the second media content is initiated).

In some embodiments, in response to detecting the event corresponding to the trigger to display the user interface element that includes the one or more captions for the media content, the computer system displays, via the display generation component, the user interface element that includes the one or more captions for the media content at a location in the three-dimensional environment that is independent of a viewpoint of the user, such as the location of element 910 in FIGS. 9P and 9Q (e.g., optionally at a fixed spatial arrangement relative to the media content, independent of the viewpoint of the user). Thus, in accordance with a determination that (e.g., in response to detecting that) that the viewpoint of the user is a first viewpoint of the user when (e.g., in accordance with a determination that) the event to display the user interface element including the one or more captions for the media content is detected, the computer system optionally displays the user interface element including the one or more captions for the media content at a first location (and with a first orientation in the three-dimensional environment), and in accordance with a determination that (e.g., in response to detecting that) the viewpoint of the user is a second viewpoint of the user of the when (e.g., in accordance with a determination that) the event to display the user interface element including the one or more captions for the media content is detected, the computer system optionally displays the user interface element including the one or more captions for the media content at a first location (and with the first orientation in the three-dimensional environment or optionally with a second orientation in the three-dimensional environment). The location is optionally above, below, and/or in between the media content and the viewpoint of the user. Displaying the captions differently based on whether the media content is immersive or non-immersive indicates a type of media content, and reduces errors in interaction with the computer system when the computer system displays immersive content versus non-immersive content.

FIG. 11 is a flow diagram illustrating an exemplary method of moving captions relative to a viewpoint of a user in accordance with some embodiments. In some embodiments, the method 1100 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1100 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1100 are, optionally, combined and/or the order of some operations is, optionally, changed.

In some embodiments, method 1100 is performed at a computer system in communication with one or more display generation components and one or more input devices. In some embodiments, the computer system, the display generation component(s) and/or the input device(s) have one or more of the characteristics of the computer system(s), the display generation component(s) and/or the input device(s) of methods 800 and/or 1000.

In some embodiments, while displaying, via the one or more display generation components, immersive media content, such as media 908 in FIG. 9R (e.g., immersive media content as described with reference to methods 800 and/or 1000) and a user interface element that includes one or more captions for the immersive media content, such as element 910 in FIG. 9R (e.g., a user interface element that includes captions as described with reference to method 1000), wherein the user interface element has a first spatial arrangement (e.g., position and/or orientation) relative to a viewpoint of a user of the computer system (e.g., the center point of the user interface element has the first spatial arrangement relative to the viewpoint of the user), such as the spatial arrangement of element 910 to viewpoint 901 in FIG. 9R, the computer system detects (1102a), via the one or more input devices, a first set of one or more inputs directed to the user interface element, such as including gaze 950 directed to element 910 and an air pinch gesture from hand 926 in FIGS. 9R-9T. For example, the first set of one or more inputs includes a gaze (directed to the user interface element) and air pinch (or other air) gesture directed to the user interface element, a mouse click directed to the user interface element, a touch input directed to the user interface element and/or a voice input directed to the user interface element. In some embodiments, the first set of one or more inputs includes a movement input, such as an air pinch and drag gesture, a touch and hold drag gesture and/or a mouse click and drag gesture. In some embodiments, the immersive media content and/or the user interface element are displayed in a three-dimensional environment. The three-dimensional environment optionally includes one or more features of the three-dimensional environments described with reference to methods 800 and/or 1000. In some embodiments, the three-dimensional environment is an XR, AR, or VR environment.

In some embodiments, in response to detecting the first set of one or more inputs, the computer system moves (1102b) the user interface element relative to the immersive media content (and/or relative to the viewpoint of the user) in accordance with the first set of one or more inputs, such as the movement of element 910 from FIGS. 9R-9T, such that the user interface element that includes the one or more captions for the immersive media content has a second spatial arrangement (e.g., position and/or orientation) relative to the viewpoint of the user, different from the first spatial arrangement relative to the viewpoint of the user, such as the different spatial arrangement of element 910 relative to viewpoint 901 in FIG. 9T than in FIG. 9R (e.g., the center point of the user interface element has the second spatial arrangement relative to the viewpoint of the user). In some embodiments, the viewpoint of the user does not change before, during and/or after detecting the first set of one or more inputs directed to the user interface element. In some embodiments, the user interface element is moved in a direction and/or magnitude corresponding to a direction and/or magnitude of the movement input included in the first set of one or more inputs. Thus, the user interface element optionally moves differently and/or to a different spatial arrangement relative to the viewpoint of the user depending on the direction and/or magnitude of the movement input. In some embodiments, the immersive media content does not move before, during and/or after detecting the first set of one or more inputs directed to the user interface element (e.g., a reference point of the immersive media content, such as the center of the immersive media content, does not move relative to the viewpoint of the user). Thus, the user interface element is optionally moving relative to the immersive media content. Facilitating movement of the user interface element relative to the immersive media content ensures efficient and/or continued access to the user interface element, thus reducing errors in interaction with the immersive media content and/or the computer system.

In some embodiments, prior to detecting the first set of one or more inputs, the user interface element is displayed without a movement element, such as in FIG. 9R (e.g., a control element that is selectable to move the user interface element in the three-dimensional environment), in response to detecting a first input of the first set of one or more inputs directed to the user interface element, such as gaze 950 directed to element 910 and an air pinch and release gesture from hand 926 in FIG. 9R (e.g., a gaze and air pinch and release gesture directed to the user interface element including the captions, or a mouse click and release gesture directed to the user interface element), the user interface element is displayed with the movement element, such as movement element 911 in FIG. 9S (e.g., the movement element is optionally displayed below or at another predefined spatial arrangement relative to the user interface element, such as below and slightly closer to the viewpoint than the user interface element), and the first set of one or more inputs includes a second input directed to the movement element for moving the user interface element relative to the viewpoint of the user, such as an air pinch and drag input from hand 926 while gaze 950 is directed to movement element 911 from FIG. 9S-9T. In some embodiments, the second input includes a movement input directed to the movement element. For example the second input optionally includes an air pinch and drag gesture directed to the movement element while the gaze of the user was directed to the movement element. In some embodiments the second input includes a click and drag gesture directed to the movement element. In some embodiments the second input is not directed to the user interface element, but is specifically directed to the movement element. In some embodiments the second input is instead directed to the user interface element. In some vitamins the user interface element is moved in a direction and/or with a magnitude that corresponds to a direction and or magnitude of the second input. Displaying a movement element for the user interface element provides visual feedback to the user that the user interface element can be moved in the three-dimensional environment, thereby reducing errors in interaction with the computer system and reducing input needed to correct such errors.

In some embodiments, while the user interface element has the second spatial arrangement relative to the viewpoint of the user, such as in FIG. 9T, the computer system detects the viewpoint of the user change from a first viewpoint to a second viewpoint, such as from FIG. 9T to FIG. 9U. In some embodiments, the change in the viewpoint of the user is a movement of the viewpoint and/or a rotation or change of orientation of the viewpoint relative to the three-dimensional environment. In some embodiments, the change in the viewpoint of the user is physical movement of the user in a physical environment of the user. In some embodiments, the change in the viewpoint of the user is a separate input, other than movement of the user in the physical environment.

In some embodiments, in response to detecting the viewpoint of the user change from the first viewpoint to the second viewpoint, the computer system displays, via the one or more display generation components, the immersive media content from the second viewpoint of the user, such as in FIG. 9U. For example, displaying the immersive content from an updated perspective and/or distance of the viewpoint of the user from the immersive media content. In some embodiments, in response to detecting the viewpoint of the user change from the first viewpoint to the second viewpoint, the computer system maintains display of the user interface element with the second spatial arrangement relative to the second viewpoint of the user, such as if element 910 maintained its spatial arrangement relative to viewpoint 901 from FIG. 9T to FIG. 9U (as indicated by indication 910′ in the top-down view of FIG. 9U). Therefore, the user interface element is optionally viewpoint-locked. The user interface element optionally maintains the second spatial arrangement relative to the viewpoint of the user until subsequent movement input is directed to the user interface element for changing the spatial arrangement of the user interface element relative to the viewpoint of the user. In some embodiments, changing the viewpoint of the user does not change the spatial arrangement between the user interface element and the viewpoint of the user; therefore the spatial arrangement between the user interface element and the viewpoint of the user is optionally maintained. Maintaining the spatial arrangement between the user interface element and the viewpoint of the user, unless subsequent movement input is directed to the user interface element for changing the spatial arrangement, ensures consistent and easy access to the user interface element, which reduces errors in interaction with the computer system, and reduces the need to provide additional movement input directed to the user interface element.

In some embodiments, the user interface element is viewpoint-locked, such as element 910 being viewpoint-locked from FIGS. 9R-9U. In some embodiments, the computer system maintains display of the user interface element at whatever spatial arrangement is set by user input, even if the immersive media content is no longer within the viewport of the computer system. For example, if the user turns their head away from the immersive media content such that the updated viewport of the computer system no longer includes the immersive media content (such that the computer system is no longer displaying the immersive media content), the computer system optionally continues to display the user interface element with the second spatial arrangement (or other preexisting spatial arrangement) relative to the viewpoint of the user. In some embodiments, the computer system continues to display the user interface element at such spatial arrangement relative to the viewpoint of the user until user input is detected to cease display of the user interface element, or until user input is detected to change the spatial arrangement between the user interface element and the viewpoint of the user. Maintaining the spatial arrangement between the user interface element and the viewpoint of the user, unless subsequent movement input is directed to the user interface element for changing the spatial arrangement, ensures consistent and easy access to the user interface element, which reduces errors in interaction with the computer system, and reduces the need to provide additional movement input directed to the user interface element.

In some embodiments, while the user interface element has the second spatial arrangement relative to the viewpoint of the user, such as in FIG. 9T, the computer system detects, via the one or more input devices, a second set of one or more inputs corresponding to a request to cease displaying the immersive media content, such as if computer system 101 detected an input to cease displaying media 908 in FIG. 9T. For example, the second set of one or more inputs includes an input to close a media application that is displaying the immersive media content. In some embodiments, the second set of one or more inputs includes a user input to close the immersive media content itself (optionally without closing a media application that is displaying the immersive media content). In some embodiments, the second set of one or more inputs includes an air gesture, a mouse input, a voice input, or a touch input.

In some embodiments, in response to detecting the second set of one or more inputs, the computer system ceases display of the immersive media content, such as ceasing display of media 908 in FIG. 9T. In some embodiments, the computer system also ceases display of the user interface element when the immersive media content is no longer displayed.

In some embodiments, after ceasing display of the immersive media content, the computer system detects, via the one or more input devices, a third set of one or more inputs corresponding to a request to display second immersive media content, such as a request to redisplay media 908 or other media. In some embodiments, the second immersive media content is the same as the immersive media content, or is different than the immersive media content. In some embodiments, the third set of one or more inputs includes an air gesture, a mouse input, a voice input, or a touch input. In some embodiments, the third set of one or more inputs includes an input to reopen the media application or the immersive media content itself. In some embodiments, the third set of one or more inputs includes an input to start playing the second immersive media content.

In some embodiments, in response to detecting the third set of one or more inputs, the computer system displays, via the one or more display generation components, the second immersive media content. Displaying the second immersive media content optionally has one or more of the characteristics of displaying the immersive media content. In some embodiments, in response to detecting the third set of one or more inputs, the computer system displays, via the one or more display generation components, a user interface element including one or more captions for the second immersive media content with the first spatial arrangement relative to the viewpoint of the user, such as resetting element 910 to have the spatial arrangement it had in FIG. 9R rather than in FIG. 9T. In some embodiments, the user interface element including the captions for the second immersive media content has one or more of the characteristics of the user interface element including the captions for the immersive media content. In some embodiments, therefore, exiting the media session after receiving user input for changing the spatial arrangement between the user interface element and the viewpoint of the user resets the spatial arrangement at which the next user interface element that is displayed with captions will be displayed relative to the viewpoint of the user when subsequent immersive media content is displayed. Resetting the spatial relationship between captions and the viewpoint of the user each time a media session is exited or closed ensures predictable display of the captions whenever immersive media content is initially displayed, which reduces errors in interaction with the computer system, and reduces the need for input to correct such errors.

In some embodiments, while the user interface element has the second spatial arrangement relative to the viewpoint of the user, such as in FIG. 9T, the computer system detects, via the one or more input devices, a second set of one or more inputs corresponding to a request to cease displaying the immersive media content, such as if computer system 101 detected an input to cease displaying media 908 in FIG. 9T (e.g., as described above). In some embodiments, in response to detecting the second set of one or more inputs, the computer system ceases display of the immersive media content, such as ceasing display of media 908 in FIG. 9T (e.g., as described above). In some embodiments, after ceasing display of the immersive media content, the computer system detects, via the one or more input devices, a third set of one or more inputs corresponding to a request to display second immersive media content, such as a request to redisplay media 908 or other media (e.g., as described above). In some embodiments, in response to detecting the third set of one or more inputs, the computer system displays, via the one or more display generation components, the second immersive media content (e.g., as described above), and displays, via the one or more display generation components, a user interface element including one or more captions for the second immersive media content with the second spatial arrangement relative to the viewpoint of the user, such as redisplaying element 910 to have the spatial arrangement it had in FIG. 9T rather than in FIG. 9R. In some embodiments, the user interface element including the captions for the second immersive media content has one or more of the characteristics of the user interface element including the captions for the immersive media content. In some embodiments, therefore, exiting the media session after receiving user input for changing the spatial arrangement between the user interface element and the viewpoint of the user does not reset the spatial arrangement at which the next user interface element that is displayed with captions will be displayed relative to the viewpoint of the user when subsequent immersive media content is displayed. Not resetting the spatial relationship between captions and the viewpoint of the user each time a media session is exited or closed ensures predictable display of the captions whenever immersive media content is initially displayed, which reduces errors in interaction with the computer system, and reduces the need for input to correct such errors.

In some embodiments, while displaying the user interface element and the immersive media content, such as element 910 and media 908 in FIG. 9R, wherein the user interface element and the immersive media content are displayed in a three-dimensional environment (e.g., a three-dimensional environment as described previously), the computer system detects the viewpoint of the user change from a first viewpoint to a second viewpoint, such as from FIG. 9T to FIG. 9U (e.g., as described previously). In some embodiments, in response to detecting the viewpoint of the user change from the first viewpoint to the second viewpoint, the computer system displays, via the one or more display generation components, the immersive media content from the second viewpoint of the user, such as shown in FIG. 9U (e.g., as described previously), in accordance with a determination that the user interface element had the first spatial arrangement relative to the viewpoint when the change in the viewpoint of the user from the first viewpoint to the second viewpoint was detected, such as the spatial arrangement in FIG. 9R, the computer system moves the user interface element from a first location to a second location in the three-dimensional environment in accordance with the change in the viewpoint of the user from the first viewpoint to the second viewpoint, such as moving element 910 from the location it had in FIG. 9R to an updated location in FIG. 9U that has the same spatial arrangement relative to viewpoint 901 as in FIG. 9R, and in accordance with a determination that the user interface element had the second spatial arrangement relative to the viewpoint when the change in the viewpoint of the user from the first viewpoint to the second viewpoint was detected, such as the spatial arrangement in FIG. 9T, the computer system moves the user interface element from a third location to a fourth location in the three-dimensional environment in accordance with the change in the viewpoint of the user from the first viewpoint to the second viewpoint, wherein the third location is different from the first location, and the fourth location is different from the third location, such as moving element 910 from the location it had in FIG. 9T to an updated location in FIG. 9U that has the same spatial arrangement relative to viewpoint 901 as in FIG. 9T. Thus, the user interface element optionally moves from a different initial location to a different final location when the viewpoint of the user changes depending on what the spatial arrangement of the user interface element relative to the viewpoint of the user was when the change in the viewpoint of the user was detected. In some environments, the spatial arrangement (e.g., position and/or orientation) between the first location and the second location is the same as the spatial arrangement (e.g., position and/or orientation) between the third location and the fourth location. Facilitating movement of the captions based on a detected change in the viewpoint of the user even when the captions have different spatial arrangements relative to the viewpoint of the user when the change in the viewpoint of the user is detected, ensures predictable and consistent display of the captions as the viewpoint of the user changes, which reduces errors in interaction with the computer system.

In some embodiments, moving the user interface element relative to the immersive media content in accordance with the first set of one or more inputs including moving the user interface element towards or away from the viewpoint of the user, such as movement of the element 910 from FIG. 9S to FIG. 9T. In some embodiments, if the first set of one or more inputs includes a movement component corresponding to moving the user interface element further away from or closer to the viewpoint of the user, the computer system optionally moves the user interface element further from or closer to the viewpoint of the user. In some embodiments, if the input includes an air pinch and drag gesture, movement of the hand of the user away from the body of the user corresponds to an input to move the user interface element away from the viewpoint of the user, and movement of the hand of the user towards the body of the user corresponds to input to move the user interface element closer to the viewpoint of the user. In some embodiments, moving the user interface element towards or away from the viewpoint of the user does not include movement of the user interface element vertically or horizontally relative to the viewpoint of the user. Thus, the user interface element is optionally closer to or further away from the viewpoint of the user as a result of the first set of one or more inputs. Allowing movement of the user interface element towards or away from the user provides increased flexibility in placement of the user interface element relative to the viewpoint of the user, which ensures that the user has quick and efficient access to the user interface element, thereby improving user device interactions.

In some embodiments, moving the user interface element relative to the immersive media content in accordance with the first set of one or more inputs is limited to a minimum distance from the viewpoint of the user, such as distance 960b in FIG. 9R, and a maximum distance from the viewpoint of the user, such as distance 960a in FIG. 9R. In some embodiments, the computer system does not allow the user interface element to be moved closer than the minimum distance from the viewpoint of the user, or further than the maximum distance from the viewpoint of the user. In some embodiments, input for moving the user interface element closer than the minimum distance will not result in the user interface element moving closer than the minimum distance, and input for moving the user interface element further than the maximum distance will not result in the user interface element moving further than the maximum distance. The user interface element will optionally remain displayed at the minimum or the maximum distance, respectively. Limiting movement of the user interface element to a minimum and a maximum distance ensures that the user interface element does not conflict with other elements in the three-dimensional environment (e.g., the immersive media content itself, or the viewpoint of the user), which reduces the need for input to correct such conflicts.

In some embodiments, in accordance with a determination that the immersive media content is first immersive media content, such as immersive media 908, the maximum distance is a first distance, such as maximum distance 960a in FIG. 9R, and in accordance with a determination that the immersive media content is second immersive media content, different from the first immersive media content, such as immersive media different from media 908, the maximum distance is a second distance, different from the first distance, such as a different maximum distance than 960a in FIG. 9R. Thus, in some embodiments, the immersive media content is able to define the maximum distance from the viewpoint of the user that the user interface element can be placed. In some embodiments, the computer system or the operating system of the computer system defines such maximum distance based on the immersive media content that is being displayed. In some embodiments, different immersive media content have different elements that might be displayed closer to or further from the viewpoint of the user (e.g., in depth). Therefore, if a first immersive media content has content that extends to within 6 feet of the viewpoint of the user, the maximum distance for the user interface element while displaying that first immersive media content is optionally 5 feet from the viewpoint of the user. In contrast, if a second immersive media content has content that only extends to within 10 feet of the viewpoint of the user, the maximum distance for the user interface element while displaying that second immersive media content is optionally 9 feet from the viewpoint of the user. Therefore the maximum distance at which to display the user interface element can be tuned to the particular immersive media content that is being displayed at that time. In some embodiments, the computer system automatically moves element 910 closer to the user to avoid a conflict with immersive media 908, such as shown in FIG. 9U. For example, in FIG. 9U, because of the change in viewpoint 901, element 910 would have conflicted with table 908b (as shown by indication 910′ in the top-down view, which indicates where element 910 would have normally been positioned in response to the change in viewpoint 901 from FIG. 9T to FIG. 9U if it had not been for the conflict between element 910 and table 908b). In response, computer system 101 has moved element 910 closer to viewpoint 901 automatically to be at a distance that is closer than any part of table 908b to viewpoint 901, thus avoiding the conflict. Allowing different maximum distances for the user interface element for different immersive media content ensures that the user interface element does not conflict with the immersive media content while allowing increased flexibility for placement of the user interface element depending on the characteristics of the particular immersive media content, which improves interactions between the computer system and the user.

In some embodiments, while the maximum distance from the viewpoint of the user is a first distance, such as distance 960a in FIG. 9T, the computer system detects a change in a spatial arrangement (e.g., position and/or orientation) between the maximum distance and the immersive media content, such as the change in spatial arrangement between distance 960a and immersive media 908 from FIG. 9T to FIG. 9U. For example, the viewpoint of the user moves or changes orientation, or an element of the immersive media content changes (for example, the immersive media content begins to include content that is closer to the viewpoint of user than the closest content that was previously displayed as part of the immersive media content). The maximum distance is optionally reflected as a portion of a circle that is centered at the viewpoint of the user, where the radius of the circle is the maximum distance. Therefore, whenever the spatial relationship between that portion of the circle and the immersive content changes, that change is optionally considered the detected change in the spatial arrangement between the maximum distance and the immersive media content.

In some embodiments, in response to detecting the change in the spatial arrangement between the maximum distance and the immersive media content, the computer system changes the maximum distance from the first distance to a second distance, different from the first distance, such as reducing distance 960a in FIG. 9U to that distance 906a does not conflict with table 908b in immersive media 908 (e.g., reducing distance 960a so it is closer to viewpoint 901 than any part of table 908b). For example, if the maximum distance now conflicts with the immersive media content, the computer system optionally reduces the maximum distance from the first distance to the second distance that is smaller than the first distance. In some embodiments, if the maximum distance is now further separated from the immersive media content than it was before the change in the spatial arrangement between the maximum distance and the immersive media content was detected, the computer system optionally increases the maximum distance from the first distance to the second distance that is greater than the first distance. In some embodiments, the maximum distance is therefore dynamic as the immersive media content progresses through playback, or as the viewpoint of the user changes. In some embodiments, if the user interface element was displayed at a certain distance from the viewpoint of the user when the change in the viewpoint of the user was detected, and that certain distance is now greater than the second distance to which the maximum distance was changed after the detected change in the viewpoint of the user, the computer system will automatically (without user input) move the user interface element closer to the viewpoint of the user (for example, a distance that is less than or equal to the updated maximum distance from the viewpoint of the user). Allowing for dynamic maximum distances for the user interface element ensures that the user interface element does not conflict with the immersive media content while allowing increased flexibility for placement of the user interface element depending on the characteristics of the particular immersive media content, which improves interactions between the computer system and the user.

In some embodiments, moving the user interface element relative to the immersive media content in accordance with the first set of one or more inputs including moving the user interface element horizontally or vertically relative to the viewpoint of the user, such as the movement of element 910 from FIG. 9S to FIG. 9T. In some embodiments, if the first set of one or more inputs includes a movement component corresponding to moving the user interface element laterally relative to the viewpoint of the user, the computer system optionally moves the user interface element further laterally relative to the viewpoint of the user. In some embodiments, if the input includes an air pinch and drag gesture, movement of the hand of the user laterally relative to the body of the user corresponds to an input to move the user interface element laterally relative to the viewpoint of the user. In some embodiments, moving the user interface element laterally relative to the viewpoint of the user does not include movement of the user interface element towards or away from the viewpoint of the user. Thus, the user interface element is optionally not closer to or further away from the viewpoint of the user as a result of the first set of one or more inputs. Allowing movement of the user interface element laterally relative to the user provides increased flexibility in placement of the user interface element relative to the viewpoint of the user, which ensures that the user has quick and efficient access to the user interface element, thereby improving user device interactions.

In some embodiments, moving the user interface element relative to the immersive media content in accordance with the first set of one or more inputs is limited to a volume defined by the viewpoint of the user, such as volume 906 in FIG. 9R. In some embodiments, the volume is a cone or a trapezoidal volume, where the narrow part of the volume is at or adjacent the viewpoint of the user, such as minimum distance boundary 906b, and expands and extends away from the viewpoint of the user. In some embodiments, the widest part of the volume coincides with and/or is defined by the maximum distance described above, such as maximum distance boundary 906a. In some embodiments, the side surface of the volume, such as the side boundaries of volume 906 in FIG. 9R, coincides with or is defined by the outer boundaries of the field of view or the viewport of the user of the computer system. Therefore, movement of the user interface element is optionally limited to being moved to a location that is currently visible from the viewpoint of the user via the display generation component. In some embodiments, user input cannot move the user interface element outside of the field of view or viewport of the user. In some embodiments, the volume in the three-dimensional environment changes location and/or orientation relative to the three-dimensional environment as the viewpoint of the user changes in location and/or orientation (respectively) relative to the three-dimensional environment. Limiting movement of the user interface element to a volume defined by the viewpoint of the user ensures that the user interface element will remain accessible to the user, therefore reducing errors in interaction with the computer system, and reducing the need for user input to correct for an inaccessible user interface element.

In some embodiments, the immersive media content is displayed in a three-dimensional environment (e.g., as described above), and is not displayed within a frame (and/or window, such as described with reference to methods 800 and/or 1000) in the three-dimensional environment, such as with media 908 in FIG. 9R. In some embodiments, the immersive media content is not displayed as being constrained within another user interface element, such as a window or a frame. This is optionally in contrast with other types of content, that are optionally displayed as being constrained within a visual frame or window via which such content is being displayed. In some embodiments, two-dimensional and three-dimensional content can be displayed within such a visual frame or a window. However, the immersive media content of method 1100 is optionally not displayed in such a visual frame or window.

In some embodiments, while displaying, via the one or more display generation components, respective media content (e.g., immersive media content, non-immersive media content as described with reference to methods 800 and/or 1000, two-dimensional content and/or three-dimensional content) and a second user interface element that includes one or more captions for the respective media content (e.g., the second user interface element and the captions optionally include one or more of the characteristics of the user interface element and its corresponding captions), the computer system detects, via the one or more input devices, a second set of one or more inputs directed to the second user interface element, such as an input that has one or more of the characteristics of the inputs from gaze 950 and hand 926 from FIGS. 9R to 9T. In some embodiments, the second set of one or more inputs has one or more of the characteristics of the first set of one or more inputs.

In some embodiments, in response to detecting the second set of one or more inputs, in accordance with a determination that the respective media content is immersive media content that is not displayed within a frame in the three-dimensional environment, such as media 908 in FIG. 9R (e.g., such as the immersive content of method 1100), the computer system moves the second user interface element relative to the respective media content in accordance with the second set of one or more inputs, similar to as shown from FIGS. 9R to 9T. Moving the second user interface element relative to the respective media content optionally has one or more of the characteristics of moving the user interface element relative to the immersive media content described previously.

In some embodiments, in response to detecting the second set of one or more inputs, in accordance with a determination that the respective media content is displayed within a frame in the three-dimensional environment, such as media 908 in FIG. 9P (e.g., the respective media content is 2 dimensional or three-dimensional media content that is displayed within a visual frame or window in the three-dimensional environment), the computer system forgoes moving the second user interface element relative to the respective media content in accordance with the second set of one or more inputs, such as maintaining element 910 in FIG. 9P at its spatial arrangement relative to media 908 in FIG. 9P (e.g., maintaining the spatial arrangement between the second user interface element and the respective media content despite detecting the second set of one or more inputs). In some embodiments, immersive media content that is not displayed in a visual frame or window cannot be moved in the three-dimensional environment with movement input. In contrast, media content that is displayed in a visual frame or window can be moved in response to movement input directed to such media content. However, captions for media content that is displayed within a visual frame or window cannot be moved relative to the media content and/or the visual frame or window. In response to detecting movement input directed to the visual frame or window, the computer system optionally moves the visual frame or window, the media content within the visual frame or window, and the captions for that media content concurrently and in the same manner in accordance with the movement input. However, during and after such movement, the spatial relationship between the visual frame or window, the media content, and the captions optionally remains constant or unchanged. Limiting movement of captions to media content that is immersive media content that is not displayed in a visual frame or a window in the three-dimensional environment reduces the likelihood that captions will be moved to a location that is disconnected from the content, thereby reducing errors in interaction with the content and the computer system.

In some embodiments, aspects/operations of methods 800, 1000 and/or 1100 may be interchanged, substituted, and/or added between these methods. For example, the media content in methods 800, 1000 and/or 1100, the user interface elements including captions in methods 1000 and/or 1100, the interactions with captions in methods 1000 and/or 1100, the playback control user interfaces in methods 800 and/or 1000, and/or the media modes in method 800 and/or 1000 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1-18. (canceled)

19. A method comprising:
at a computer system in communication with a display generation component and one or more input devices:
while a three-dimensional environment is visible via the display generation component, concurrently displaying, via the display generation component:
media content, wherein the media content is displayed from a first viewpoint of a user relative to the three-dimensional environment, and
a user interface element that includes one or more captions for the media content, wherein the user interface element has a first spatial relationship relative to a spatial reference in the media content in the three-dimensional environment;
while concurrently displaying the media content from the first viewpoint of the user relative to the three-dimensional environment and the user interface element that includes the one or more captions for the media content having the first spatial relationship relative to the spatial reference in the media content in the three-dimensional environment, detecting, via the one or more input devices, an event corresponding to a change of a viewpoint of the user relative to the three-dimensional environment; and
in response to detecting the event corresponding to the change of the viewpoint of the user relative to the three-dimensional environment from the first viewpoint of the user to a second viewpoint of the user relative to the three-dimensional environment, wherein the second viewpoint of the user is different from the first viewpoint of the user:
displaying the user interface element including the one or more captions for the media content having a second spatial relationship relative to the spatial reference in the media content, different from the first spatial relationship relative to the spatial reference in the media content, based on the change of the viewpoint of the user.

20. The method of claim 19, comprising:
while the three-dimensional environment is visible from a respective viewpoint of the user and while displaying the user interface element including the one or more captions for the media content having a respective spatial relationship to the spatial reference in the media content, wherein the user interface element including the one or more captions for the media content is displayed at a first location in the three-dimensional environment, detecting, via the one or more input devices, an input to display a playback control user interface including one or more selectable options for performing one or more actions associated with the media content; and
in response to detecting the input to display the playback control user interface including one or more selectable options for performing one or more actions associated with the media content:
displaying, via the display generation component, the playback control user interface including one or more selectable options for performing one or more actions associated with the media content wherein the playback control user interface is spatially separated from the media content in the three-dimensional environment; and
in accordance with a determination that one or more criteria is met, displaying, via the display generation component, the user interface element including the one or more captions for the media content at a second location, different from the first location, wherein when the user interface element including the one or more captions for the media content is at the second location, a spatial arrangement of the playback control user interface and the user interface element including the one or more captions for the media content is a first spatial arrangement.

21. The method of claim 20, wherein the one or more criteria includes a requirement that attention of the user is directed to the playback control user interface in order for the one or more criteria to be met.

22. The method of claim 20, comprising:
while the three-dimensional environment is visible via the display generation component from the respective viewpoint of the user, while displaying, at the second location in the three-dimensional environment, the user interface element including the one or more captions for the media content, and
while displaying the playback control user interface, wherein the user interface element and the playback control user interface have the first spatial arrangement, detecting, via the one or more input devices, a second event corresponding to a second change of the viewpoint of the user relative to the three-dimensional environment; and
in response to detecting the second event corresponding to the second change of the viewpoint of the user relative to the three-dimensional environment, continuing display, via the display generation component, of the user interface element including the one or more captions for the media content at the second location in the three-dimensional environment and the playback control user interface, with the spatial arrangement of the user interface element including the one or more captions for the media content and the playback control user interface being the first spatial arrangement.

23. The method of claim 22, comprising:
after continuing display, via the display generation component, of the user interface element including the one or more captions for the media content at the second location and the playback control user interface with the spatial arrangement of the user interface element including the one or more captions for the media content and the playback control user interface being the first spatial arrangement, and
in accordance with a determination that one or more second criteria is met:
reducing a visual prominence of the playback control user interface;
initiating a process to display, via the display generation component, the user interface element including the one or more captions for the media content at a location in the three-dimensional environment that is different from the second location in the three-dimensional environment, having a third spatial relationship relative to the spatial reference in the media content, based on the second change of viewpoint of the user relative to the three-dimensional environment, including displaying, via the display generation component, the user interface element including the one or more captions for the media content at the location in the three-dimensional environment having the third spatial relationship relative to the spatial reference in the media content.

24. The method of claim 23, wherein:
initiating the process to display, via the display generation component, the user interface element including the one or more captions for the media content at the location in the three-dimensional environment having the third spatial relationship relative to the spatial reference in the media content includes:
reducing a visual prominence of the user interface element including the one or more captions for the media content that was displayed at the second location with the spatial arrangement of the user interface element including the one or more captions for the media content and the playback control user interface being the first spatial arrangement; and
after reducing the visual prominence of the user interface element including the one or more captions for the media content that was displayed at the second location with the spatial arrangement of the user interface element including the one or more captions for the media content and the playback control user interface being the first spatial arrangement, displaying, via the display generation component, the user interface element including the one or more captions for the media content at the location in the three-dimensional environment having the third spatial relationship relative to the spatial reference in the media content.

25. The method of claim 23, wherein
displaying, via the display generation component, the user interface element including the one or more captions for the media content at the location in the three-dimensional environment having the third spatial relationship relative to the spatial reference in the media content includes: increasing the visual prominence of the user interface element including the one or more captions for the media content while visually moving the user interface element including the one or more captions for the media content towards the location in the three-dimensional environment having the third spatial relationship relative to the spatial reference in the media content.

26. The method of claim 19, wherein displaying the user interface element including the one or more captions for the media content having the second spatial relationship relative to the spatial reference in the media content is performed in accordance with a determination that one or more criteria is met, wherein the one or more criteria includes a requirement that a threshold period of time has passed since detecting the event corresponding to the change of the viewpoint of the user relative to the three-dimensional environment from the first viewpoint of the user to the second viewpoint of the user relative to the three-dimensional environment in order for the one or more criteria to be met.

27. The method of claim 19, comprising:
in response to detecting the event corresponding to the change of the viewpoint of the user relative to the three-dimensional environment from the first viewpoint of the user to the second viewpoint of the user:
displaying, via the display generation component, the user interface element including the one or more captions for the media content at a first respective location in the three-dimensional environment from the second viewpoint of the user, with a respective amount of visual prominence, wherein the one or more captions are displayed as moving towards a second respective location in the three-dimensional environment; and
after displaying, via the display generation component, the user interface element including the one or more captions for the media content having the first respective location in the three-dimensional environment from the second viewpoint of the user and with the respective amount of visual prominence, displaying, via the display generation component, the user interface element including the one or more captions for the media content having the second respective location in the three-dimensional environment from the second viewpoint of the user, different from the first respective location in the three-dimensional environment from the second viewpoint of the user, with an amount of visual prominence that is greater than the respective amount of visual prominence, and
wherein when the user interface element has the second respective location in the three-dimensional environment from the second viewpoint of the user, the user interface element including the one or more captions for the media content has the second spatial relationship relative to the spatial reference in the media content in the three-dimensional environment.

28. The method of claim 27, wherein while displaying, via the display generation component, the user interface element including the one or more captions for the media content at the first respective location:
in accordance with a determination that the change in viewpoint of the user relative to the three-dimensional environment from the first viewpoint of the user to the second viewpoint of the user is a first amount of change of viewpoint of the user, the respective amount of visual prominence is a first amount of visual prominence, and
in accordance with a determination that the change in viewpoint of the user relative to the three-dimensional environment from the first viewpoint of the user to the second viewpoint of the user is a second amount of change of viewpoint of the user, greater than the first amount of change of viewpoint of the user, the respective amount of visual prominence is a second amount of visual prominence that is less than the first amount of visual prominence.

29. The method of claim 28, comprising:
in response to detecting the event corresponding to the change of the viewpoint of the user relative to the three-dimensional environment from the first viewpoint of the user to the second viewpoint of the user:
in accordance with a determination that the change in viewpoint of the user relative to the three-dimensional environment from the first viewpoint of the user to the second viewpoint of the user is greater than a threshold change in viewpoint of the user, forgoing display of the user interface element including the one or more captions for the media content via the display generation component at the first respective location.

30. The method of claim 19, wherein:
while displaying the user interface element including the one or more captions for the media content having the second spatial relationship relative to the spatial reference in the media content in the three-dimensional environment, the user interface element including the one or more captions for the media content is displayed at a first location in three-dimensional environment that, in a view of the three-dimensional environment from the second viewpoint of the user, is offset from a center of the second viewpoint of the user.

31. The method of claim 19, comprising:
in response to detecting the event corresponding to the change of the viewpoint of the user relative to the three-dimensional environment from the first viewpoint of the user to the second viewpoint of the user relative to the three-dimensional environment:
displaying, via the display generation component, the media content, wherein the media content is displayed from the second viewpoint of the user relative to the three-dimensional environment, wherein a closest element of the media content to the second viewpoint of the user is at a first distance from the second viewpoint of the user,
wherein the user interface element including the one or more captions for the media content is displayed at a second distance from the second viewpoint of the user that is less than the first distance from the second viewpoint of the user.

32. The method of claim 19, comprising:
while displaying the media content:
in accordance with a determination that attention of the user is directed to a respective user interface element of a first type, different from the user interface element of a second type including the one or more captions for the media content, reducing a visual prominence of the user interface element including the one or more captions for the media content.

33. The method of claim 19, wherein the media content is immersive media content, the method further comprising:
displaying, via the display generation component, second media content that is non-immersive media content at a location in the three-dimensional environment;
detecting, via the one or more input devices, an event corresponding to a trigger to display a user interface element that includes one or more captions for the second media content; and
in response to detecting the event corresponding to the trigger to display the user interface element that includes the one or more captions for the media content, displaying, via the display generation component, the user interface element that includes the one or more captions for the media content at a location in the three-dimensional environment that is independent of a viewpoint of the user.

34. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while a three-dimensional environment is visible via the display generation component, concurrently displaying, via the display generation component:
media content, wherein the media content is displayed from a first viewpoint of a user relative to the three-dimensional environment, and
a user interface element that includes one or more captions for the media content, wherein the user interface element has a first spatial relationship relative to a spatial reference in the media content in the three-dimensional environment;
while concurrently displaying the media content from the first viewpoint of the user relative to the three-dimensional environment and the user interface element that includes the one or more captions for the media content having the first spatial relationship relative to the spatial reference in the media content in the three-dimensional environment, detecting, via the one or more input devices, an event corresponding to a change of a viewpoint of the user relative to the three-dimensional environment; and
in response to detecting the event corresponding to the change of the viewpoint of the user relative to the three-dimensional environment from the first viewpoint of the user to a second viewpoint of the user relative to the three-dimensional environment, wherein the second viewpoint of the user is different from the first viewpoint of the user:
displaying the user interface element including the one or more captions for the media content having a second spatial relationship relative to the spatial reference in the media content, different from the first spatial relationship relative to the spatial reference in the media content, based on the change of the viewpoint of the user.

35. A non-transitory computer readable storage medium storing one or more programs, the one or more programs comprising instructions, which when executed by one or more processors of a computer system that is in communication with a display generation component and one or more input devices, cause the computer system to perform a method comprising:
while a three-dimensional environment is visible via the display generation component, concurrently displaying, via the display generation component:
media content, wherein the media content is displayed from a first viewpoint of a user relative to the three-dimensional environment, and
a user interface element that includes one or more captions for the media content, wherein the user interface element has a first spatial relationship relative to a spatial reference in the media content in the three-dimensional environment;
while concurrently displaying the media content from the first viewpoint of the user relative to the three-dimensional environment and the user interface element that includes the one or more captions for the media content having the first spatial relationship relative to the spatial reference in the media content in the three-dimensional environment, detecting, via the one or more input devices, an event corresponding to a change of a viewpoint of the user relative to the three-dimensional environment; and
in response to detecting the event corresponding to the change of the viewpoint of the user relative to the three-dimensional environment from the first viewpoint of the user to a second viewpoint of the user relative to the three-dimensional environment, wherein the second viewpoint of the user is different from the first viewpoint of the user:
displaying the user interface element including the one or more captions for the media content having a second spatial relationship relative to the spatial reference in the media content, different from the first spatial relationship relative to the spatial reference in the media content, based on the change of the viewpoint of the user.

36-59. (canceled)
